(19) United States
(12) Patent Application Publication
(10) Pub. No.: US 2025/0236521 A1
(43) Pub. Date: Jul. 24, 2025

(54) FLASH JOULE HEATING FOR PRODUCTION OF 1D CARBON AND/OR BORON NITRIDE NANOMATERIALS

(71) Applicant: William Marsh Rice University, Houston, TX (US)

(72) Inventors: James Mitchell TOUR, Houston, TX (US); John Tianci LI, Houston, TX (US); Kevin WYSS, Houston, TX (US); Jinhang CHEN, Houston, TX (US); Weiyin CHEN, Houston, TX (US); Lucas EDDY, Houston, TX (US); Phelecia SCOTLAND, Houston, TX (US)

(73) Assignee: WILLIAM MARSH RICE UNIVERSITY, Houston, TX (US)

(21) Appl. No.: 18/863,937

(22) PCT Filed: May 15, 2023
(86) PCT No.: PCT/US2023/067000

§ 371 Date: Nov. 7, 2024

Related U.S. Application Data
(60) Provisional application No. 63/341,934, filed on May 13, 2022.

(51) Int. Cl. C01B 21/064; C01B 32/205; H05B 3/14

(52) U.S. Cl. CPC C01B 21/064; C01B 32/205; H05B 3/14; C01P 2002/72; C01P 2002/82; C01P 2004/03; C01P 2004/04; C01P 2004/13

(57) ABSTRACT

Flash Joule heating (FJH) for production of one-dimensional (1D) carbon and/or boron nitride nanomaterials, and 1D materials integrated with 0D, 1D, 2D, and 3D nanomaterials, composites, nanostructures, networks, and mixtures thereof. Such materials produced by FJH include 1D carbon and hybrid nanomaterials, boron nitride nanotubes (BNNTs), turbostratic boron-carbon-nitrogen (BCN), doped (substituted) graphene, and heteroatom doped (substituted) re-flashed graphene.

### CROSS-REFERENCED TO RELATED PATENT APPLICATIONS

The application claims priority to U.S. Patent Appl. Ser. No. 63/341,934, filed May 13, 2022, entitled “Flash Joule Heating For Production Of 1D Carbon And/Or Boron Nitride Nanomaterials, 1D Materials Integrated With 0D, 1D, 2D, And 3D Nanomaterials, Composites, Nanostructures, Networks, Or Mixtures Thereof,” which Patent application is commonly owned by the owner of the present invention. This patent application is incorporated herein in its entirety.

### STATEMENT REGARDING FEDERALLY SPONSORED RESEARCH

This invention was made with government support under Grant No. FA9550-22-1-0526, awarded by the United States Air Force Office of Scientific Research, and Grant No. FE0031794, awarded by the National Science Foundation (Graduate Research Fellowship) and the US Army Corp. of Engineers, ERDC No. W912HZ-21-2-0050. The United States government has certain rights in the invention.

### TECHNICAL FIELD

The present invention relates to flash Joule heating for production of 1D carbon and/or boron nitride nanomaterials, 1D materials integrated with 0D, 1D, 2D, and 3D nanomaterials, composites, nanostructures, networks, doped or substituted materials, and mixtures thereof.

### STATEMENT REGARDING FEDERALLY SPONSORED RESEARCH

This invention was made with government support under Grant No. FA9550-22-1-0526, awarded by the Air Force Office of Scientific Research, and Grant No. FE0031794, awarded by the National Science Foundation, and Grant No. W912HZ-21-2-0050 awarded by the Army Corp. of Engineers. The government has certain rights in the invention.

### BACKGROUND

One-dimensional (1D) carbon materials. One-dimensional (1D) carbon materials have received substantial research and attention since their discovery in the late 20^{th} century. [Ajayan 2001; Rathinavel 2021; Ruiz-Cornejo 2020; Yang 2015]. Although carbon nanotubes present the most widely acknowledged example of such 1D materials, many subclasses and different morphologies have been characterized. [Shi 2019; Kou 2017]. Examples of these 1D carbon nanomaterials include carbon nanotubes (CNTs), both single- and multi-walled, as well as ribbon- and plate-like carbon nanofibers, bamboo-like carbon nanotubes, cup-stacked carbon nanofibers, and many more. [Feng2014; Jai 2017; Liu 2021; Wang2019]. 1D materials are used extensively in composites, coatings, sensors, electrochemical energy storage, and electrocatalysts, capitalizing upon their strength, conductivity, low density, broadband electromagnetic absorption, high surface area, and chemical robustness. [Restivo 2020; Kumar 2021; Kour 2020; Wu 2021]. Due to their broad utility and scientific interest, identifying new methods of synthesizing 1D carbon materials remains critical. The majority of synthetic strategies to form 1D carbon materials, including arc-discharge, laser ablation, chemical vapor deposition, plasma torch, and high partial pressure carbon monoxide involve the mobilization of carbon atoms in feedstocks on the surface of a catalytic metal which then grow into a graphitic 1D morphology. [Xu 2019]. These current methods often result in mixtures of 1D materials and amorphous carbon that require separation, and 1D materials syntheses often suffer from low production rates of <1 g h⁻¹. [Lee S 2021; McLean 2021; Rao 2018].

Some recent work has focused on converting waste plastic into higher value carbon nanomaterials, inspired by the low cost and high availability of the feedstock. [Yaqoob 2022; Wang 2020; Williams 2021]. However, these methods often use a two-step chemical vapor deposition pyrolysis process: the first stage deconstructs the plastic into volatile hydrocarbons under an inert atmosphere at temperatures of 700-900° C. for 0.5-2 h. [Zhuo 2014; Sharma 2020]. In the second stage, the hydrocarbon gases then grow into 1D materials on complex transition metal catalysts, once again under inert atmosphere at similarly high temperatures for multiple hours. [Wang 2022; Bazargan 2012; Gong 2013]. The growth catalysts generally require dedicated synthesis or templating methods that can be time, energy, and resource intensive. [Jie 2020; Ahamed 2020; Jia 2022].

Further, many of these methods use 1:1 ratios of waste plastic to growth metal complex, meaning that every 1 ton of waste plastic processed would require 1 ton of metal complex be manufactured, which would hamper widespread implementation and economic viability. [Cai 2021]. To Applicant's knowledge, production of complex carbon hybrid materials from waste plastic has not been demonstrated. Current methods of carbon nanomaterial production from waste plastic are hampered by long reaction durations and high resource consumption, large amounts of metal complex additive, and minimal scalability of chemical vapor deposition techniques.

Flash Joule heating (FJH) synthesis. Flash Joule heating (FJH) was recently leveraged as efficient methods for the solvent-free synthesis of a variety of carbonaceous and inorganic nanomaterials. [Luong 2020; Wyss I 2022; Yao 2016; Deng 2022; Guo 2022]. Particularly, FJH has presented a facile method to upcycle low-value waste materials into high-value nanomaterials. [Algozeeb 2020; Wyss I 2021; Advincula 2021; Wyss II 2021]. For the FJH synthesis of graphene, electrical energy and resistance are leveraged to rapidly generate high temperatures and form turbostratic, or rotationally mismatched, graphene as the short duration of FJH (0.05 to 1 seconds) limits the rotational movement. Temperatures >3,100 K are accessed in milliseconds, allowing for the reorganization of amorphous carbon bonding into highly ordered sp²-hybridized sheets. [Wyss I 2022]. Flash graphene sheets form through a ‘mobile carbon’ mechanism, with temperatures generated by high resistance junctions within the sample allow for annealing and formation of crystalized nanoparticles. [Stanford 2020]. The capacitance density of the reaction can also control reaction conditions; increasing charge per unit mass shifts the nucleation process from reaction limited to diffusion-controlled reaction kinetics. [Algozeeb 2020; Beckham 2022].

Boron nitride nanotubes (BNNTs). Boron nitride (BN) is a highly intriguing group III-V compound due to its exceptional properties, including high thermal conductivity [Terao 2010; Zeng 2017], stability [Zhu 12005; Lee 2016], excellent mechanical strength [Chen 2017; Lahiri 2010], and insulating capabilities [Zh 2009]. The two most studied BN allotropes are one-dimensional (1D) boron nitride nanotubes (BNNTs) and two-dimensional (2D) hexagonal BN (h-BN). BNNTs are considered the structural analog of CNTs, with carbon atoms are replaced by alternating boron and nitrogen atoms. This substitution enhances the nanotubes oxidation resistance in air and results in stronger interaction with polymers compared to CNTs. [Huang 2011; Chen 2015].

In 1994, Rubio et al. made a theoretical prediction about the existence of BNNTs [Ruio 1994], which were later synthesized by Chopra et al. in 1995 using arc-discharge methods [Chopra 1995]. Since then, various methods were used to synthesize BNNTs, including laser ablation [Yu 1998; Kim 2019; Bae 2022], ball-milling combined annealing method [Chen 1999; Kim 2011; Zhuang 2016], template-assisted synthesis [Tay 2015; Wang 2008], chemical vapor deposition (CVD) [Pakdel 2012; Lourie 2000; Kim J 2018], thermal plasma [Kim 2020; Fathalizadeh 2014].

The preparation method directly determines the length, diameter and purity of BNNT, which plays a vital role in the applications. CVD is widely regarded as the most promising method for producing high-quality BNNT. This technique operates on a Vapor-Liquid-Solid (VLS) growth mechanism. [Zhi II 2005]. The yield and shape of BNNTs are extremely dependent on device design, gas flow, precursors, and catalysts. However, the CVD technique is still limited in its ability to produce BNNTs on a large scale. The method of using ball-milling and annealing is acknowledged for its ability to produce BNNTs with a high yield at a low cost. The BNNTs prepared by this method mainly possessed a bamboo-like structure. Laser ablation and thermal plasma are feasible to prepare BNNTs with a high production rate. Laser or high temperature plasma are used as the heat source to provide high energy, so that the surface temperature of the precursor is instantly raised and gasified to obtain thin-walled BNNT. The reaction mechanism remains unclear and the purification processes are required to remove these impurities, such as B and h-BN.

Turbostratic Boron-Carbon-Nitrogen (BCN). Canonical layered materials usually have a distinct and thermodynamically favored stacking sequence under standard temperature and pressure conditions. [Luong 2020; Stanford 2020]. The stacking sequence is determined by various non-covalent interactions, such as van der Waals, London, and Keesom interactions. [Smith 2011]. Deviation from these stacking morphologies leads to the formation of turbostratic lattices with the expansion of intrinsic interlayer distances and the weakening of coupling interactions between the neighboring layers [Advincula 2021; Algozeeb 2020], which can introduce unique optical, electrical, and magnetic properties for turbostratic materials, thus broadening their applications. [Wyss 12021; Chen 112021].

A major concern for the synthesis of turbostratic materials lies in the unfavorable formation energy and the spontaneous relaxation towards the thermodynamically favored stacking sequence. Once a sustained heat source is provided, products with thermodynamically most stable layered sequences dominate, making the access to turbostratic structures difficult.^{[2,8-10]} [Stanford 2020; Ba 2017; Song 2010; Xu D 2018] Therefore, most bottom-up methods for preparing layered materials cannot be adopted for synthesizing turbostratic materials because of an insufficient relaxation energy barrier (<4 kJ mol⁻¹) [Rydberg 2003] and limited cooling rate (<10 K s⁻¹). [Chilkoor 2020; Wang 2017]. The organization of regular in-plane configurations is usually accompanied by the formation of self-limited monolayer or well-aligned multilayer structures.

Although previous work has demonstrated that the formation of turbostratic structures can be induced by low-temperature (˜500 K) heat treatment, or bias-assisted hot-filament chemical vapor deposition (CVD), these products usually have a semi-crystalline in-plane configuration with hybrid nanocrystalline and amorphous domains. [Kakiagea 2013; Ahn 2000]. The semi-crystalline in-plane structures can prevent the precise stacking of individual layers, which induces the formation of the turbostratic stacking structures. In addition, guest intercalation methods using ionic liquids [Lian 2009] and chemical functionalization [Cao 2022] have been used to stabilize turbostratic materials. These methods are ascribed to the modification of interlayer interactions, such as hydrogen bonds and 71-71 stacking between neighboring basal planes. Therefore, the direct synthesis of turbostratic materials with high in-plane crystallinity remains challenging when one wants to study the unique properties caused by the weak coupling effect between neighboring layers.

The semi-crystalline in-plane structure is common for multicomponent systems when starting from gaseous precursors, such as boron-nitrogen dual compounds [Demirci 2020] and boron-carbon-nitrogen ternary compounds (BCN). [Ahn 2000; Puyoo 2017]. These reactive precursors, such as BCl₃ and NH₃ [Puyoo 2017], or ammonia borane (BH₃NH₃) [Zhong 2017], achieve fast conversion and cause the formation of amorphous products with numerous structural imperfections. Although the in-plane crystallinity of the products can be improved by controlling the annealing time and temperature, either semi-crystalline structures or well-aligned stacking structures eventually form [Chilkoor 2020; Ahn 2000] because of the thermodynamic limitation of these traditional bottom-up methods and metastable features of turbostratic materials with high in-plane crystallinity. [Luong 2020; Stanford 2020].

Turbostratic layers in 2D materials have an interlayer misalignment. The lack of alignment expands the intrinsic interlayer distances and weakens the optical and electronic interactions between adjacent layers. This introduces properties distinct from those structures with well-aligned lattices and strong coupling interactions. However, direct, and rapid synthesis of turbostratic materials remains a challenge owing to their thermodynamically metastable properties.

Doped Graphene. Graphene is a 2D material with exceptionally high mechanical strength, electrical conductivity, and other desirable chemical properties. [Ye 2019]. Graphene is often doped (or one could use the term “substituted” since the replaced or added atoms can be as greater than 5 wt %) with non-carbon atoms in order to chemically modify the graphene and tune its chemical, physical, and optical properties. [Wang 2014; Xu H 2018; Agnoli 2016]. These atoms can be placed into the graphene lattice and are thus most commonly similar in atomic radius to carbon atoms, or added above and below the place of the graphene lattice as in, for example, the addition of fluorine atoms. The resulting lattice is often comprised of up to a few percent heteroatoms by atomic ratio. A prominent technique to mass-produce graphene known as flash Joule heating (FJH) was published in 2020 by which amorphous carbon compounds can be converted to turbostratic graphene using an electrical pulse. [Luong 2020]. The amorphous carbon can be derived from a variety of sources, including coal products, waste plastic [Wyss II 2022; Wyss III 2022; Wyss I 2021], and rubber waste [Advincula 2021]. In 2022, an article was published presenting the mixing of amorphous carbon feedstocks with organic feedstocks that contain non-carbon atoms, such as melamine and boric acid, and flashing of these feedstocks together to make heteroatom (non-carbon) doped flash graphene. [Chen 2022]

In this previously reported technique, the organic heteroatom feedstocks along with the amorphous carbon feedstocks are destroyed. During the subsequent graphene formation, the non-carbon heteroatoms formerly present in these feedstocks place themselves inside the graphene structure or above and below the plane such that the product is doped graphene. The quantity of the non-carbon heteroatoms present in the graphene lattice was described in terms of a doping percentage, which is an atomic percentage of the graphene lattice that is comprised of non-carbon atoms. By this method, doping percentages of up to 7.4% for single-dopant flashes were achieved in the graphene lattice in different trials with sulfur, nitrogen, boron, and fluorine atoms, and slightly higher doping ratios were achieving by the simultaneous use of combinations of these dopants.

### SUMMARY OF THE INVENTION

The present invention relates to flash Joule heating (FJH) for production of one-dimensional (1D) carbon and/or boron nitride nanomaterials, and 1D materials integrated with 0D, 1D, 2D, and 3D nanomaterials, composites, nanostructures, networks, and mixtures thereof. Such materials produced by FJH include 1D carbon and hybrid nanomaterials, boron nitride nanotubes (BNNTs), turbostratic boron-carbon-nitrogen (BCN), doped (substituted) graphene, and heteroatom doped (substituted) re-flashed graphene.

In general, in one embodiment, the invention features a method that includes flash Joule heating a mixture of a material and a catalyst to form a 1-dimensional structure.

Implementations of the invention can include one or more of the following features:

The flash Joule heating can be a process that includes applying a voltage across the mixture, which drives a current through the mixture to form the 1-dimensional structure. The voltage can be applied in one or more voltage pulses. The duration of each of the one or more voltage pulses can be for a duration period.

The material can be a carbon material that is substantially not graphene.

The 1-dimensional structure can be a graphitic 1D and/or hybrid material nanomaterial.

The method can further include forming the 1-dimensional structure forms along with one or more other dimensional structures selected from the group consisting of 0-dimensional structures, 2-dimensional structures, and mixtures thereof.

The 1-dimensional structure and the one or more other dimensional structures can be conjoined covalently or non-covalently.

The 1-dimensional structure and the one or more other dimensional structures can be conjoined to form a 3-dimensional network.

The material can be a carbon material including a polymer.

The mixture can be formed by loading the polymer with particles of the catalyst through surface wetting.

The mixture can be formed by loading the polymer with particles of the catalyst through melt mixing.

The materials can be a waste product including carbon.

The catalyst can be selected from the group consisting of iron(II) chloride, nickel(II) chloride, cobalt(II) chloride, and ferrocene.

The catalyst can be selected from the group consisting of any transition metal or main group metal or transition metal or main group metal complex, salt, oxide, halide, or combinations thereof.

The mixture can further include a conductive carbon additive.

The conductive carbon additive can be selected from the group consisting of graphene, flash graphene, turbostratic graphene, anthracite coal, coconut shell-derived carbon, higher temperature-treated biochar, activated charcoal, calcined petroleum coke, metallurgical coke, coke, shungite, carbon nanotubes, asphaltenes, acetylene black, carbon black, ash, carbon fiber, and mixtures thereof.

The conductive carbon additive can include carbon black and/or metallurgical coke.

The method can further include that, after the flash Joule heating, separating at least some of the conductive carbon additive from the formed the 1-dimensional structure.

The step of separating can be based grain size of the conductive carbon additive and size of the 1-dimensional structure formed.

The step of separating can include sieving to separate the small 1-dimensional structure from the large grain conductive carbon additive.

After the step of separating, % yield of 1-dimensional structure formed in the method can be at least 80%.

After the step of separating % yield of the 1-dimensional structure formed in the method can be between 80% and 90%.

The % yield of 1-dimensional structure formed in the method can be at least 65%.

The % yield of the 1-dimensional structure formed in the method can be at least 80%.

In general, in another embodiment, the invention features a 1-dimensional structure that is made by any of the above-described methods.

Implementations of the invention can include one or more of the following features:

The 1-dimensional structure can be any form of nanostructure or microstructure in which length of the 1-dimensional structure is at least 3 times longer than the width of the 1-dimensional structure.

The 1-dimensional structure can be not a single atomic sheet thick.

In general, in another embodiment, the invention features a composite that includes any of the above-described the 1-dimensional structures.

Implementations of the invention can include one or more of the following features:

The composite can include the 1-dimensional structure and a vinyl ester.

The composite can be a 1-dimensional structure reinforced vinyl ester resin nanocomposite.

In general, in another embodiment, the invention features a structure or network that is made by any of the above-described methods.

Implementations of the invention can include one or more of the following features:

The 1-dimensional structure of the structure or network can be any form of nanostructure or microstructure in which length of the 1-dimensional structure is at least 3 times longer than the width of the 1-dimensional structure.

The 1-dimensional structure of the structure or network can be not a single atomic sheet thick.

In general, in another embodiment, the invention features a method that includes flash Joule heating a mixture to form boron nitride nanotubes. The mixture includes (i) a material comprising boron, (ii) a material comprising nitrogen and (iii) a catalyst.

Implementations of the invention can include one or more of the following features:

The flash Joule heating can be a process that includes applying a voltage across the mixture, which drives a current through the mixture to form the boron nitride nanotubes. The voltage can be applied in one or more voltage pulses. The duration of each of the one or more voltage pulses can be for a duration period.

The material including the boron and the material including the nitrogen can be different materials.

The material include the boron and the material including the nitrogen are the same material.

The same material can be ammonia borane.

The catalyst can be Ni(acac)₂ and/or Fe(acac)₃.

The catalyst can include Ni and/or Fe.

The mixture can further include a conductive carbon source.

The conductive carbon source can be selected from the group consisting of graphene, flash graphene, turbostratic graphene, anthracite coal, coconut shell-derived carbon, higher temperature-treated biochar, activated charcoal, calcined petroleum coke, metallurgical coke, coke, shungite, carbon nanotubes, asphaltenes, acetylene black, carbon black, ash, carbon fiber, and mixtures thereof.

The conductive carbon source can include carbon black and/or metallurgical coke.

The mixture can include (i) the material including the boron and the material including the nitrogen and (b) the conductive carbon source in a weight ratio between 1:2 and 2:1.

The method can further include that, after the flash Joule heating, separating at least some of the conductive carbon source from the boron nitride nanotubes formed.

The step of separating can be based grain size of the conductive carbon source and size of the boron nitride nanotubes formed.

The step of separating can include sieving to separate the small boron nitride nanotubes from the large grain conductive carbon source.

After the step of separating, % yield of boron nitride nanotubes formed in the method can be at least 45%.

After the step of separating, % yield of the 1-dimensional structure formed in the method can be at least 60%.

The % yield of the boron nitride nanotubes formed in the method can be at least 45%.

The % yield of the boron nitride nanotubes formed in the method can be at least 60%.

The n products of the method can include the boron nitride nanotubes and a sheet-like structure.

At least 30% of the products of the method can be boron nitride nanotubes.

In general, in another embodiment, the invention features a composition that include boron nitride nanotubes made by any of the above-described methods.

In general, in another embodiment, the invention features a method that includes flash Joule heating a mixture to form turbostratic nanomaterial including (a) boron, (b) nitrogen, and a (c) third element selected from the group consisting of carbon, tungsten, or iron. The mixture includes (i) a material including boron, (ii) a material including nitrogen, and (iii) a material including the third element.

Implementations of the invention can include one or more of the following features:

The flash Joule heating can be a process that includes applying a voltage across the mixture, which drives a current through the mixture to form the turbostratic nanomaterial. The voltage can be applied in one or more voltage pulses. The duration of each of the one or more voltage pulses can be for a duration period.

The third element can be carbon, and the turbostratic nanomaterial can be turbostratic BCN.

The third element can be tungsten, and the turbostratic nanomaterial can be turbostratic BN-W.

The third element can be iron and the turbostratic nanomaterial can be turbostratic BN-Fe.

The mixture can include (i) the material including the boron and the material including the nitrogen and (b) the material including the third element in a weight ratio above 4:1.

The mixture comprises (i) the material including the boron and the material including the nitrogen and (b) the material including the third element in a weight ratio between 1:2 and 2:1.

The % yield of the turbostratic nanomaterial formed in the method can be at least 20%.

The % yield of the turbostratic nanomaterial formed in the method can be at least 30%.

In general, in another embodiment, the invention features a composition including a turbostratic nanomaterial including (a) boron, (b) nitrogen, and (c) a third element selected from the group consisting of carbon, tungsten, and iron. The composition is made by any of the above-described methods.

In general, in another embodiment, the invention features a method to form doped or substituted graphene. The method includes performing a first flash Joule heating process using a first mixture to form a first formed graphene. The first mixture includes (i) a carbon source that is substantially not graphene and (ii) a catalyst. The method further includes mixing one or more heteroatom doping compounds with the first formed graphene to form a second mixture. The method further includes performing a second flash Joule heating process using the second mixture to form the doped or substituted graphene.

Implementations of the invention can include one or more of the following features:

The first flash Joule heating process can include applying a first voltage across the first mixture, which drives a first current through the first mixture to form the first formed graphene. The first voltage can be applied in one or more first voltage pulses. The duration of each of the one or more first voltage pulses can be for a first duration period. The second flash Joule heating process can include applying a second voltage across the second mixture, which drives a second current through the second mixture to form the doped or substituted graphene. The second voltage can be applied in one or more second voltage pulses. The duration of each of the one or more second voltage pulses can be for a second duration period.

The first formed graphene can be a 1-dimensional structure.

The 1-dimensional structure can be formed by any of the above-described methods.

The first formed graphene can be holey and wrinkled graphene.

The first formed graphene can be turbostratic graphene.

The carbon material can include a polymer.

The carbon material can be a waste product comprising carbon.

The carbon material can be a plastic.

The carbon material can be selected from the group consisting of graphene, flash graphene, turbostratic graphene, anthracite coal, coconut shell-derived carbon, higher temperature-treated biochar, activated charcoal, calcined petroleum coke, metallurgical coke, coke, shungite, carbon nanotubes, asphaltenes, acetylene black, carbon black, ash, carbon fiber, and mixtures thereof.

The conductive carbon material can include metallurgical coke and/or bituminous activated charcoal.

The catalyst can be selected from the group consisting of iron(II) chloride, nickel(II) chloride, cobalt(II) chloride, and ferrocene.

The catalyst can be selected from the group consisting of any transition metal or main group metal or transition metal or main group metal complex, salt, oxide, halide, or combinations thereof.

The method can further include that, after the first flash Joule heating process, separating at least some of the carbon material from the formed the first formed graphene.

The step of separating can be based grain size of the carbon material and size of the first formed graphene.

The step of separating can include sieving to separate the small first formed graphene from the large grain carbon material.

The step of mixing to form the second mixture can include mixing exactly one heteroatom doping compound with the first formed graphene.

The step of mixing to form the second mixture can include mixing two or more heteroatom doping compounds with the first formed graphene.

The one or more heteroatom doping compounds each can include at least one heteroatom selected from the group consisting of boron, nitrogen, sulfur, and fluorine.

The one or more heteroatom doping compounds can be each selected from the group consisting of boric acid, melamine resin, polyphenylene sulfide, perfluorooctanoic acid.

The one or more heteroatom doping compounds can include an organic powder having a low melting point.

The ratio of (i) one or more heteroatom doping compounds and (ii) the first formed graphene can be in a weight ratio between 1:8 and 1:2.

The second flash Joule heating process can be performed under an argon atmosphere.

The carbon source can have a large grain size.

The second flash Joule heating process can be performed using a first second-flash-Joule-heating voltage and a second-flash-Joule-heating voltage. The second second-flash-Joule-heating voltage can be greater than the first second-flash-Joule-heating voltage.

The second second-flash-Joule-heating voltage can be at least twice the first second-flash-Joule-heating voltage.

The second second-flash-Joule-heating voltage can be at least five times the first second-flash-Joule-heating voltage.

The second flash Joule heating process can be performed with a pulse width modulated DC electrical pulse from a capacitor bank discharge.

The second flash Joule heating process can be performed with a modulated or non-modulated AC and DC current source.

The first flash Joule heating process can be performed in a first cylindrical reactor having a first diameter. The second flash Joule heating process can be performed in a second cylindrical reactor having a second diameter. The first dimeter can be greater than the second reactor.

The doped or substituted graphene can include heteroatoms doped into the graphene lattice.

The doped or substituted graphene can include heteroatoms above or below the graphene lattice.

The doped or substituted graphene can include heteroatoms doped into the graphene lattice and heteroatoms above or below the graphene lattice.

The doping ratio of the doped or substituted graphene can be at least 10%.

The doping ratio of the doped or substituted graphene can be at least 20%.

In general, in another embodiment, the invention features doped or substituted graphene that is made by any of the above-described methods.

In general, in another embodiment, the invention features a method that includes mixing any of the above-described doped or substituted graphene in a concrete to increase mechanical strength of the concrete.

In general, in another embodiment, the invention features a concrete that includes any of the above-described doped or substituted graphene.

In general, in another embodiment, the invention features a method that includes mixing any of the above-described doped or substituted graphene in an epoxy to increase mechanical strength of the concrete.

In general, in another embodiment, the invention features an epoxy that includes any of the above-described doped or substituted graphene.

In general, in another embodiment, the invention features a battery having a battery electrode that includes any of the above-described doped or substituted graphene.

### BRIEF DESCRIPTION OF THE DRAWINGS

FIGS. 1A-1F show preparation of flash 1D materials (F1DM). FIG. 1A is a schematic of FJH process forming F1DM with a representative scanning electron microscope (SEM) image showing carbon F1DM-rich area of the sample. FIGS. 1B-1C are SEM images of F1DM rich areas within the sample, showing the tangled arrangement of 1D materials produced. TEM images of different F1DM morphologies including ribbon-type nanofiber (FIG. 1D), bamboo-like nanofiber (FIG. 1E), and multi-walled nanotubes (FIG. 1F). Lattice fringes are highlighted with yellow lines to help guide the eye, and the average interlayer spacing for each morphology is also provided. The fast Fourier transform of FIG. 1F is shown in the inset demonstrating the prominent (002) fringe of the nanotube. The scale bars in images correspond to (i) 5 μm for FIG. 1A, (ii) 3 μm for FIG. 1B, (iii) 300 nm for FIG. 1C, and (iv) 10 nm for FIGS. 1D-1F.

FIGS. 2A-2F show characterization of F1DM synthesized from virgin HDPE powder. FIG. 2A shows representative high resolution extended Raman spectrum of a sample of F1DM compared to a control sample where no metal was incorporated but all FJH parameters were the same. FIG. 2B is Raman spectra comparing the F1DM sample to the control sample, showing the average Raman spectra from a 36 μm² area and the absence of radial breathing mode peaks in the control sample. FIG. 2C is Raman spectra comparing the M, TS₁, and TS₂ peaks in the high resolution F1DM sample to the control sample, showing the presence of the M peak only in the F1DM sample. FIG. 2D is powder XRD comparing the F1DM to the starting material and a control sample where no metal catalyst was used, but all other parameters are identical. FIG. 2E is powder XRD spectra comparing the (002) peak of the F1DM and control sample, showing the multi-Lorentzian peak of the F1DM. FIG. 2F is powder XRD spectra showing the (101) and (100) peak area, showing the enhanced (101) peak in the F1DM sample.

FIGS. 3A-3F show characterization of F1DM synthesized from post-consumer mixed waste plastic. FIG. 3A is a Raman spectrum that shows mixed waste plastic derived F1DM characterized by large area Raman average spectrum. FIG. 3B is powder XRD comparing the waste plastic to the synthesized F1DM. FIG. 3C is survey and high resolution XPS. FIGS. 3D-3F are SEM images showing morphologies of waste plastic derived F1DM.

FIGS. 4A-4I show electron microscope images showing areas of 1D and 2D morphologies colocalizing to form graphitic hybrid materials and molecular dynamics models. FIGS. 4A-4D are SEM images showing colocalization and coalescence of 1D and 2D graphitic materials, with 2D morphologies attached to the ends of 1D morphologies. FIG. 4E is a TEM image showing an area of colocalization of a bamboo-like carbon nanofibers with the edge of a graphene sheet. FIG. 4F is a high-resolution TEM image of the area highlighted in FIG. 4F. FIG. 4G is a TEM image of a bamboo-like nanofiber merging with a graphene flake. FIG. 4H is an atomic resolution bright field TEM image of the area highlighted in FIG. 4G. FIG. 4I is the fast Fourier transform showing AB stacking in the hybrid material shown in FIG. 4H. The scale bars in images correspond to (i) 20 μm for FIG. 4A, (ii) 3 μm for FIGS. 4B-4C, (iii) 1 μm for FIG. 4D, (iv) 20 nm for FIGS. 4E-4F, (v) 100 nm for FIG. 4G, and (vi) 20 Å for FIG. 4H.

FIGS. 5A-5I show quantitative analysis of size and morphology control through FJH parameter tuning. FIGS. 5A-5D are confidence interval plots examining, respectively, the effect that (a) catalyst species, (b) catalyst concentration in the wetting solution, (c) peak voltage during FJH, and (d) capacitance density applied during FJH has on the diameter of the F1DM, as determined by SEM images. The mean diameter is shown by the dot, with a 95% confidence interval shown by the error bars. A line connecting the mean of each sample is provided to guide the eye. FIGS. 5E-5H are stacked column plots examining, respectively, the effect that (e) catalyst species, (f) catalyst concentration in the wetting solution, (g) discharge voltage applied during FJH, and (h) capacitance density applied during FJH has on the morphology of the F1DM, as determined by SEM images. FIG. 5I are stacked column plots examining the morphological composition of the sample used in the vinyl ester composites; the sample obtained after sieving; and the sample obtained from iterative mixing twice. Each data point in FIGS. 5A-5D represents 120 individual carbon nanofibers or nanotubes, from 6 randomly selected areas of the sample to ensure an accurate average was obtained. In FIGS. 5E-5I, 108 randomly selected areas for each sample (12 images, each divided into 9 equal area regions) were imaged and assigned a dominant morphology, either 1D, 2D or hybrid. The optimized parameters to maximize 1D and hybrid morphology share is 0.1 g ml⁻¹ of Fe(III), with discharge of 200 V and capacitance density of 1.46 mF mg⁻¹.

FIGS. 6A-6D show atomistic simulations of the amorphous carbon annealed at 3000 K in contact with a Ni nanoparticle. FIG. 6A shows configuration after initial pre-annealing, while FIG. 6B shows the final structure shows the beginning of the carbon fiber formation through carbon interaction and catalytic graphitization. FIG. 6C shows graphitization level of all carbon and carbon affected by Ni. FIG. 6D shows the percentage of carbon affected by Ni particle throughout the simulation.

FIGS. 7A-7F show quantitative comparison of F1DM utility in composites and sustainability with commercial alternatives. FIGS. 7A-7B show, respectively, mechanical analysis of vinyl ester nanocomposites reinforced with F1DM in (a) bulk scale compressive testing as compared with commercial multiwalled carbon nanotubes (MWCNT) and (b) F1DM in tensile testing as compared to neat matrix material. FIGS. 7C-7E show, respectively, the (c) cumulative energy demand, (d) global warming potential, and (e) cumulative water use associated with F1DM synthesis of F1DM through the surface wetting or melt mixing catalyst loading strategy, as compared to the FJH synthesis of 2D flash graphene where metal catalyst is not required. FIG. 7F shows a comparison of the two FJH synthesis of F1DM strategies considered in the life-cycle assessment, as compared with literature life-cycle assessment probing the synthesis of carbon nanotubes or nanofibers.

FIGS. 8A-8G show mechanical testing of F1DM and vinyl ester epoxy composites, as compared to 50 nm diameter commercial MWCNT obtained from the company Cheap Tubes (5% CheapTubes), as well as 2D flash graphene synthesized by the FJH. FIGS. 8A-8C show nanoscale compressive testing, FIGS. 8D-8E show macro-scale compressive testing, and FIGS. 8F-8G show macro-scale tensile testing.

FIGS. 9A-9D show representative stress-strain curves for mechanical testing shown in FIGS. 8A-8G. FIG. 9A shows nanoscale compressive testing, FIGS. 9B-9C show macro-scale compressive testing, and FIG. 9D shows macro-scale tensile testing.

FIGS. 10A-10C are schemes for life cycle inventory for the considered FH scenarios to synthesize F1DM, as compared to predominant industrial methods. FIG. 10A shows a scheme for general commercial methods, FIG. 10B shows a scheme for melt mixing and FJH for F1DM, and FIG. 10C shows a scheme for surface wetting and FJH for F1DM.

FIGS. 11A-11E show synthesis of boron nitride nanotubes (BNNT) by flash Joule heating. FIG. 11A is a schematic diagram of FJH device and BNNT production from ammonia borane (AB) precursors. FIG. 11B is the temperature measurement curve of sample during the FJH process. FIG. 11C is the conversion of AB in melt-mixing and FJH process. FIGS. 11D-11E are photographs of flash device with quartz tube and polyetheretherketone (PEEK) tube.

FIGS. 12A-12D show characterizations of synthesized BNNT by FJH. FIG. 12A FTIR spectra of AB precursor and flashed product. FIG. 12B is Raman spectra of AB precursor and flashed product. FIG. 12C is XRD patterns of AB precursor and flashed product. FIG. 12D is B is spectra of AB precursor and flashed product.

FIGS. 13A-13I are SEM images of BNNT product formation. FIGS. 13A-13C are SEM images of BNNTs formation in quartz tube. FIGS. 13D-13F are SEM images of BNNTs formation in PEEK tube. FIG. 13G is low-magnification SEM image of tube-rich region. FIG. 13H is low-magnification SEM image of sheet-rich region. FIG. 13I is an SEM image of BN sheets formation in quartz tube.

FIGS. 14A-14K are images of BNNTs in the flashed products. FIGS. 14A-14E are TEM images of BNNTs and BN sheets formed in quartz tube. FIG. 14F are HAADF-STEM images, and corresponding elemental distribution of BNNT. FIGS. 14G-14H are HAADF-STEM images, and corresponding elemental distribution of BN sheets. FIG. 14I is a TEM image of the catalyst particle. FIGS. 14J-14K are HAADF-STEM images, and corresponding elemental distribution of BNNT bamboo-like structure.

FIGS. 15A-15D shows all-solid-state synthesis of f-BCN by flash Joule heating. FIG. 15A is a schematic diagram for the formation of f-BCN from BH₃NH₃ and carbon via FJH. FIG. 15B shows real-time temperature measurement from the sample during the FJH process. FIG. 15C is a time-temperature-transformation diagram showing the kinetic formation of the turbostratic structure with ultrafast cooling (>10³ K s⁻¹). FIG. 15D is the potential energy profiles of h-BN sheets of various sizes (per atom) along the rotational minimum energy pathways from AA′ to AB stacking.

FIGS. 16A-16J shows spectroscopic analysis and crystal structure of f-BN. FIG. 16A is FTIR spectra of BH₃NH₃, f-BN and commercial h-BN. FIG. 16B is Raman spectra of BH₃NH₃ and f-BN. FIG. 16C is representative high-resolution Raman spectra reporting E_{2g} peak positions of f-BN and commercial h-BN. FIG. 16D is the statistic survey about E_{2g} peak positions of f-BN and commercial h-BN. The number of samples N=100. FIG. 16E are schemes showing the structures of h-BN and t-BN. FIG. 16F is XRD spectra of f-BN and commercial h-BN. FIGS. 16G-16H are high resolution XPS spectra of commercial h-BN and f-BN. FIG. 16G is B is spectra, and FIG. 16H N is spectra. FIG. 16I is HR-TEM images of f-BN sheets. FIG. 16J is BF-STEM, HAADF-STEM images and corresponding elemental distribution of f-BN sheets.

FIGS. 17A-17I show mechanical exfoliation tests of f-BN. FIGS. 17A-17B are SEM images showing the tape exfoliation results of, respectively, (a) f-BN and (b) commercial h-BN. FIG. 17C shows the size distributions of f-BN and commercial h-BN by the tape exfoliation method. The number of samples N=100. FIGS. 17D-17E are SEM images showing the monodirectional mechanical shearing results of, respectively, (d) f-BN and (e) commercial h-BN. FIG. 17F shows the size distributions of f-BN and commercial h-BN by the monodirectional mechanical shearing method. The number of samples N=100. FIGS. 17G-17H are TEM images of, respectively, (g) f-BN and (h) commercial h-BN after bath sonication treatment, both atop a lacy carbon grid. FIG. 17I shows the layer number distributions of the f-BN by the bath sonication treatment. The number of samples N=16.

FIGS. 18A-18D show the electrochemical anticorrosion tests of f-BN composites. FIGS. 18A-18B are, respectively, (a) Bode plots and (b) Tafel plots for the electrochemical analysis of bare Cu, Cu-PVA, Cu-PVA-h-BN and Cu-PVA-f-BN in 3.5 wt % NaCl (aq). FIGS. 18C-18D are, respectively, (c) Bode plots and (d) Tafel plots for Electrochemical analysis of bare Cu, Cu-PVA, Cu-PVA-h-BN and Cu-PVA-f-BN in 0.5 M H₂SO₄.

FIGS. 19A-19D show the electrochemical LPR tests of different coating materials in 3.5 wt % NaCl (aq) for, respectively, (a) bare Cu, (b) Cu-PVA, (c) Cu-PVA-h-BN, and (d) Cu-PVA-f-BN.

FIGS. 20A-20H show characterizations of f-BCN with different chemical compositions. FIG. 20A is schematic of f-BCN with variable atomic ratios. FIG. 20B shows the elemental distributions of different f-BCN samples. FIG. 20C shows valence band maximum (VBM) of different f-BCN samples. FIG. 20D shows interlayer spacing and surface area of different f-BCN samples. FIG. 20E shows a TEM image and Moiré pattern of f-BCN-30 and FIG. 20F shows the corresponding FFT results. FIG. 20G is an HR-TEM image showing in-plane crystallinity of f-BCN-30. FIG. 20H is HAADF-STEM, BF-STEM images, and corresponding elemental distribution of f-BCN-30 sheets. The scale bars are 20 nm.

FIG. 21 shows a boron-carbon-nitrogen ternary phase diagram before thermal treatment.

FIGS. 22A-22B show a schematic of a general workflow for the synthesis process of heteroatom doped reflash graphene (FG) from, respectively (a) metallurgical coke (MC) and (b) bituminous activated charcoal (BAC) by flash Joule heating (FJH).

FIG. 23 shows a schematic illustration of a flashing vessel used in an embodiment of the present invention.

FIGS. 24A-24B show a schematic of the flashing vessels inputs and outputs. The re-flash doping process is composed of two separate flashing reactions (shown in FIGS. 24A-24B, respectively).

FIGS. 25A-25C show spectroscopic analysis of N-doped BAC flash graphene. FIG. 25A shows average of 100 Raman spectra (with standard deviation). FIG. 25B shows high resolution Raman spectrum showing the TS₁ and TS₂ peaks, which are positive indicators of turbostraticity. FIG. 25C shows XPS spectrum in which the nitrogen peak is deconvoluted based on its bonding types. The nitrogen content was measured here to be over 5%.

FIGS. 26A-26C show an SEM image and EDX elemental analysis of N-doped flash graphene.

FIGS. 27A-27B show spectroscopic analysis of N-doped MC reflash graphene. FIG. 27A shows average of 100 Raman spectra (with the standard deviation). FIG. 27B shows B XPS spectrum in which the nitrogen peak is deconvoluted based on its bonding types.

FIG. 28 shows summary of re-flash doping results.

### DETAILED DESCRIPTION

The present invention relates to flash Joule heating (FJH) for production of one-dimensional (1D) carbon and/or boron nitride nanomaterials, and 1D materials integrated with 0D, 1D, 2D, and 3D nanomaterials, composites, nanostructures, networks, and mixtures thereof. Such materials produced by FJH include 1D carbon and hybrid nanomaterials, boron nitride nanotubes (BNNTs), turbostratic boron-carbon-nitrogen (BCN), heteroatom doped (substituted) graphene, and heteroatom doped (substituted) re-flashed graphene.

### One-Dimensional (1D) Carbon and Hybrid Nanomaterials Synthesis by FJH

In embodiments, the present invention relates to the conversion of plastic into 1D materials and hybrid graphitic 1D/2D materials, with controllable morphologies. The process utilizes in situ catalysis and enables directional control over the assembly of mobile carbon during FJH. The produced F1DM demonstrate excellent mechanical behavior in vinyl ester composites, attributable to the hybrid morphology and indicative of the value and utility of the waste plastic upcycled product. Further, FJH presents substantial advantages over classical 1D synthesis when analyzed using a cradle-to-gate perspective life cycle assessment.

Graphitic one-dimensional (1D) and hybrid nanomaterials represent a powerful solution in composite and electronic applications due to exceptional properties, but large-scale synthesis of hybrid materials has yet to be realized. The process, which is scalable, produces graphitic 1D materials from polymers using flash Joule heating (FJH). This avoids lengthy chemical vapor deposition and uses no solvent or water. The flash 1D materials (F1DM), synthesized using a variety of earth-abundant catalysts, have controllable diameters and morphologies by parameter tuning. Furthermore, the process can be modified to form hybrid materials, with F1DM bonded to turbostratic graphene. In nanocomposites, F1DM outperform commercially available carbon nanotubes. Compared to current 1D material synthetic strategies using life cycle assessment (LCA), FJH synthesis represents an 86-92% decrease in cumulative energy demand and 92-94% decrease in global warming potential. FJH affords a cost-effective and sustainable route to upcycle waste plastic into valuable 1D and hybrid nanomaterials.

### Synthesis of F1DM

Flash Joule heating (FJH) was recently identified as an efficient method for the solvent-free synthesis of carbonaceous and inorganic nanomaterials, in which electrical energy and resistance are leveraged to rapidly (0.05-3 sec) generate high temperatures (˜3,000 K), allowing for the solvent-free upcycling of low-value waste materials into high-value products. [Luong 2020; Yao 2016; Xie 2018]. Graphitic 1D and hybrid nanomaterials often grow through the deposition of mobile carbon on metallic nanoparticles, and FJH is known to efficiently produce mobile carbon, inspiring study of the growth of 1D nanomaterials using FJH.

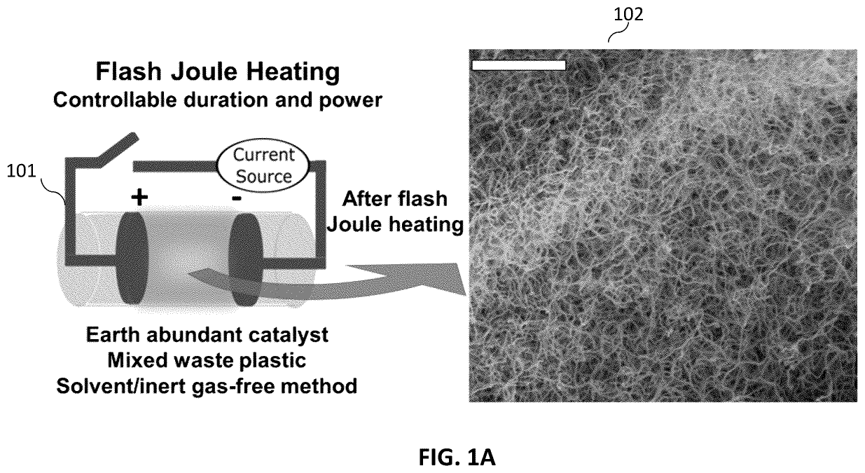

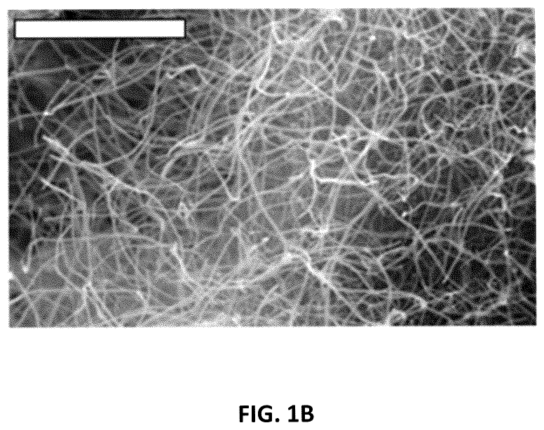

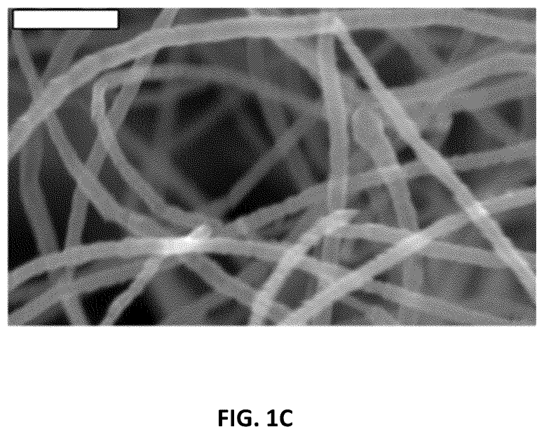

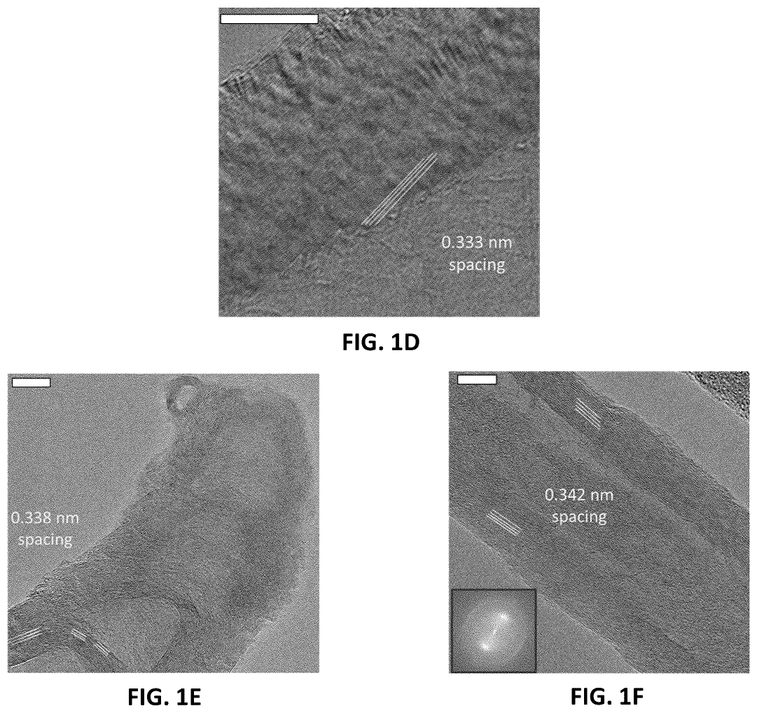

Introducing low concentrations of simple, earth-abundant transition metal salts into the carbonaceous polymer feedstock results in graphitic 1D material growth, catalyzed in situ during the FJH process. See schematic 101 shown in FIG. 1A. Iron(II) chloride, nickel(II) chloride, cobalt(II) chloride, and ferrocene were used as the growth catalysts. A polymer feedstock was selected due to the abundance and low cost of waste plastic and resulting yield of F1DM. The resistance of the reaction mixture was easily controlled by adjusting the amount of conductive carbon additive, such as carbon black or metallurgical coke. The high resistance of a plastic precursor allows for many high-resistance junctions between particles in the sample, resulting in high overall and local temperatures. The FJH system that can be utilized (and parameters) can be based on the system set forth and described in the Tour '642 Application and the Tour '111 PCT Application with the modifications as discussed below.

The polymer feedstock can be loaded with catalyst particles through surface wetting or melt mixing. For surface wetting, the polymer can be sonicated in an aqueous alcohol solution containing 0.1 g mL⁻¹ of salt, then filtered and dried to coat the surface of the polymer with small amounts of the catalyst. For solvent-free catalyst loading, melt-mixing can be used wherein metal complexes such as ferrocene and polymers with similar melting points are mixed mechanically in the melt state and no solvent is used. Scanning electron microscope (SEM) images (SEM image 102 of FIG. 1A and SEM images of FIGS. 1B-1C) show fibers of varying diameters are formed during the FJH process. A typical aspect ratio of 330 was observed but often the entire intertwined length could not be continuously tracked so this is likely an underestimate.

In embodiments, the F1DM were synthesized using a flash Joule heating reactor as described in in the Tour '642 Application and the Tour '111 PCT Application. Specifically, the catalyst-loaded polymer feedstock were prepared by surface wetting or melt mixing. For the surface wetting method: a solution of 80/20 v/v mixture of water and ethanol was prepared, with the salt of choice dissolved in the solution. For example, FeCl₃ at a concentration of 0.1 g mL⁻¹ of solution. Then, 5 g of <0.1 mm grain size virgin or waste polymer was submerged in the solution and sonicated for 15 min. The polymer with salt solution was vacuum filtered to remove excess salt solution. The polymer was dried overnight at room temperature to afford the catalyst loaded polymer, which has a slight color change depending on the salt used.

For the melt mixing method: ferrocene was used as the catalyst due to its low melting point of 173° C. The heater in the melt mixer was set to 175° C., and a mixture of 4.95 g of HDPE and 0.05 g of ferrocene is melt-mixed to homogeneity using a Braebender 350-E heated zone melt mixer. The melt mix was then cooled to room temperature and ground to a fine powder using an electric hammer mill.

The catalyst-loaded polymer resulting from surface wetting or melt mixing was then mixed with the conductive additive. Amorphous carbon black (Cabot) was used for all samples herein, except when metallurgical coke is specified to have been used as a less expensive alternative.

When amorphous carbon black was used as the conductive additive, 20 wt % was ground with 80 wt % of the catalyst-loaded polymer. Due to the small particle size of the amorphous carbon black, it coated the polymer homogeneously. The higher cost of carbon black relative to waste plastic, an alternative feedstock of metallurgical coke, a coal-derived product that costs $150 ton⁻¹, was also demonstrated effective.

Since metallurgical coke has a larger grain size of ˜150 μm, a higher weight percent must be used to achieve a similar final sample conductivity. For the use of metallurgical coke as the conductive additive, 40 wt % was used, and was mixed with 60 wt % of catalyst loaded polymer. Grain size of both the polymer and the conductive additive might impact the ratio of polymer feedstock and conductive additive. The conductive additive and polymer were mixed by hand, using mortar and pestle. Then, 0.20 g the homogeneous mixture was loaded into a quartz tube, with an internal diameter of 8 mm, with the sample compressed in tube by graphite electrodes to contain the powder.

The sample was then loaded into the FJH reactor, connecting the capacitors to be able to discharge through the resistive sample. An initial sample resistance of 6-8Ω was used for the samples as described here. The sample was enclosed in a vacuum desiccator at ˜20 mmHg to facilitate outgassing of heteroatoms and volatiles. A FJH current discharge pulse of the desired voltage, using the desired capacitance, was then discharged to completion through the sample, lasting 1-3 s, depending on the voltage and capacitance, with higher capacitance resulting in longer durations. The circuit was closed fully for 5 s, with a typical discharge only lasting 1-3 s. The voltage on the capacitors was fully discharged, which may require multiple discharges. A bright flash could be observed from the sample because of the black body radiation produced.

After the FJH, the resistance of the sample decreased to 0.6-1Ω. The F1DM was then emptied from the quartz tube, ground using a mortar and pestle, and characterized without further purification. The yield of F1DM ranges (40-60 wt % of reactant recovered as graphitic product) depending on the parameters, polymer type, grain size, and amount of conductive additive used.

Quantitatively differentiating between graphitic carbon morphologies can be a difficult task, as 1-D and 2-D morphologies look almost identical by common analytical methodologies such as XPS and TGA, with Raman and powder XRD showing only minor differences. Due to the combination of morphologies obtained during FJH, extensive SEM imaging was used to determine the morphological share of each sample. At low magnifications, 1D and 2D morphologies can look similar, so for each sample 108 different images over 9 different areas were examined and assigned a dominant morphology (1D, 2D, or hybrid). This allows for the morphological percentage, in area %, to be quantitatively determined. Area % is used herein when discussing F1DM morphology yield. A maximum of ˜65% of the solid product is 1D morphology with the remainder including 2D turbostratic graphene. FIGS. 1D-1F show high resolution TEM images of ribbon-like carbon nanofibers, graphitic bamboo-like carbon, and multi-walled carbon nanotubes. Bamboo-like carbon nanofibers with many layers stacking in a cup-like manner comprise the dominant F1DM morphology. The 2D morphologies present were observed by TEM imaging. Graphene nanoribbons were observed through TEM imaging which could result from the high-temperature unzipping of carbon nanotubes.

### Characterization of F1DM

F1DM were characterized using Raman spectral mapping, which demonstrated highly graphitic character over a large area. The F1DM were compared to a control sample, where no metal was included but all other conditions were identical and both samples yield products with 97-98% graphitic character. The graphitic content was determined by three different characterization methods including Raman spectroscopy, TGA, and high resolution XPS. Wide area Raman mapping was carried out by collecting 100 unique spectra, over a 4 mm² area, which were then processed using MatLab scripts which characterize spectra with a I2D/IG ratio >0.3 to be graphitic. TGA can be used to determine graphitization by measuring the thermally stable mass at 550° C. under an air atmosphere, since amorphous carbon will degrade lower than this temperature. High-resolution XPS and fitting of the C1s peak allow for graphitic character to be determined, and a more accurate method of C KLL XPS can also probe graphitic content.

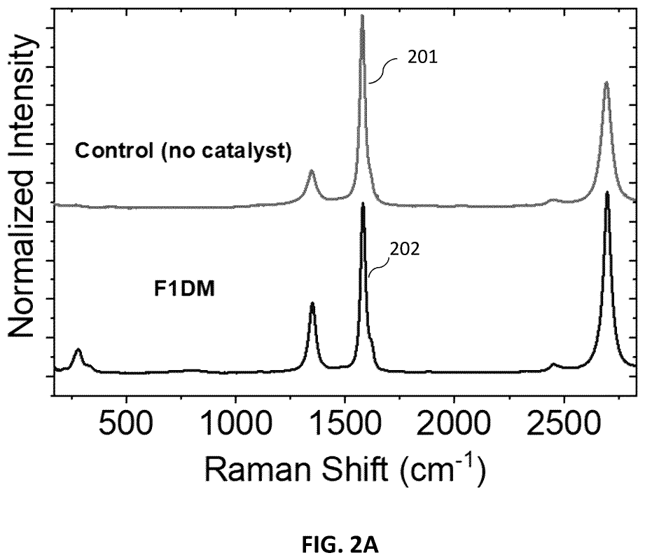

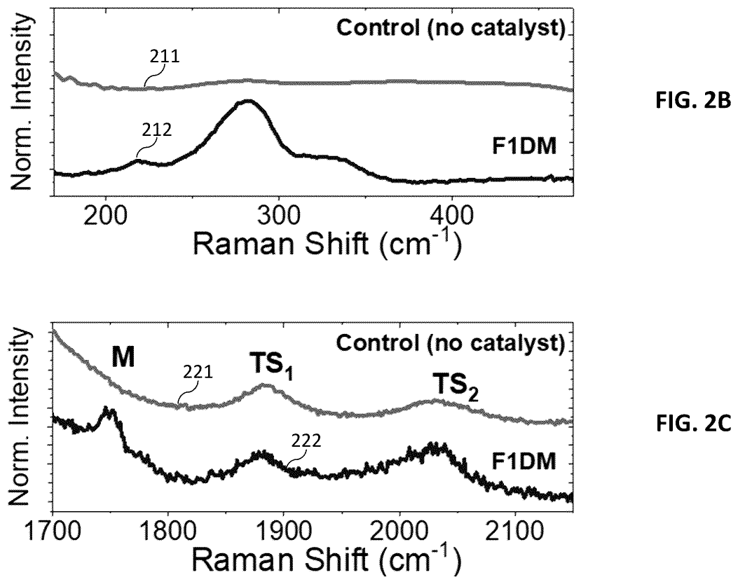

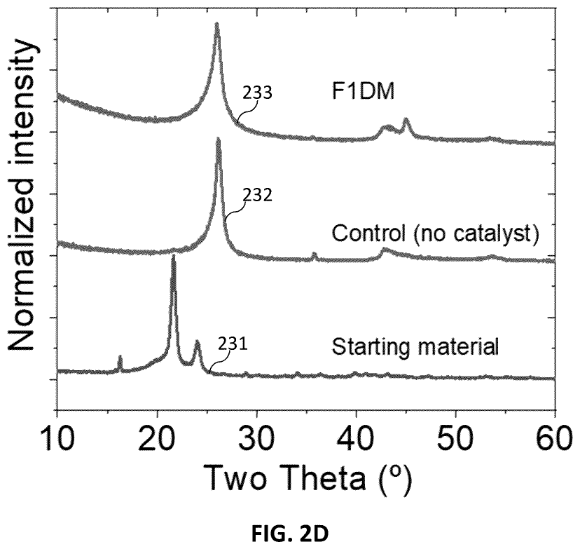

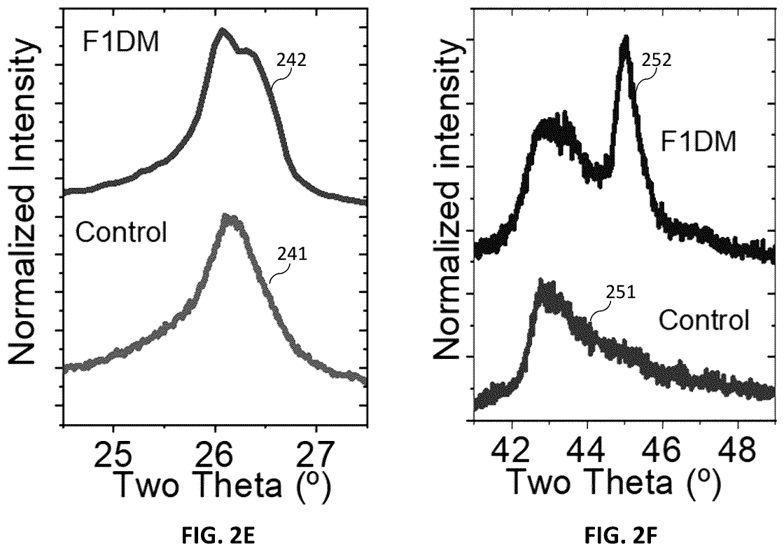

High resolution, extended exposure scans revealed the presence of radial breathing mode peaks in the F1DM sample indicating the presence of carbon nanotubes in the F1DM sample, but not in the metal-free control sample. FIG. 2A (with plots 201-202 for control (no catalyst) and F1DM, respectively); FIG. 2B (with plots 211-212 for control (no catalyst) and F1DM, respectively). By varying the Raman excitation wavelength, different radial breathing mode peaks can be observed. The low intensity M, TS₁ and TS₂ peaks can also be observed. FIG. 2C (with plots 221-222 for control (no catalyst) and F1DM, respectively).

The M peak, located at 1750 cm⁻¹, indicated ordered AB stacking. [Ferrari 2013]. The TS₁ and TS₂ peaks, located at 1875 cm⁻¹ and 2050 cm⁻¹, respectively, indicated disordered turbostratic stacking. [Merlen 2017; Chen I 2021]. The presence of both the M and TS peaks indicated that both aligned and misaligned stacking of graphitic domains were present. Flash graphene is turbostratic, so M peak presence was unexpected. [Luong 2020; Wyss I 20222]. Catalytically synthesized plate- and ribbon-like carbon nanofibers often demonstrate rotationally ordered AB stacking, which could explain the presence of the M peak and further indicate the bulk presence of nanofiber morphologies in F1DM. [Carozo 2011; Brar 2002].

To characterize the bulk F1DM product, powder X-ray diffraction (XRD) was used. FIG. 2D (with plots 231-233 for starting material, control (no catalyst) and F1DM, respectively). This showed a broad, intense, and multi-Lorentzian (002) peak indicating graphitic structure. The F1DM (002) peak is fit by two distinct Lorentzians, occurring at 26.46° and 26.11°. See FIG. 2E (with plots 241-242 for control (no catalyst) and F1DM, respectively). The (002) peak of the catalyst-free control sample is fit with a single Lorentzian centered at 26.12°. Graphitic 1D materials, such as MWCNT and CNF have nearly identical diffractograms to that of 2D graphene because they share the same unit cell. The only difference is the interlayer spacing of turbostratic graphene (0.35 nm) as compared to that of graphitic 1D materials (0.34 nm), reflected by the position of the (002) peak. A lattice spacing of 0.350 nm corresponds to a diffraction peak of 26.1°, while a decreased lattice spacing would result, shifting the diffraction peak to higher angles. The fitting of the F1DM (002) peak by two distinct Lorentzian functions indicates that both 1D materials and turbostratic graphene were present in the sample, whereas the single peak in the control sample corresponds only to turbostratic graphene. It is also known that the position of the (002) peak is dependent on the diameter of the carbon nanotube or nanofiber, and (002) peaks that can be fit by multiple sub-peaks. [Singh 2010].

Further, an enhanced (101) peak at 45.3° can be observed in the F1DM, but not in the catalyst-free control (FIG. 2F, with plots 251-252 for control (no catalyst) and F1DM, respectively), as observable for large diameter carbon nanotubes. [Singh 2010]

X-ray photoelectron spectroscopy (XPS) was used to probe the elemental content and bonding of F1DM (Figure S10a). During FJH, the high boiling carbon content of the plastic is enriched to 97.8% graphitic product. High resolution spectra of the C1s transition demonstrates minimal oxygen content and the π-π* transition, located at 291 eV. The D-parameter of the starting material polymer is 12.8 eV, which increases to 20.2 eV after FJH, signifying a transition from sp³- to sp²-hybridization. Thermogravimetric analysis of F1DM under air atmosphere shows high degradation onset temperature of 630° C., confirming the bulk graphitic character.

The limit of detection for XPS survey scans is typically 0.5 to 1.0 at %. Thus, at the concentrations determined by ICP-MS, with a maximum of 0.3 wt %, one would not expect to detect any signal by XPS survey scans. Further, the penetration depth of XPS detection is only 1-2 nanometers. Since TEM imaging shows that the iron was present in nanoparticles below many layers of graphitic carbon, it is also likely that the iron photoelectrons were not detected.

In contrast, the iron is solubilized following sample digestion as it is prepared for ICP-MS testing, and ICP-MS has much lower limits of detection. Inductively coupled plasma mass spectrometry revealed that F1DM formed using the surface wetting method of 0.1 g mL⁻¹ FeCl₃ on a virgin high density polyethylene (HDPE) feedstock showed only 0.3 wt % Fe content in the starting material, decreasing during FJH to 0.06 wt %. The reduction in catalyst content during the FJH process was likely due to sublimation and outgassing of the metal ions at high temperatures. [Deng 2021]. The catalyst content could be further reduced to <10 ppm with 1 M HCl wash.

F1DM from Untreated, Post-Consumer, Mixed Plastics

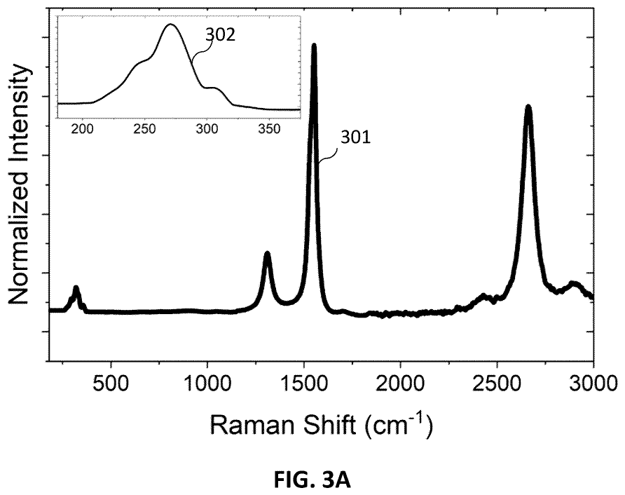

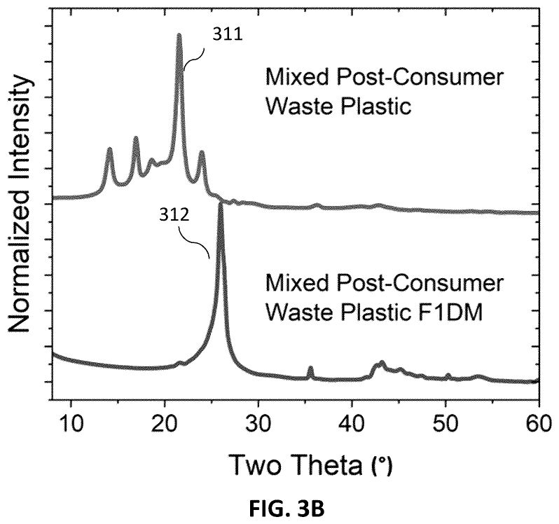

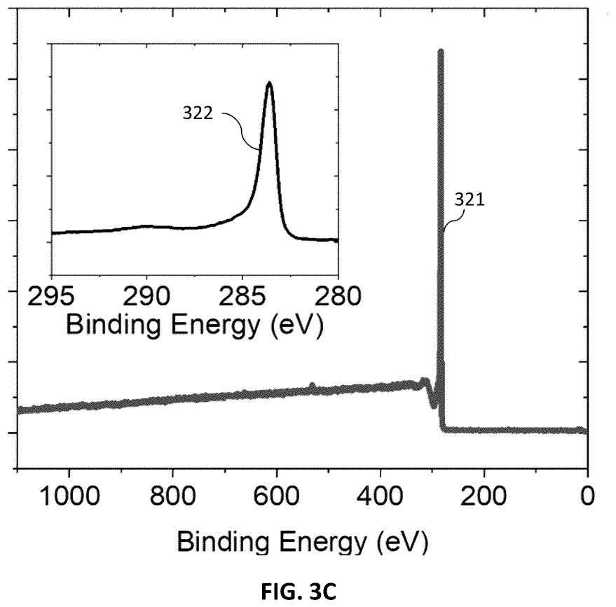

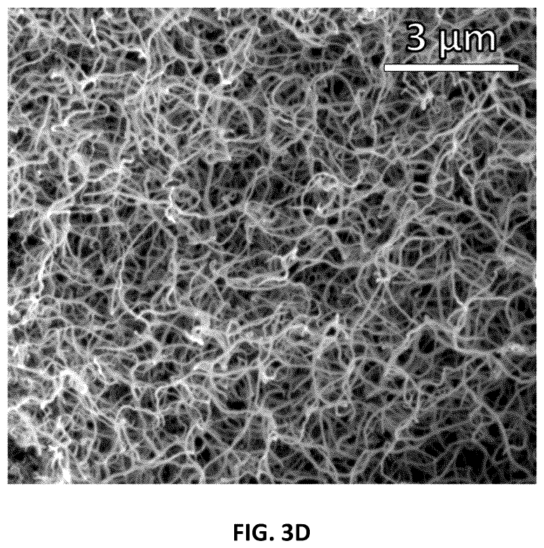

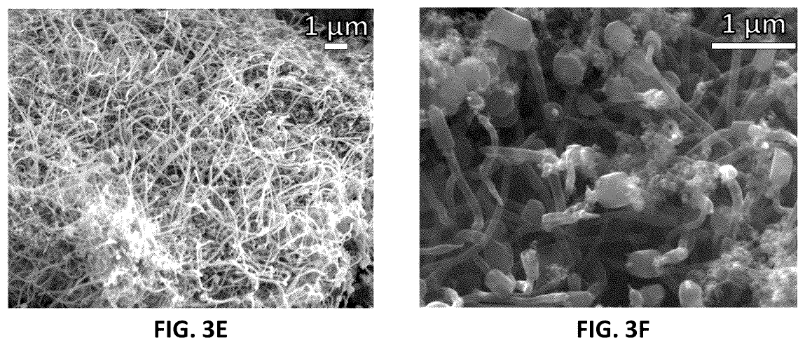

There are 27 million tons of mixed waste plastic landfilled annually. Mixed post-consumer waste plastic was converted into F1DM by grinding, surface wetting, and FJH. FIGS. 3A-3F shows that mixed waste plastic composed of HDPE, low density polyethylene (LDPE), polypropylene (PP), polystyrene (PS), and polyethylene terephthalate (PET), can be easily upcycled into F1DM by a 3-sec-long FJH pulse. FIG. 3A is a Raman spectrum (plot 301) that shows mixed waste plastic derived F1DM characterized by large area Raman average spectrum with inset (plot 302) showing the radial breathing modes. FIG. 3B is powder XRD comparing the waste plastic (plot 311) to the synthesized F1DM (plot 312). FIG. 3C is survey and high resolution XPS (plots 321-322). FIGS. 3D-3F are SEM images showing morphologies of waste plastic derived F1DM.

Other recent research described the synthesis of graphitic 1D materials from waste plastic. [Williams 2021; Wang 2022; Jie 2020]. However, those methods often relied on two-stage 2-h-long pyrolysis followed by catalyst-aided chemical vapor deposition methods and have not been shown to accommodate mixed waste plastic streams, and can result in mixtures composed of ˜30 wt % amorphous carbon or large excesses of catalyst that must be further removed. [Tripathi 2017; Wu 2016].

The mixed waste plastic mixture used was composed of 42% HDPE, 20% PP, 20% LDPE, 10% PS, 8% PET, replicating the global plastic waste composition. It is known that pyrolysis and FJH or PET result in lower carbon yields, and a lower yield of 1-D graphitic materials. [Algozeeb 202; Yao 2022]. The conversion of polystyrene was further investigated as some studies have reported that the aromatic structures result in thicker CNTs. [Yao 2022]. This trend was also observed for F1DM. Radial breathing modes can be observed for the waste derived F1DM (FIG. 3A), as well as complete conversion of the waste plastic into graphitic structures, as determined by powder XRD (FIG. 3B) and TGA. The enhanced (101) peak can also be observed in FIG. 3B, confirming the bulk presence of F1DM from mixed waste plastic.

High elemental purity in the produced F1DM can be further studied by XPS (FIG. 3C, which shows a 2% increase in oxygen content as compared to HDPE derived F1DM despite the inclusion of PET, which is 25 wt % oxygen. Additives, such as colorants, plasticizers, adhesives, or residual waste from the plastics' primary use are regarded as impurities.

The TGA and XRD (FIG. 3B) of the mixed waste plastics do not show substantial metallic impurities, as signified by low residual TGA mass and minimal unidentified XRD peaks. The atomic carbon in these impurities can be converted to graphene while heteroatoms such as oxygen, metals, or halides, are sublimed out. F1DM morphologies, including hybrid morphologies, can be observed by SEM imaging as shown in FIGS. 3D-3F.

The particle size of the waste polymer feedstock has been demonstrated to impact the results of FJH [Algozeeb 2020], and the finer particle size will allow for more catalyst loading and higher surface area of high resistance junctions, improving the yield of F1DM. Thus, the yield of F1DM in the post-consumer polymer samples may be further increased by improved grinding. The mixed waste plastic was ground as fine as the utilized hammer mill allowed, but industrial scaling can afford smaller particles and thus more surface for the F1DM to form.

Many types of polymers exist, and high melting temperatures of some may not allow for the catalyst to be introduced by melt-mixing. To demonstrate process generality, polyurethane, a thermoset polymer, was converted into F1DM through a simple surface wetting technique. These F1DM synthesized from waste polyurethane demonstrated similar properties and morphologies as those derived from virgin HDPE. Polyurethane derived F1DM did have slight increases in oxygen (2.3%) and nitrogen (1.4%) content, indicating that the formation of heteroatom doped 1D and hybrid morphologies was possible by FJH, something that has already been demonstrated for FJH graphene. [Chen 2022].

### Controllable Hybrid and F1DM Morphologies

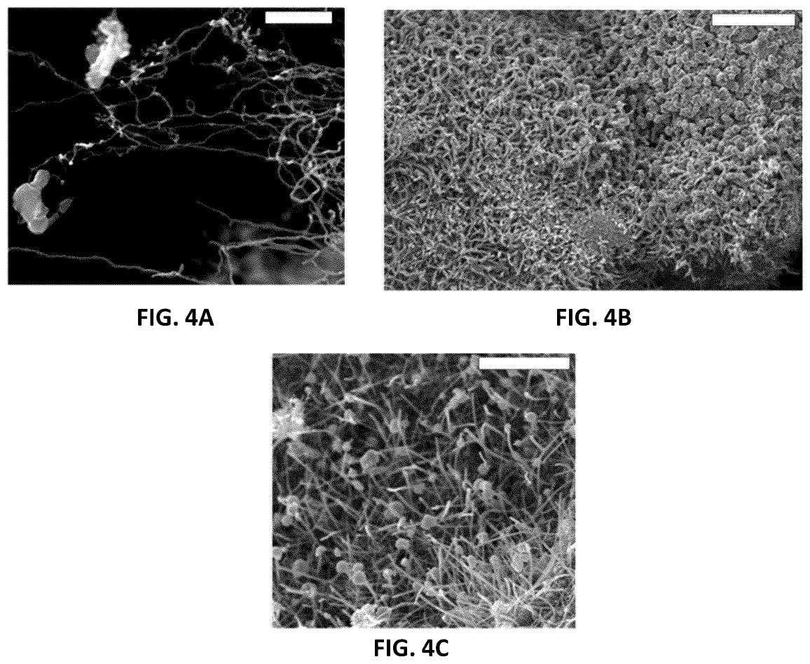

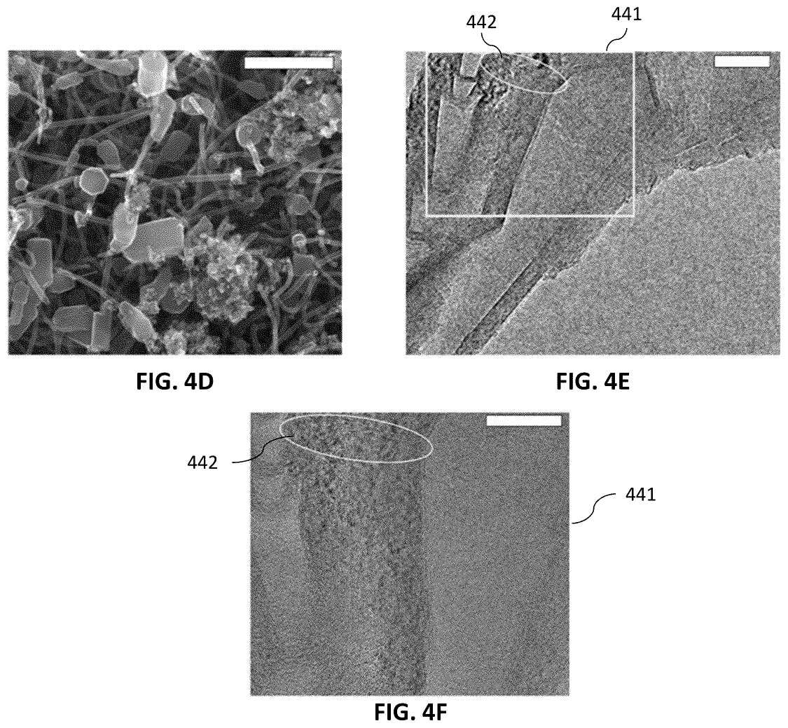

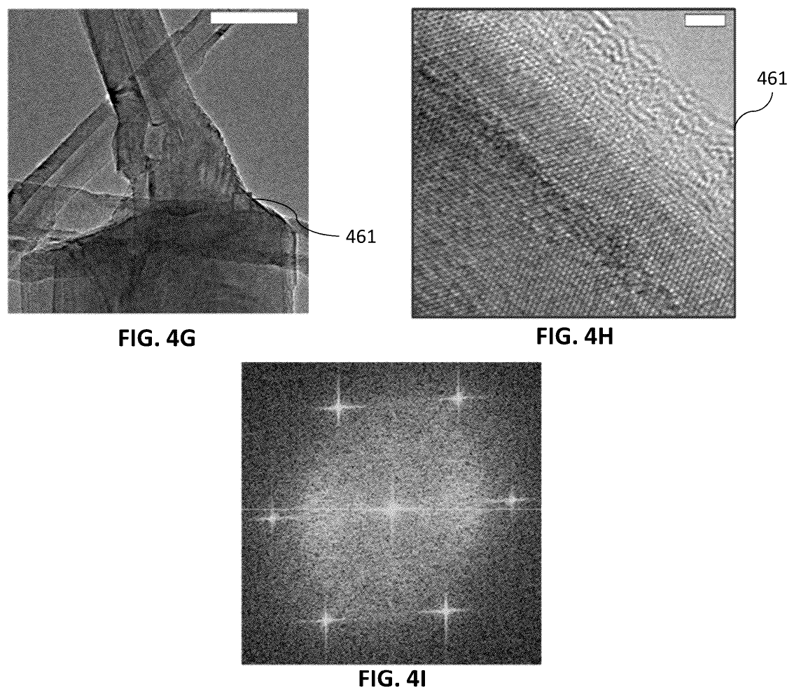

1D and 2D hybrid materials, such as rebar graphene, are desirable for application due to their exotic mechanical and electronic properties. [Vedhanarayanan 2018; Yan 2014]. However, these materials are almost singularly synthesized through multi-step chemical vapor deposition methods that are high-cost and low-yielding. [Xia 2017; Zhao 2012]. FJH produced areas of 2D graphene morphologies, F1DM morphologies, and commonly observable areas of colocalization and coalescence of 1D and 2D morphologies. FIGS. 4A-4I.

SEM imaging demonstrated F1DM decorated with 2D graphene sheets at their ends, with the 1D morphology occasionally extending all the way through the 2D graphene (FIGS. 4A and 4C-4D). Areas of the sample (FIG. 4B) also exhibited the coalescence of 1D morphologies into larger-diameter 1D materials and then networks of 2D graphitic morphologies. TEM imaging (FIGS. 4E-4I) shows colocalization of F1DM and graphene. FIG. 4F is a high-resolution TEM image of the area 441 highlighted in FIG. 4F. The circled area 442 highlights the lattice fringe between the bamboo-like carbon nanofibers and graphene sheet, showing that they are part of the same crystal lattice. FIG. 4H is an atomic resolution bright field TEM image of the area 461 highlighted in FIG. 4G showing the hexagonal arrangement of carbon atoms in the graphene sheets uninterrupted at the junction between the 1D and 2D morphologies.

High resolution imaging (FIGS. 4E-4G) showed that the lattice fringe and edge was uninterrupted from the external wall of the nanofiber to the larger graphene sheet, indicating van der Waals interactions connecting the 1D and 2D domains together. Atomic resolution TEM imaging (FIG. 4H) revealed hexagonal sp²-hybridized graphene sheets, uninterrupted along the edge at the junction between the 1D and 2D morphology, suggesting covalently linked hybrid materials. The fast Fourier transform (FIG. 4I) indicated AB-stacked graphene, suggesting that hybrid materials can show decreased lattice spacings by XRD and an M peak in Raman spectral analysis (FIGS. 2A-2F).

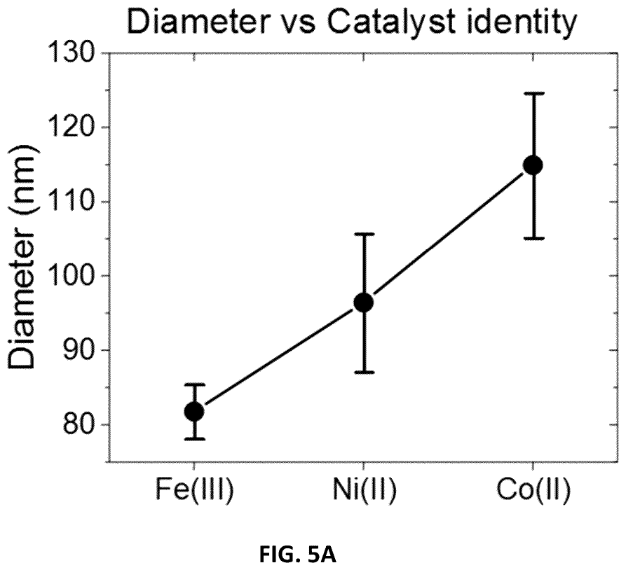

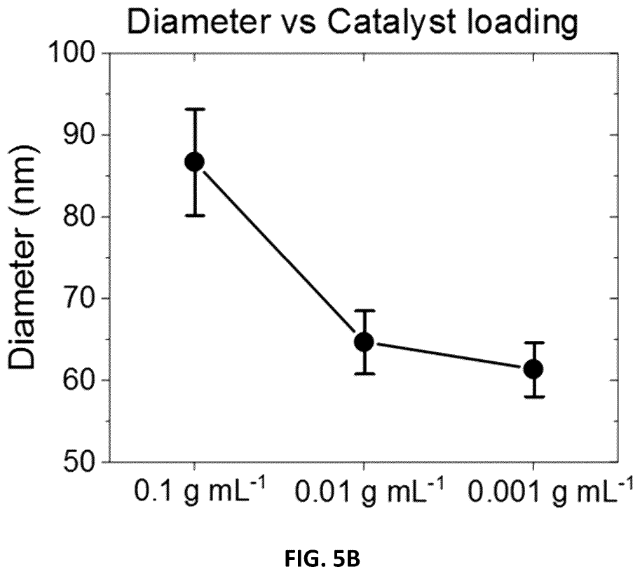

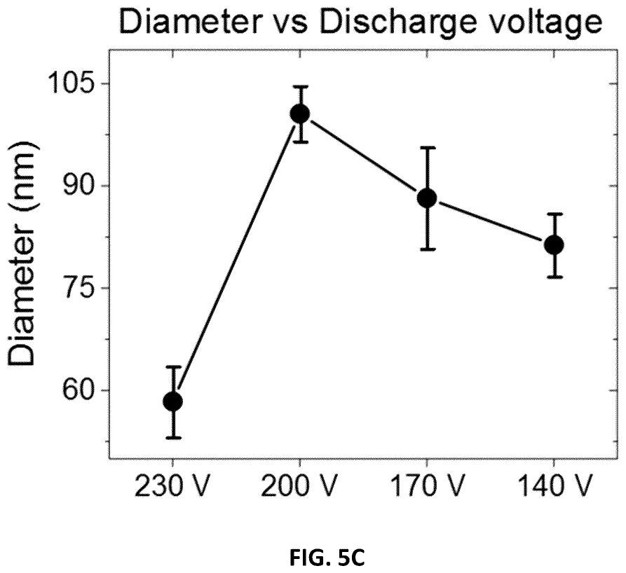

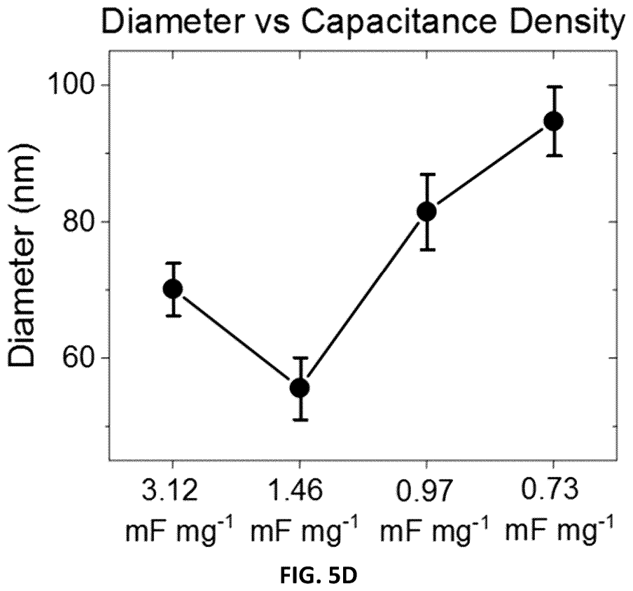

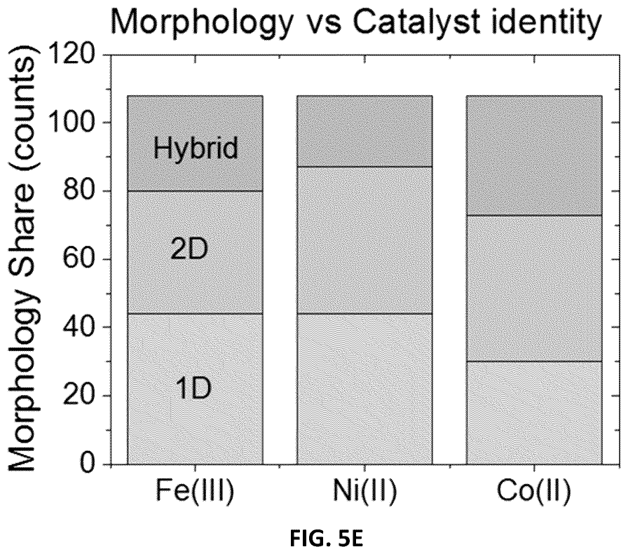

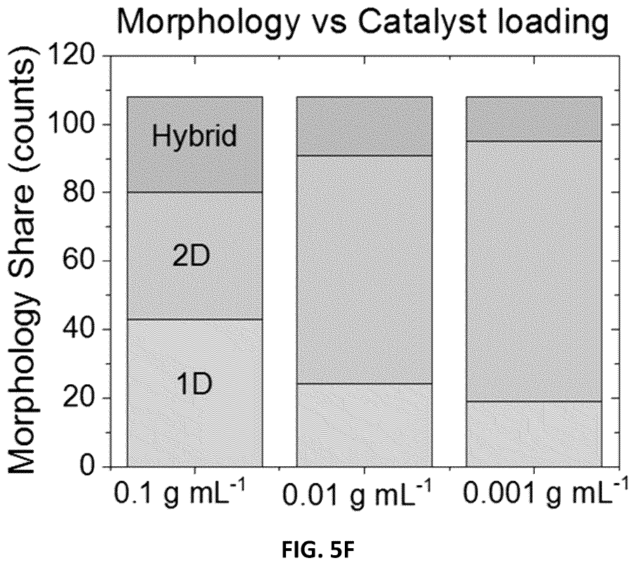

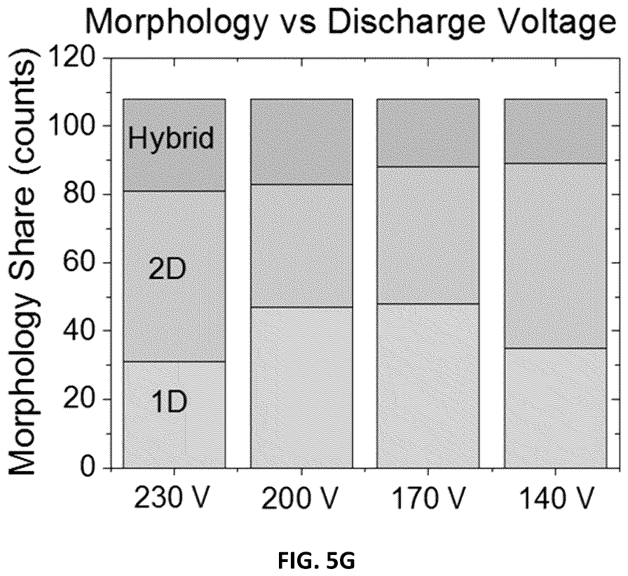

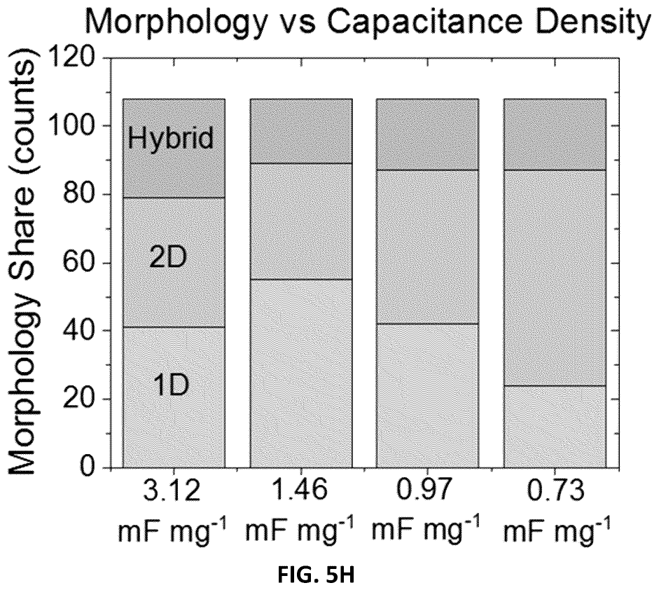

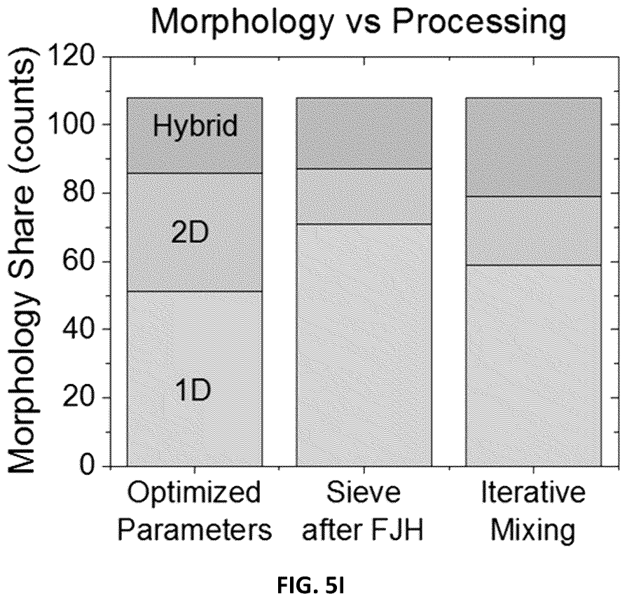

FJH parameters, including discharge voltage, catalyst type, loading, and capacitance density, can impact the product morphologies. Capacitance density is defined herein as the system capacitance per unit mass reacted. [Beckham 2022]. SEM analysis revealed that catalyst loading and type impact the diameter of the produced F1DM (FIGS. 5A-5B) with decreasing catalyst loadings resulting in thinner 1D materials being produced, with Fe(III) producing the thinnest F1DM and Co(II) producing the thickest.

It is well known that catalyst type can have substantial impact on the size of produced CNTs, since different metals have different catalytic graphitization rates and carbon solubilities. [Yuan 2008; Thambiliyagodage 2018; Hunter 2022]. Consistent with herein, many literature reports suggest that iron is more effective than cobalt and nickel, possibly due to these impacts. FJH parameters such as capacitance density and pulse voltage directly correlate with the capacitive current by Eq (1) and affect the diameter of F1DM (FIGS. 5C-5D), where I, C, V, and t correspond to current, capacitance, voltage, and time, respectively.

$$I = C \frac{d ( V )}{d ( f )} \qquad ( 1 )$$

Intriguingly, capacitance and pulse voltage discharge resulted in opposite trends in F1DM diameter, despite both contributing additional charge to the reaction. However, the discharge rate of a capacitor was not uniform, so doubling the capacitance will not double the current but would instead double the discharge time. The amount of time required for the capacitors to discharge can be determined by using Eq (2), where R represents the resistance.

$$t = C * R * log ( V ) \qquad ( 2 )$$

Increased peak discharge voltage allowed for increased instantaneous current discharge through the sample, resulting in higher overall power and heating rates. The non-monotonic correlation of capacitance density and discharge voltage with diameter was unexpected but appeared to indicate a shift in mechanism. This has previously been observed in a partial dependence analysis of a machine learning guided FJH study that found that an increasing current density results in a shift from reaction-limited to diffusion-controlled kinetics. [Stanford 2020; Beckham 2022]. This shift in growth kinetics is common in crystalline materials and may be observed here as well. [Carroll 2018; Viswanatha 2007]. Representative SEM images of the F1DM as each parameter was varied that demonstrated that formation of F1DM was parameter-sensitive, allowing for control of product morphologies.

Qualitative analysis also indicated that catalyst type, loading, capacitance density, and discharge voltage can be used to control the morphological makeup of F1DM (FIGS. 5E-5H). Use of Ni(II) resulted in the highest share of 2D materials while Co(II) yields the most hybrid materials. As the catalyst loading decreased, the amount of hybrid and 1D morphologies produced also decreased, likely due to a lower density of catalytic sites for mobile carbon deposition (FIG. 5F). As power input to the system increased, through applied voltage or capacitance density, the amount of 1D and hybrid materials increased. The diameter of the F1DM product was positively correlated to the amount of hybrid morphology present. Optimized reaction parameters yielded 68% of the 1D/hybrid morphology (FIG. 5I). Iterative mixing or sieving was used to further increase the yield of F1DM up to 90%.

As the catalyst was loaded on or in the plastic, and the conductive CB reaches lower temperatures, it is believed that only the polymer feedstock forms the F1DM morphology, while the conductive additive forms 2D morphologies. The conductive additive can be essential to the FJH process to reduce the resistance of the sample and allow for high power discharge. To increase the yield of the 1D morphology, iterative mixing can be used, where the F1DM product (50/50 1D and 2D morphologies) is used as the conductive additive in a second FJH reaction, increasing the 1D share to ˜75%, without degradation in quality. Use of a larger grain conductive additive, such as metallurgical coke, allows the use of simple sieving to separate the small F1DM product from the large grain conductive additive. Sieving or iterative mixing allows for the production of F1DM that is composed of 80-90% 1D and hybrid morphologies without using solvent- or centrifugation-based separation methods.

### Mechanism of F1DM Formation

Catalyst-loaded conductive additive does not result in the formation of F1DM, but rather 2D graphene morphologies surface decorated with metal nanoparticles. High resistance junctions and volatile decomposition imparted by the plastic feedstock can be essential for the formation of F1DM. It is believed that these junctions form hot spots that facilitate F1DM nucleation. To further analyze this effect, a homogeneous sample with similar overall resistance and density was tested and evaluated. Ash resulting from the industrial pyrolysis of plastic waste has a similar 7Ω resistance to the carbon-added F1DM feedstock but is homogeneous. Surface wetting was used to introduce metal salt to the pyrolysis ash, and the sample was subjected to FJH using the same parameters used to form F1DM. No 1D morphologies were observed by SEM and TEM imaging indicating that resistive junctions at the plastic surface are required to form 1D morphologies.

To further probe if the resistive junctions are a mechanistic cause of the F1DM formation, the process was replicated using sand (silica) rather than plastic. All parameters, including surface wetting the sand to introduce the catalyst, mixing with carbon black conductive additive, and FJH settings, remained identical. The sample was ground after FJH and sieved to remove the residual inert silica. The results showed graphitization of the carbon black, as well as minor SiC formation, with <20 area % of the carbon being converted to F1DM, while the remainder was converted to 2D graphene morphologies.

This testing demonstrated that the resistive junctions can be necessary for the formation of F1DM, but also indicated that the carbon from the plastic can be important for large amounts of F1DM to be produced. Recent work has shown that carbonization in the presence of carbon black or other conductive amorphous carbons can result in the metal catalyst free formation of turbostratic carbon nanoparticles. [Jia 2022]. Amorphous carbon can be converted to graphene sheets as the minor side products in CNT formation. [Gog 2013]. This further supports the observation that the 2D graphene sheets were produced from the carbon black.

TEM images showed the presence of metallic nanoparticles at the base of plastic derived F1DM. The lattice spacing matched that of the metal oxide of the original catalyst used, indicating that during the FJH process, the high temperatures resulted in degradation of the metal salt to form nanoparticles that facilitate deposition of mobile carbon which then nucleated to form the thermodynamically favored graphitic domains that elongate into F1DM. At lower catalyst loading concentrations, fewer or smaller nanoparticles will form, and 2D graphene morphologies will form, explaining why F1DM morphology and diameter vary with catalyst concentration.

Similarly, the type of salt catalyst will determine the degradation temperature at which catalytic nanoparticles will form, and the rate of nanoparticle formation, impacting F1DM formation. Both metal nanoparticles and metal oxide nanoparticles are known to catalyze the growth of CNF and CNT materials, so it is unknown if the nanoparticles formed in situ during the FJH reaction are metal or metal oxide. It is believed that the catalytically active species is the neutral metal species, which is then converted to oxide once the sample is removed from the FJH reactor and exposed to air. Since the metal or metal oxide catalyst nanoparticles are formed in situ during the FJH reaction, there would be no need to add expensive catalysts, such as noble metal nanoparticles to the reaction scheme, as are often used in CVD methods.

To better understand the relationship between catalyst concentration and F1DM diameter, TEM imaging was used to probe the size of the catalytic nanoparticles as catalyst concentration is changed. These showed that when the catalyst loading concentration was decreased, the size of the catalytic nanoparticles decreased, which resulted in a decrease in the diameter of F1DM. At high metal salt loadings, some catalytic nanoparticles could be seen without a surrounding F1DM coating. This indicated that the catalyst concentration in the wetting solution has control over the size and abundance of nanoparticles formed.

The catalytic effect of Fe, Ni, and Co particles in synthesis of carbon 1D structures is commonly considered in CVD conditions, where carbon feedstock containing is deposited on the nanoparticle's surface, diffuses through the particle, and is incorporated into the growing graphitic domain. [Fouquet 2012]. The majority of previous studies were focused on carbon nanotube formation from gaseous sources, leaving catalytic graphitization of amorphous carbon unexplored. [Wang 2007]. Previous work has demonstrated that stopping the FJH reaction early results in a carbonized product with substantial amorphous content, and considerable graphitic lattice disorder, suggesting an amorphous intermediate between polymer and graphitic product. [Algozeeb 2020]. Further, since a mixture of morphologies was obtained, rather than only 1D morphologies as is commonly obtained from the catalytic pyrolysis of plastics, this revealed that a different mechanism may be occurring. The solid amorphous intermediate can be converted to graphitic products, which are 1D when on the catalytic nanoparticles.

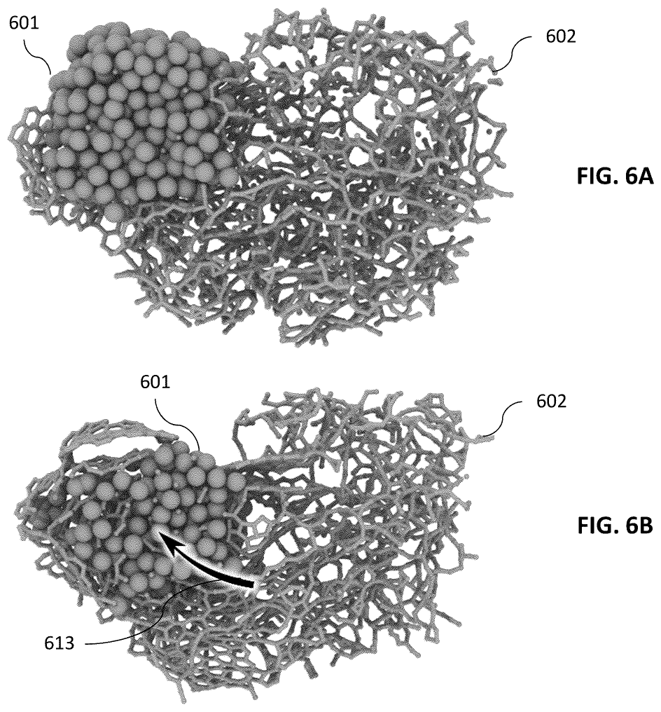

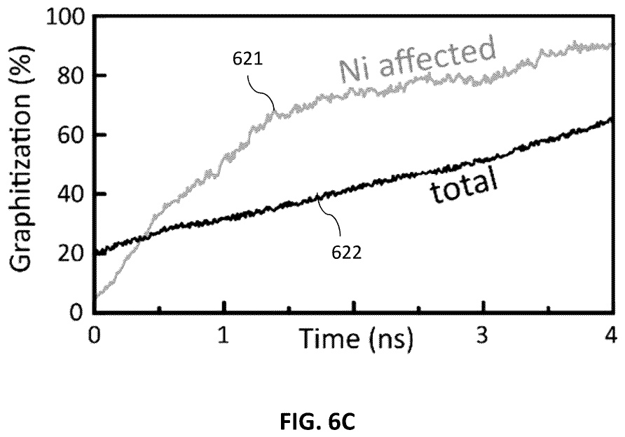

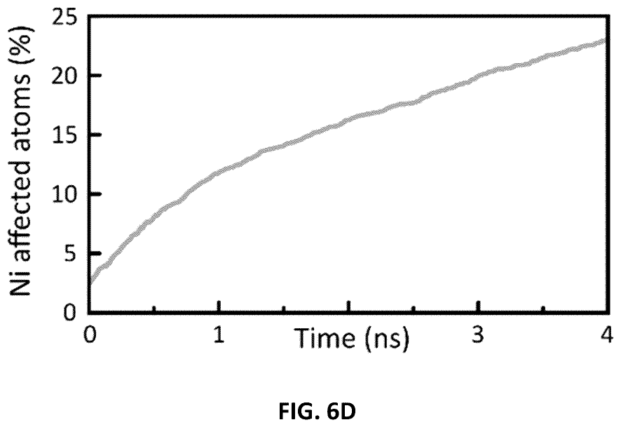

To investigate the effect of metal inclusions within the FJH setup, the behavior of the amorphous carbon domain in contact with the Ni nanoparticle (FIG. 6A) was examined through molecular dynamics. FIG. 6A shows configuration after initial pre-annealing already shows some carbon atoms of the amorphous carbon 602 dissolved within the Ni nanoparticle 601. The system was heated and kept at 3000 K for 4 nsec to simulate high temperatures of FJH. The amorphous carbon underwent thermal and catalytic graphitization, both accelerated due to high FJH temperatures. Catalytic graphitization involves dissolution of carbon atoms, both from amorphous and already partially graphitized domains, into the Ni particle which then deposit on the surface, forming large 1D or hybrid graphitic domains (FIG. 6B). FIG. 6B shows the final structure shows the beginning of the carbon fiber formation through carbon interaction and catalytic graphitization, as indicated by the arrow 613.

The large size of the catalytic nanoparticle (450 Ni atoms) resulted in a large diameter carbon product distinct from existing literature results. [Chiang 2009]. Analyzing the graphitization rate, it was determined that the catalytic process accelerates amorphous carbon conversion (FIGS. 6C-6D) and the curvature and size of the metallic nanoparticles favored the formation of 1D and hybrid morphologies. FIG. 6C (plots 621-622 for Ni affected and total, respectively) shows graphitization level of all carbon and carbon affected by Ni, indicating the catalytic effect that the Ni atoms have on the graphitization of affected carbon atoms. FIG. 6D shows the percentage of carbon affected by Ni particle throughout the simulation indicating interaction of the mobile carbon with the Ni catalyst even in the short simulated timescale.

### Utility in Nanocomposites

Due to high tensile strengths, thermal and electric conductivities, and low densities, both 1D and 2D graphitic morphologies can be utilized in composites. Hybrid materials can result in excellent mechanical properties due to the 2D morphology increasing interfacial attachment between nanomaterial and matrix.

The F1DM are highly dispersible in a 1% Pluronic surfactant aqueous medium allowing concentrations of 1.63 mg mL⁻¹. Varying amounts of ground F1DM powder were weighed into centrifuge tubes, and solvent was added to yield the initial loading concentration (˜1 mg F1DM powder mL⁻¹ of solvent). The centrifuge tubes were then sonicated in a cup-horn sonicator for 10 min (Cole-Parmer Qsonica 448) and centrifuged at 550 relative centrifugal force for 5 min to remove larger aggregates. The supernatant was decanted after centrifugation and diluted 100× since the graphene concentration leads to a very high absorbance. The absorbance of the solution was measured at 660 nm. The concentration was determined using Beer's Law with an extinction coefficient of 66 L g⁻¹ cm⁻¹.

7 g of F1DM was produced to test loadings of 0.5, 2, and 5 wt %. The F1DM was readily dispersible in the vinyl ester matrix material through brief cup horn sonication. Vinylester (VE) resin was obtained from Fiberglass Supply Depot and used as received. Methyl ethyl ketone peroxide (MEKP) was obtained from Fiberglass Supply Depot and used as received as a catalyst/hardener for the resin. F1DM/VE Composites were prepared by combining 5.0 g of vinyl ester and 20-200 mg of F1DM, depending on the desired loading, in a 20 mL scintillation vial. The solution was then mixed using a magnetic stir bar for 30 min at 300 rpm. After stirring, the solution was then shear mixed with a homogenizer obtained from Cole-Parmer (Tissue Tearor 986370-07 Homogenizer; 120 VAC, 1.2 A) for 5 min. at ˜10,000 rpm. 5 drops (˜0.15 g) of MEKP were then added to the solution while stirring with a magnetic stir bar at 300 rpm for 5 min. The solution was then poured into a PDMS mold coated with release agent and allowed to cure overnight.

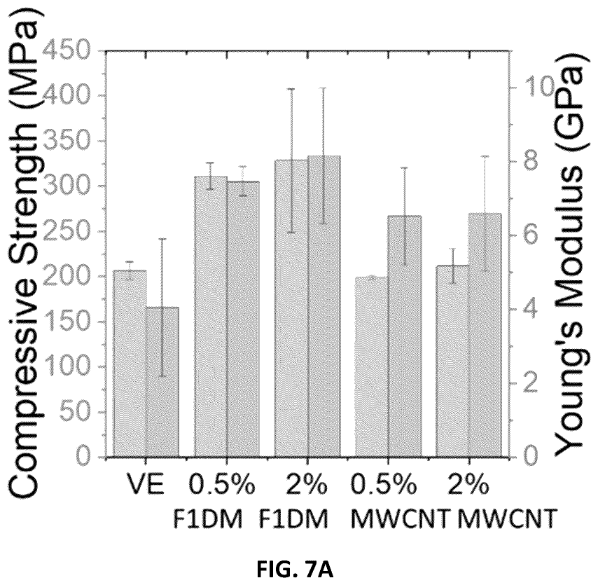

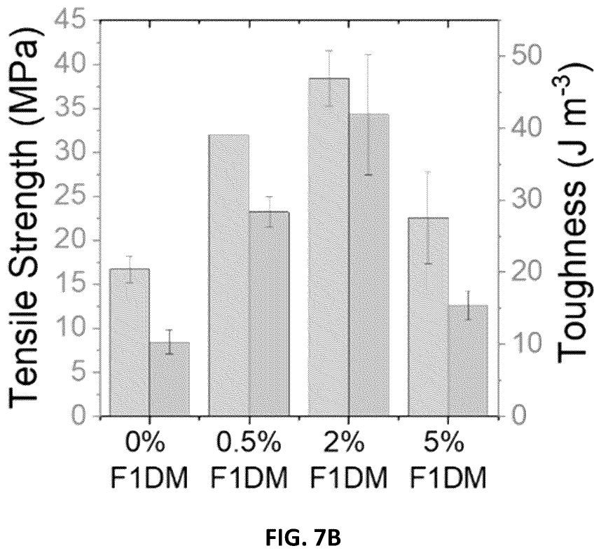

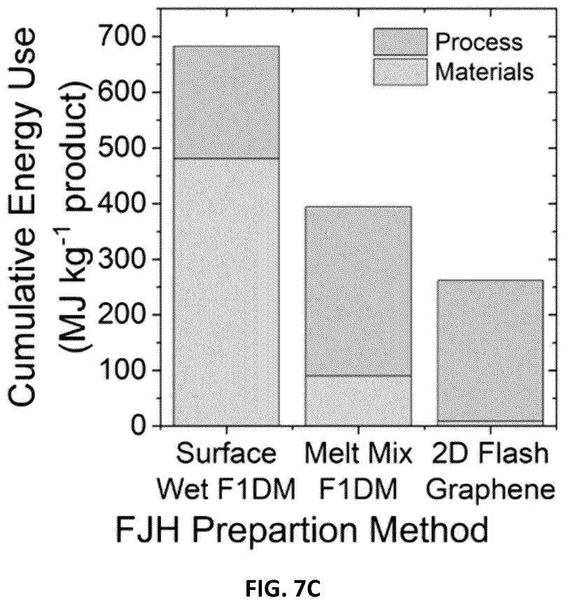

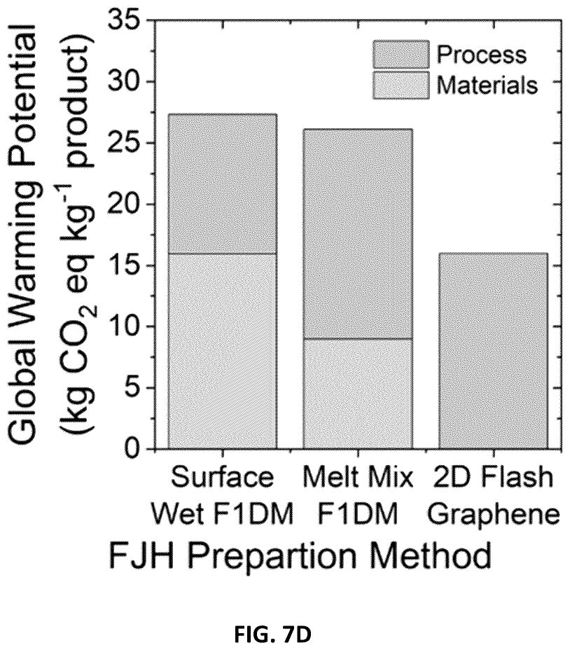

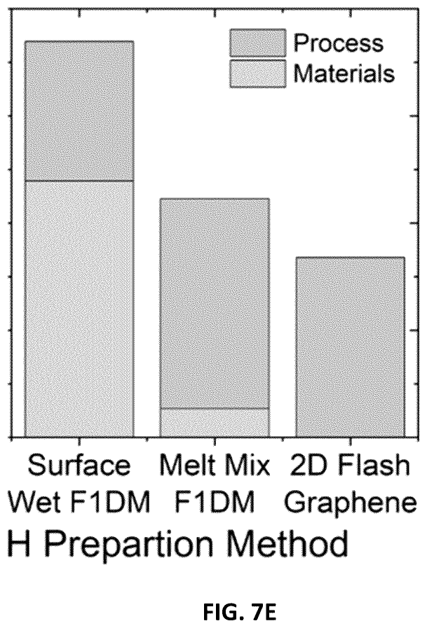

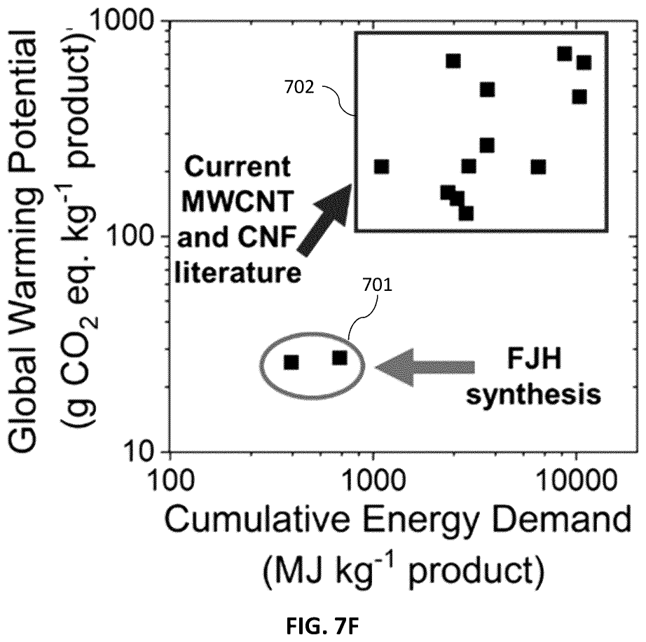

The F1DM reinforced vinyl ester resin nanocomposites tested using nanoindentation demonstrated a dramatic increase in compressive modulus at even 0.5 wt % resulting in a 21% increase. Macro-scale mechanical testing indicates substantial improvements under tensile extension and compression (FIGS. 7A-7B) with the F1DM composites showing 92%, 130%, and 48% increases in tensile strength and 174%, 304%, and 63% increases in toughness at 0.5, 2, and 5 wt %, respectively.

The decrease in mechanical properties as the loading is increased from 2% to 5% is believed to be a result of F1DM aggregation in the vinyl ester matrix material. It is well known that nanocomposites do not exhibit a linear increase in mechanical properties as more reinforcing agent is added, but rather have an optimal maximum, usually less than 5% loading. [Medupin 2019; Roy 2018]. The interphase properties of polymer nanocomposites is complex and directly impact the macroscale mechanical properties, but can depend of surface area, aspect ratio, and dispersibility of nanomaterials, viscosity of the matrix material, and interfacial interactions between the phases. [Ashraf 2018; Zare 2016].

F1DM loaded vinyl ester was compared with the composite properties of vinyl ester loaded with commercially available carbon nanotubes made using traditional methods (FIG. 7A). F1DM outperformed commercial nanotubes tested in nanoindentation and macro-scale compressive testing (FIG. 7A), likely due to the hybrid morphology and high graphitic purity, and F1DM improves the properties of neat vinyl ester matrix material (FIG. 7B).

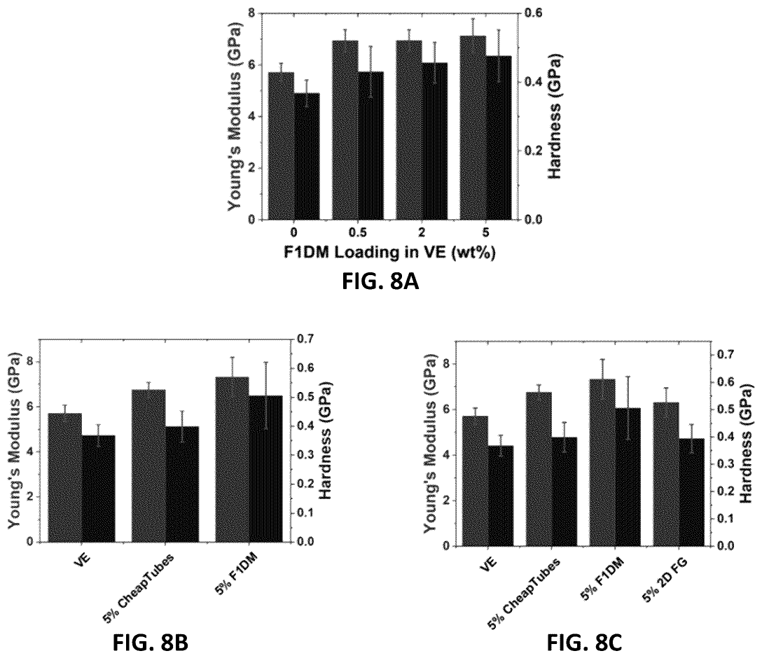

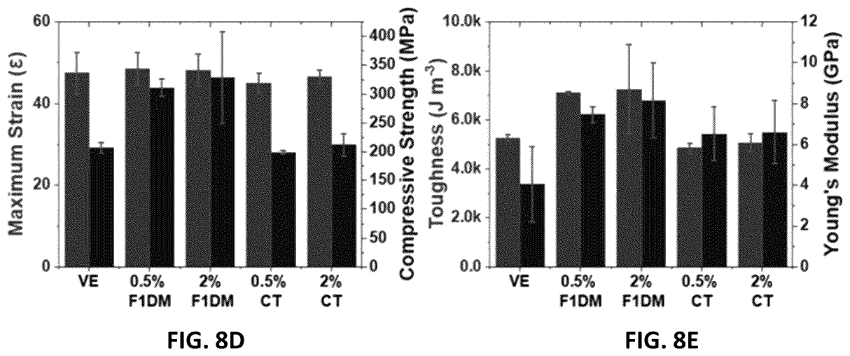

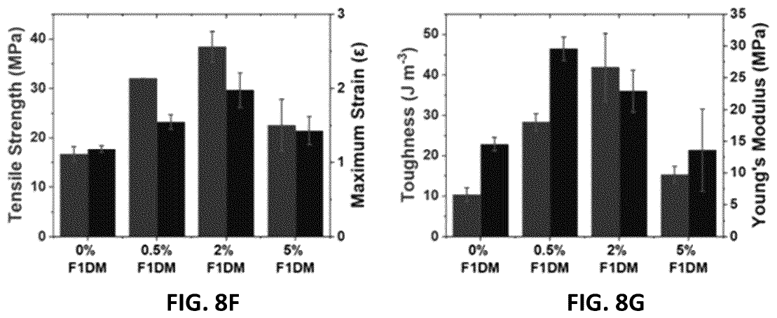

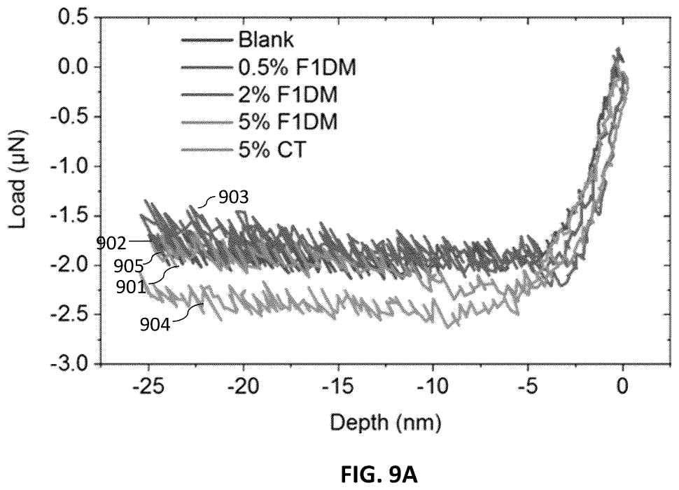

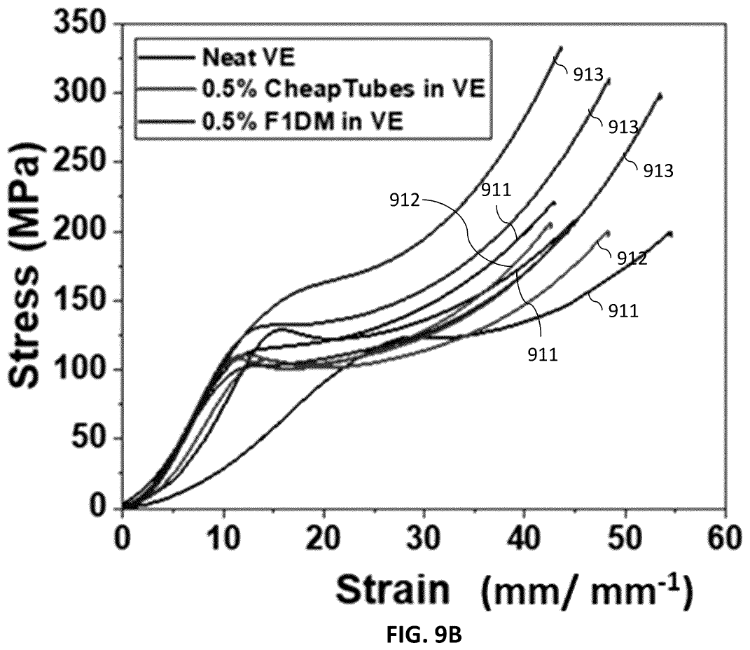

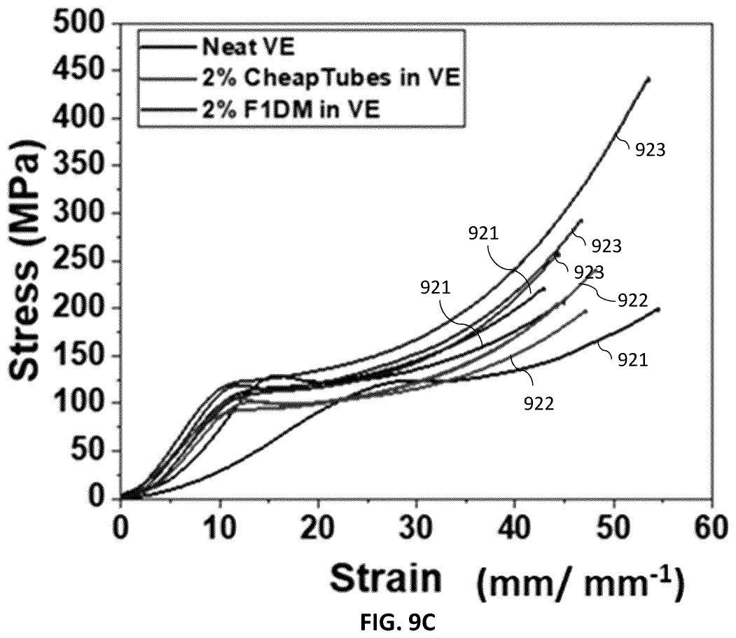

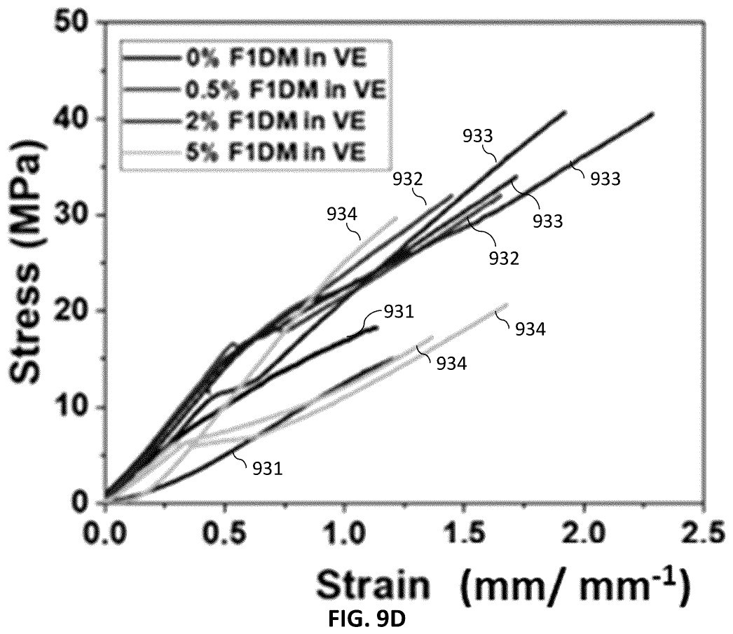

To show the advantage of F1DM as compared to graphene produced by FJH without the inclusion of catalysts, the best-performing sample (5% F1DM) was compared with a similarly prepared sample that contains 5% 2D graphene produced by FJH. FIGS. 8A-8G and FIGS. 9A-9D show that F1DM outperforms graphene produced by flash Joule heating in nanoindentation testing. FIGS. 8A-8C show nanoscale compressive testing, FIGS. 8D-8E show macro-scale compressive testing, and FIGS. 8F-8G show macro-scale tensile testing.

FIG. 9A (plots 901-905 for blank, 0.5% F1DM, 2% F1DM, 5% F1DM, and 5% CT, respectively) shows nanoscale compressive testing. FIG. 9B (multiple plots 911-913 for neat VE, 0.5% cheap tubes in VE, and 0.5% F1DM in VE, respectively) and FIG. 9C (multiple plots 921-923 for neat VE, 2% cheap tubes in VE, and 2% F1DM in VE, respectively) show macro-scale compressive testing. FIG. 9D (multiple plots 931-934 for 0% F1DM in VE, 0.5% F1DM in VE, 2% F1DM in VE, and 5% F1DM in VE, respectively) shows macro-scale tensile testing.

F1DM outperforming graphene produced by flash Joule heating in nanoindentation testing is likely due to the hybrid morphology of F1DM improving matrix penetration and strain propagation properties of the vinyl ester. Thus, it is shown that the F1DM hybrid morphology mechanically outperforms both 1-D and 2D graphitic carbon nanomaterials as an additive in vinyl ester.

1D graphitic nanomaterials are well-known for their conductivity, and this property is often capitalized upon in nanocomposite materials. As such, the conductivity of the produced F1DM/vinyl esters was measured as shown in TABLE I, which demonstrates an increase in conductivity as the loading increases; however, commercial MWCNT outperforms the F1DM as a conductive additive. This is likely a result of the longer aspect ratio of commercial MWCNT when compared to the F1DM.

TABLE I
Conductivity Measurements Of Nanomaterial
Enhanced Vinyl Ester Composites

| | Sample DC Electrical |
|---|---|
| Material | Conductivity (S/m) |
| Raw Vinyl Ester Matrix | <1E−10 |
| 0.5 wt % added F1DM | <1E−10 |
| 2 wt % added F1DM | 1.72E−08 |
| 5 wt % added F1DM | 4.26E−08 |
| 5 wt % added Commercial MWCNT | 1.19E−02 |

### Cradle-to-Gate Life Cycle Assessment

A cradle-to-gate life-cycle assessment was conducted to examine the FJH method of F1DM synthesis as the impacts of application and disposal will vary negligibly based on the synthetic method of the graphitic 1D material.

Regarding the life-cycle assessment scope, goal, functional unit, and inventory, a cradle-to-gate life-cycle assessment is a systematic analysis of the demands and impacts associated with a product from raw materials required for synthesis to the processing and manufacturing of the product and does not examine the final disposal end-use application or disposal of the product. The specific goal of the life-cycle assessment herein was to evaluate the demands and environmental impacts resulting from the FJH production of F1DM to compare with literature benchmarks studying the production of graphitic 1D materials synthesized using other methods. The system considered here covers three main steps: raw material production, reaction feedstock preparation, and FJH reaction. Transportation of raw materials was not considered here, and a lab-scale process was assumed. The functional unit considered here was 1 kg of high purity graphitic 1D material powder, with a >95% graphitic content, as this is the purity level commonly sold for gram-scale or larger applications, such as composites or coatings. The environmental impacts pertaining to the production of waste polyethylene were not considered herein; however, the burdens for collection and separation of postconsumer waste polyethylene have been included. [Martin-Lara 2022]. Direct energy inputs for the FJH process were measured experimentally, and cumulative demands and impacts were calculated using Argonne National Laboratory GREET life-cycle assessment.

The surface wetting method used virgin HDPE powder, wet by 4 L of 80/20 vv water/EtOH solution per kg of polymer, bath sonicated for 15 min, and centrifugation recovering 75% of the solution. The polymer mixture was air dried, and 20 wt % carbon black was mixed in using ball milling. The mixture of salt loaded polymer and conductive additive was then FJH and used without further purification, resulting in 1 kg of F1DM mixed morphologies that is >95% carbon and graphitic content. Alternatively, the melt mixing method considered waste polyethylene with iron acetylacetonate at a 0.25 wt % loading. The homogeneous melt mix was cooled and electrically hammer milled to 1 mm particle size, then mixed with 33 wt % metallurgical coke (3 mm particle size) to give a conductive mixture. The mixture was then FJH, pushed from the quartz tube, and sieved to separate the F1DM from the metallurgical coke, affording highly pure 1D morphologies with >95% carbon and graphitic content. Direct comparison of our life-cycle assessment with other literature values was possible if all databases utilized (e.g. GREET, SimaPro, Ecoinvent, and Gabi) follow International Standards Organization best standard procedures.

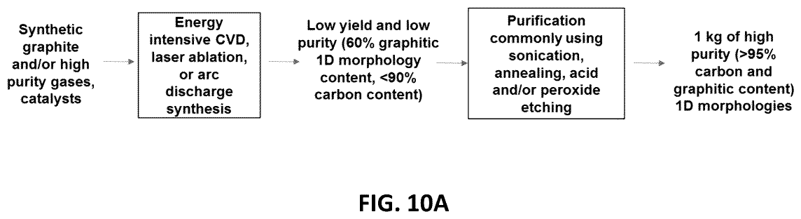

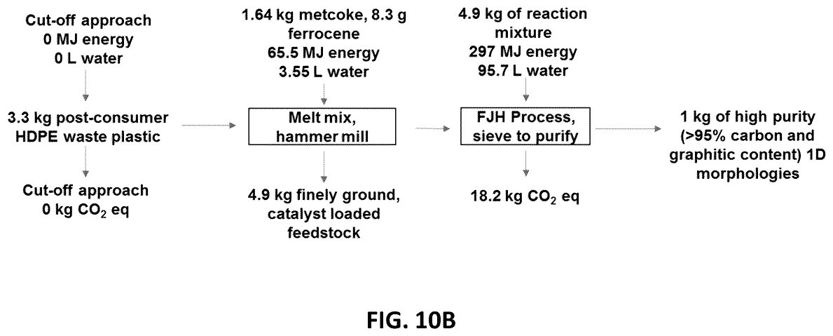

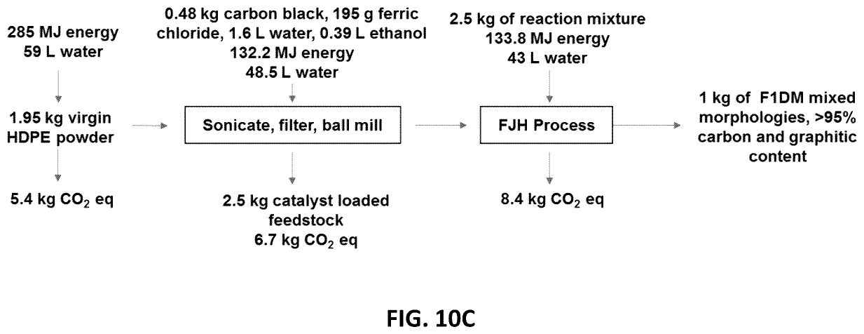

A general scheme for the industrial synthesis of nanotubes and the life cycle inventories are shown in FIGS. 10A-10C. FIG. 10A shows a scheme for general commercial methods, FIG. 10B shows a scheme for melt mixing and FJH for F1DM, and FIG. 10C shows a scheme for surface wetting and FJH for F1DM. This life-cycle assessment considered two different synthetic scenarios: melt mixing of waste polymer and surface wetting of virgin polymer to determine the cumulative energy demand, global warming potential, and cumulative water use (FIGS. 7C-7E).

F1DM synthesis was compared to FJH 2D graphene synthesis from post-consumer waste plastic, where no catalyst loading is needed. [Wyss II 2022]. F1DM synthesis using surface wetting consumed 683 MJ and 185 L of water and produced 27 kg of CO₂ equivalent per kg of graphitic product produced. Most of the impacts resulted from the virgin polymer and conductive additive. When considering the melt mixing scenario, the process used 395 MJ and 111 L of water, while producing 26 kg of CO₂ equivalent per kg of graphitic product produced. The impacts resulting from the synthesis of the waste polyethylene were disregarded, but the collection and separation burdens were considered. For the waste polymer melt mixing scenario, most burdens result from FJH.

Comparing the FJH synthesis of graphitic 1D and hybrid materials to literature was complicated by the wide variety of morphologies produced. Single-walled nanotubes were not considered a comparable product; only multi-walled nanotubes or nanofibers are compared. Comparing the FJH synthesis of F1DM to International Standards Organization compliant life-cycle assessments of graphitic 1D materials indicated a reduction in both energy use and global warming potential to synthesize 1 kg of graphitic 1D material. FIG. 7F shows the comparison of the two FJH synthesis of F1DM strategies considered in the life-cycle assessment, as compared with literature life-cycle assessment probing the synthesis of carbon nanotubes or nanofibers. TABLE II provides the numerical values and references for the data plotted in FIG. 7F, comparing the cumulative energy demand (CED) and global warming potential (GWP) of F1DM strategies (which are within oval 701) to literature life cycle assessment (LCA) probing the synthesis of MWCNT and CNF (which are within block 702). The units for CED is MJ kg⁻¹, while the units for GWP is g CO₂ eq kg⁻¹ product.

TABLE II

| Material | CED | GWP | Reference |
|---|---|---|---|
| M-CVD1 | 2960 | 212 | Temizel-Sekeryan |
| M-CVD2 | 10400 | 445 | 2021 |
| M-CVD4 | 8780 | 704 | |
| M-CVD5 | 3640 | 265 | |
| M-CVD6 | 2590 | 150 | |
| CVD vgcnf | 2872 | 128 | Khanna 2008 |
| CVD vgcnf | 10925 | 640 | |
| CVD MWCNT | 2334 | 160 | Wu 2020 |
| CVD MWCNT | 2480 | 652 | Trompeta 2016 |
| CVD MWCNT | 1100 | 211 | |
| Melt mix, MC, WP | 363.0 | 19.5 | Herein |
| Surface Wet, CB. VP | 683.1 | 27.3 | |
| CVD MWCNT | 3650 | 480 | Teah 2020 |
| CVD MWCNT | 6523 | 210 | |

The literature average for cradle-to-gate energy demand to form 1 kg of graphitic 1D materials is 4,855 MJ, while the average global warming potential is 355 kg of CO₂ equivalent, represent 86-92% decreased in cumulative energy demand and 92-94% decreased global warming potential for the FJH route.

### Further Applicability

FJH can rapidly and controllably synthesize a variety of high value graphitic 1D or hybrid materials using earth-abundant simple salts and waste plastic, with demonstrated value, in an inexpensive, sustainable, and efficient manner. Further the F1DM can be doped or functionalized.

### Boron Nitride Nanotubes (BNNTs) Synthesis By FJH

In embodiments, the present invention further relates to the synthesis of BNNT by using flash Joule heating (FJH) processes. The processes are carried in a solid-phase and under moderate reaction pressure (1 atm Ar) and temperature (˜1800 K) and no solvent was used. Ammonia borane(AB) and nickel(II) bis(acetylacetonate) (Ni(acac)₂) can be used as the precursor and catalyst, respectively. The products, mainly BNNT and h-BN, can be directly separated from the conductive additives after the synthesis.

Boron nitride nanotubes (BNNTs), known as the structure analog of carbon nanotubes (CNTs), have attracted significant attention for their exceptional intrinsic properties and wide-ranging applications. Despite their potential, rapid synthesis of BNNTs with high yield and quality remains challenging to attain, which limits their development of practical applications. Using an all-solid-state catalytic flash Joule heating method (a catalytic growth process), BNNTs can be synthesized within 1 second, resulting in high yield and selectivity of BNNT and BN nanosheets. The products can be directly separated from the conductive additives, such as carbon or metal powders. This further provides for a continuous, scalable synthesis of BNNTs using the FJH method and provides potential catalytic synthesis of other materials.

f-BCN with various chemical compositions and turbostratic characteristics can be synthesized from BH₃NH₃ and carbon black in <1 s using the ultrafast and solvent-free FJH method. The atomic percentage of carbon can be controlled from ˜0% to ˜100% and spectroscopic analyses show the VBM can be correspondingly tuned. At the lower percentages of carbon, the f-BN is very close to t-BN in its spectroscopic characteristics. Calculations support the existence of turbostratic structures along with the energy barriers that impede conversion to the well-aligned counterparts. The obtained f-BCN layers with disordered orientation are easily exfoliated. Compared to commercial h-BN nanoplates, f-BCN samples demonstrate stable dispersibility in aqueous Pluronic (F-127, 1 wt % in deionized water).

Furthermore, the addition of f-BCN as barrier fillers in PVA nanocomposites shows better compatibility and they confer higher corrosion protection efficiency. The turbostratic morphology of f-BCN is difficult to reproduce by common bottom-up methods, such as CVD and hydrothermal methods, whose cooling rates are 100-1000× lower than that of FJH. The FJH method offers a high-yield process to synthesize bulk quantities of turbostratic materials.

### Synthesis of BNNT by FJH

To synthesized BNNT by FJH, ammonia borane (AB) was chosen as the representative precursor because its decomposition at different temperatures has been studied and both B and N are provided at a stoichiometric ratio. AB has been extensively studied as the monolayer h-BN precursor in CVD. [Tay 2014; Stehle 2015; Koepke 2016]. Suib et al. demonstrated that decomposition of AB yields semi-crystalline h-BN. [Frueh 2011] Prior to h-BN growth, it is common practice to perform low-temperature decomposition of AB to generate polymeric radical species and borazine, which are more reactive in CVD. B-N bonds are maintained during the decomposition while H₂ experienced a stepwise loss. The FJH system that can be utilized (and parameters) can be based on the system set forth and described in the Tour '642 Application and the Tour '111 PCT Application with the modifications as discussed below. [See also Luong 2020; Chen 2022; Deng 2022].

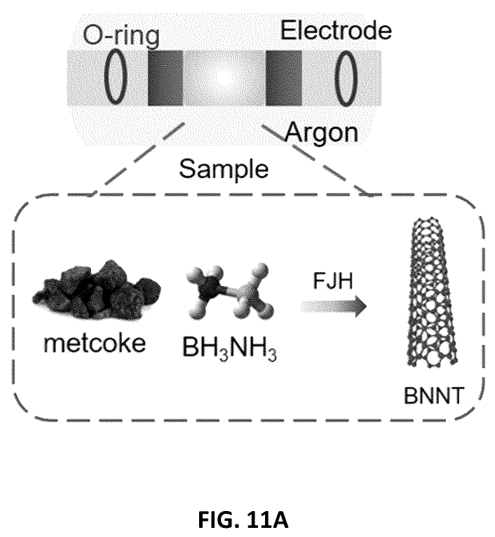

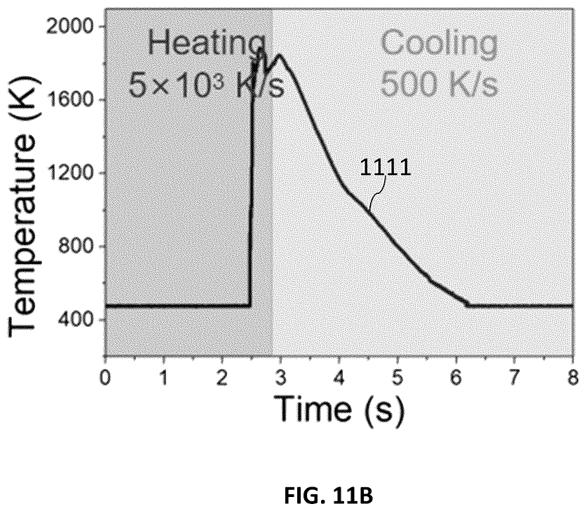

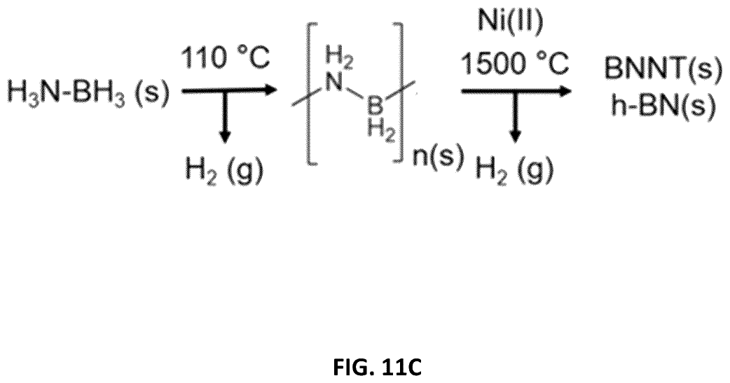

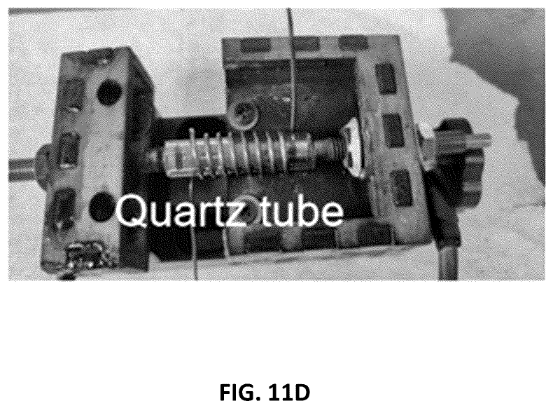

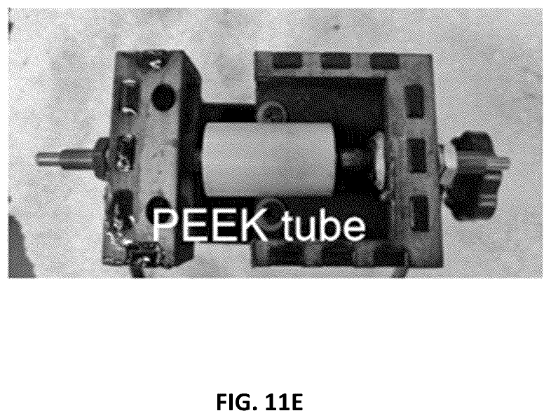

In embodiments of the present invention, the device diagram and temperature curve are shown in FIGS. 11A-11B. In a typical FJH process, the mixture of AB, Fe(acac)₃/Ni(acac)₂ catalyst, and metallurgic coke (metcoke) is compressed inside a quartz tube between two graphite rods. The two graphite electrodes were connected to a capacitor bank with a total capacitance of 60 mF. Then the current passing through the sample was measured after the rapid discharge under different voltages. The real-time temperature can be measured using an infrared sensor as plotted (FIG. 11B). The heating rate is up to 5×10³ K/s. To reduce the carbon content in the product, metcoke (12-20 mesh, or 840-1680 μm) was used as the conductive additive instead the carbon black powder. The large particle size of metcoke allows for a convenient separation by sieving and weight loss of metcoke at reaction temperature is negligible. AB and its decomposed species are susceptible to oxidation at high temperature. To reduce the oxygen contamination, O-ring sealing was used on both electrodes in the quartz tube and Ar was used as the protective atmosphere. AB, Ni(acac)₂ were mixed and heated to 110° C. to ensure a uniform melt-mixing (FIG. 11C). Two types of tubes can be used in the FJH process (FIGS. 11D-11E).

For example, in a typical experiment, ammonia borane was mixed and ground with 3 wt % Ni(acac)₂ and 3 wt % Fe(acac)₃ and heated to 120° C. for 10 min. Then the mixture was mixed with metcoke at a mass ratio of 1:1. The reactant was added into a quartz tube (inner diameter of 8 mm and outer diameter of 12 mm). Graphite rods were used as the electrode on both sides of the quartz tube and copper wool was used between the graphite rods and the electrodes. The tube was sealed by two O-rings and loaded into the jig. Ar gas (˜1 atm) was used as an inert atmosphere to avoid sample oxidation during the FJH reaction. The capacitor bank with a total capacitance of 60 mF was charged by a DC supply. The discharge time was controlled by the Arduino controller relay with programmable millisecond-level delay time. The optimized condition for BNNT synthesis is 90 V 500 ms for twice. After the FJH reaction, the apparatus was allowed to vent and cool to room temperature. The flashed products were sieved from a 40-mesh sieve (425 μm metric) to separate metcoke and BNNT/BN products. The mass yield is ˜45% of the theoretical BN yield in the quartz tube and ˜60% in the PEEK tube. ˜30% the products are in tubular structure and the rest are sheet-like structure.

### Characterization of BNNT

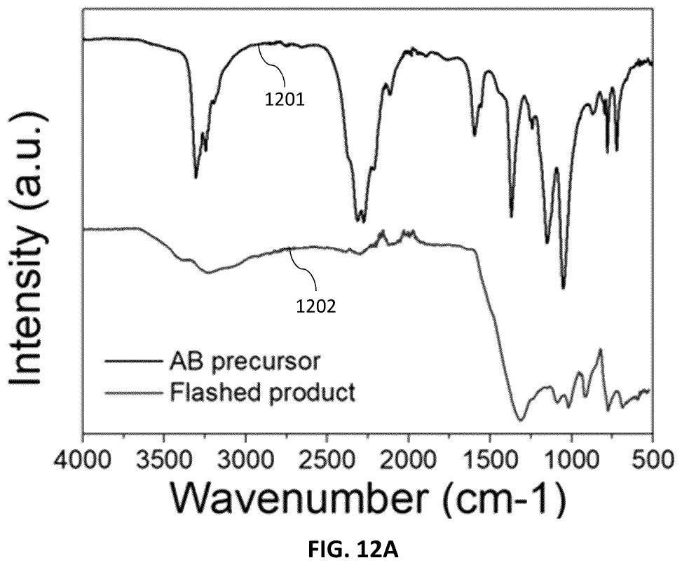

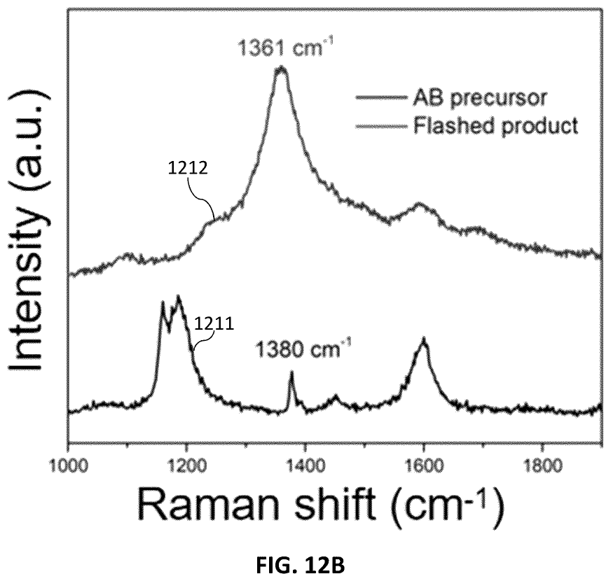

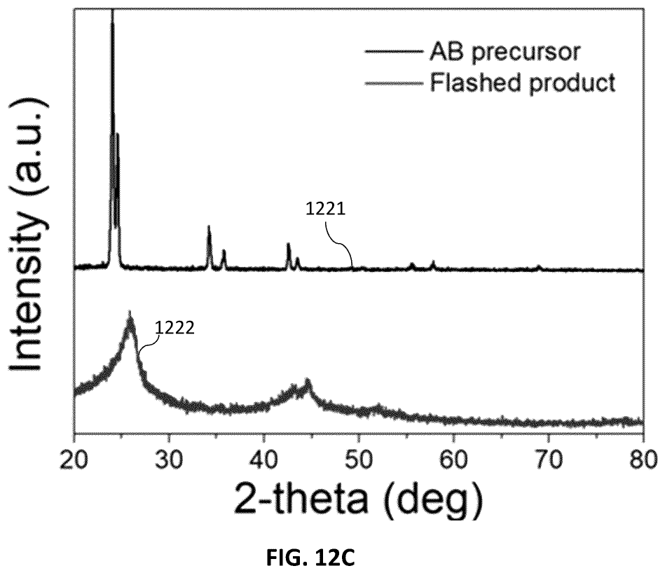

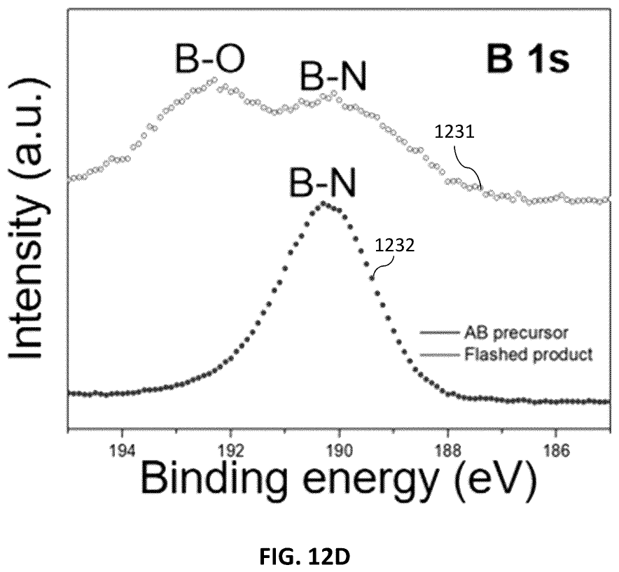

Spectroscopic analysis and imaging techniques were used to confirm the formation of BNNT in the flashed product. FIGS. 12A-12D. In the FTIR spectra, the flashed product showed a B-N stretching peak at 1317 cm⁻¹ and a B-N-B bending peak at 780 cm⁻¹. FIG. 12A (with plots 1201-1202 for AB precursor and flashed product, respectively). The peaks are in accordance with those in commercial h-BN. Some peaks are consistent with the peaks of AB precursor, which indicates a small mount of AB presence.

The Raman peaks for AB precursors are absent in flashed product. FIG. 12B (with plots 1211-1212 for AB precursor and flashed product, respectively). The characteristic E_{2g} peak appears at ˜1361 cm⁻¹ in plot 1212, which is lower than the E_{2g} peak in the h-BN (˜1368 cm⁻¹). The blueshift can be ascribed to the strain in the tubular structure and hardening of E_{2g} mode. [Arenal 2006].

In XRD patterns, the AB precursor peaks disappeared in the products. FIG. 12C (with plots 1221-1222 for AB precursor and flashed product, respectively). In plot 1222, the peak at 26.0° corresponds to the characteristic (002) diffraction peak of BN and peaks at 43.4° and 44.5° correspond the (100) and (001) diffraction peaks. The broadened peaks suggest the formed BN sheets and BNNT are not highly crystallized. BNNTs also showed broadened (002) peaks compared to h-BN materials in previous reports. [Lee J 2021; Kim H 2021].

The B is spectra confirmed the purity of BN products. FIG. 12D (with plots 1231-1232 for AB precursor and flashed product, respectively). Slight oxidation can be observed in AB precursor (˜10%) since AB absorbs water rapidly in air. In flashed product, only B-N bonds present and no obvious B-O and B-C bond formed. The B/N ratio is ˜1.06.

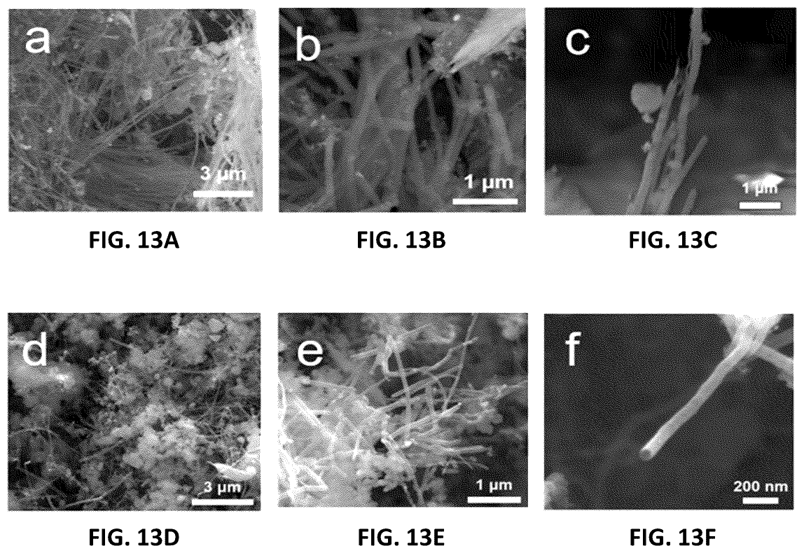

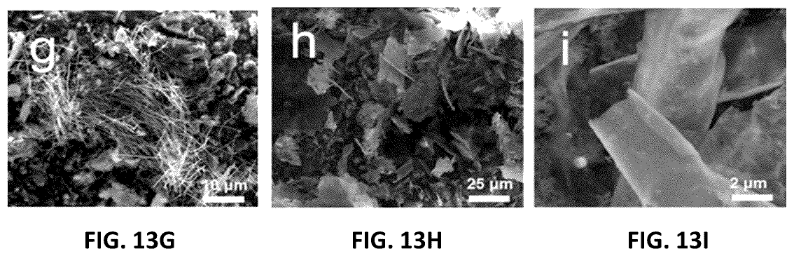

The formed BNNT structure can be seen in the SEM images. FIGS. 13A-13I. BNNT can be found both in quartz tube (FIGS. 13A-13C) and PEEK tube (FIGS. 13D-13F), revealing the tube growth is not dependent on the outer container. The multi-walled BNNTs showed both hollow and non-hollow morphology in the sample. However, the formed tubular structure in the PEEK exhibited higher hollow ratio likely due to higher pressure can be maintained in the PEEK tube. The high pressure promotes the BNNT selectivity to BN sheets and BNNT crystallinity. [Bae 2022]. The length and diameter of BNNT were 20-50 μm and 50-100 nm, respectively. It was observed in the flashed product with a selectivity of ˜30% and the rest of the product are sheet-like BN structure. FIGS. 13H-13I.

Two types of BNNTs morphology could be distinguished in the TEM images. The tube without an obvious hollow structure exhibited a diameter of 30-50 nm while the hollow tube showed a diameter of 50-100 nm. TEM analysis showed crystalline domains on the outer region of BNNTs. The interlayer spacing of 0.353 nm was slightly larger than that of crystallized h-BN (0.333 nm). The result is consistent well with the broadened (002) and shifted peak in the XRD pattern. An increased lattice spacing would result in resulting the diffraction peaks to higher angle.

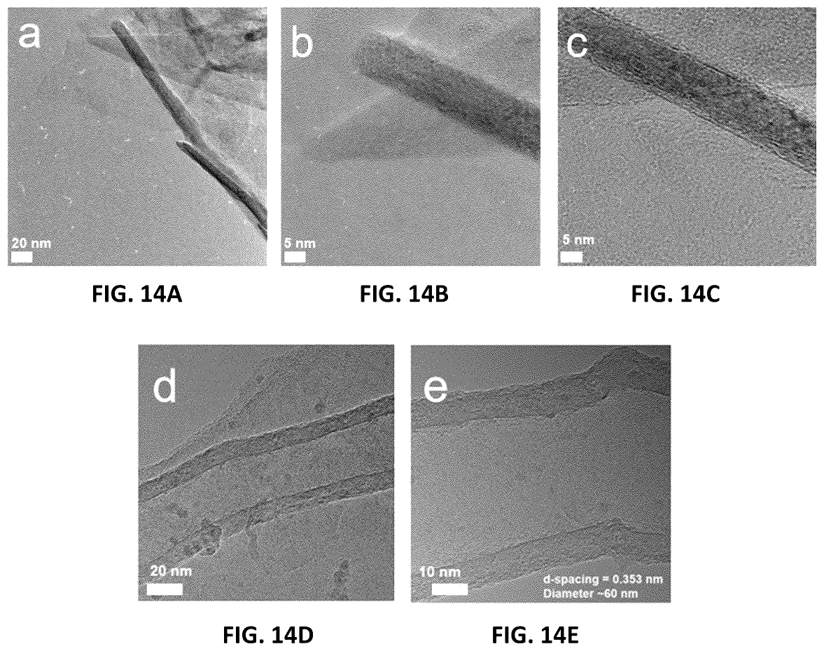

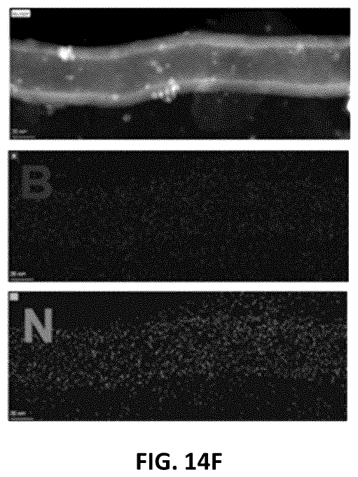

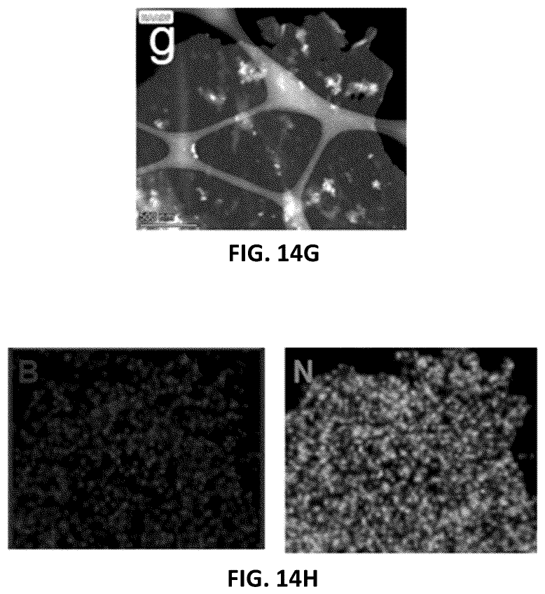

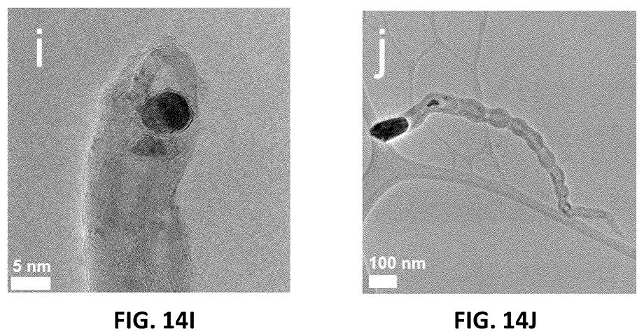

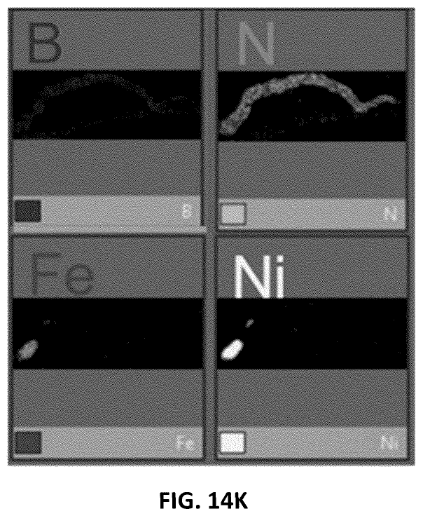

BN sheets (lateral size of ˜100 nm) were also noticed in the FIGS. 14A-14B. The clear edge fringes suggest the good crystallinity of the few-layer BN nanosheets. The bright-field (BF) and high-angle annular dark-field scanning transmission electron microscopy (HAADF-STEM) images, together with elemental mapping, indicate the existence of B, N in BNNTs and BN nanosheets (FIGS. 13G-13I), which is consistent with XPS results.

### Catalyst Effect

The catalyst effect in the FJH technique is discussed above with regard to the synthesis of 1D carbon materials. The usage of proper catalyst enabled promotion of the reaction rate and selectivity. To investigate the catalyst effect in the catalytic decomposition and BNNT growth process, various types of catalyst were used in the synthesis. No obvious tubular structure formations were observed in the reactions using metal borides, metal chlorides, metal powders as the catalysts, which suggested the catalyst effect might be different from the BNNT growth process in the CVD method.

It has been found that the combined Ni(acac)₂/Fe(acac)₃ catalyst showed an enhanced selectivity towards tubular structure over sheets. The presence of Ni/Fe catalyst was confirmed in the elemental mapping of HAADF-STEM images. FIG. 14K. The major decomposition product of Fe(acac)₃ is Fe₂O₃/Fe₃O₄ at ˜400° C. [Kim H 2021; Toyos-Rodriguez

The metal oxide particles can be found in the heads of the BNNT. The growth mode is accordance with the typical VLS mechanism in CVD. The growth mechanism of BNNT during the FJH process is believed to be as follows: Active B-N species first forms and evaporates during the rapid dehydrogenation process over 200° C., followed by the decomposition of Ni(acac)₂/Fe(acac)₃ into metal oxide particles at ˜400° C. The last dehydrogenation step from NHBH(s) to BN(s) require a high temperature of over 1200K. [Demirci 2020]. Semi-crystalline h-BN was found to form at ˜1500K [Frueh 2011] and the h-BN morphology is similar to the BN sheets in our flashed products. BNNTs started to grow at the temperature window of 1500-1800K. The rapid dehydrogenation and high local B-N species concentration enabled the selectivity towards BNNTs instead of h-BN. The comparison of FJH-synthesized BNNT between other BNNT synthesizing methods are listed in TABLE III. FJH method reduces the cost of producing BNNT in a large scale by decreasing the reaction temperature, pressure, and duration.

TABLE III
Comparison of Recent BNNT Synthesizing Methods

| Method | Temp | Pressure | Prec/Cat | Duration | | Impurities |
|---|---|---|---|---|---|---|
| Ball-milling | / | 1 bar N₂ | B₂O₃ | 80 h, 12 h NH₃ | | BN sheets, |
| | | | | annealing | | B₂O₃, |
| | | | | | | amorphous B |
| Ball-milling | / | 1 bar N₂ | B₂O₃/Mg | 4 h, 2 h NH₃ | | BN sheets, |
| | | | | annealing | | B₂O₃ |
| Laser ablation | 3800K | 14 bar N₂ | B | / | | Amorphous |
| | | | | | | boron |
| Laser ablation | 4000K | 2-12 bar Ar | BH₃NH₃ | 30 | min | h-BN sheets |
| DC plasma | 5000-7000K | Ar | h-BN | continuous | | h-BN sheets |
| DC plasma | 5500K | N₂ | B | continuous | | Boron |
| | | | | | | particles |
| RF plasma | 4000K | N₂, H₂, Ar | h-BN | 5 | h | h-BN sheets |
| RF plasma | 4200K | N₂, H₂, Ar | h-BN | continuous | | Boron |
| | | | | | | particles, BN |
| | | | | | | sheets |
| BOCVD | 1500K | NH₃ | B₂O₃/ | 2 | h | BN sheets |
| | | | Fe₂O₃/S | | | |
| PECVD | 1200K | N₂, O₂ | B₃H₆N₃/ | 30 | min | Shell BN, |
| | | | Cu | | | B₂O₃ |
| CVD | 1700K | NH₃ | B/Ni | 3 | h | Boron |
| | | | | | | particles |
| CVD | 1100K | NH₃ | B/KFeO₂ | 1 | h | Boron |
| | | | | | | particles, B₂O₃ |
| BOCVD | 1300K | NH₃ | B₂O₃/Mg | 1 | h | B₂O₃ |
| FJH | 1800K | 1 bar Ar | BH₃NH₃/ | 1 | s | BN sheets |
| | | | NiFe | | | |

### Turbostratic Boron-Carbon-Nitrogen (BCN) Synthesis by FJH

In embodiments, the present invention further relates the synthesizes of BCN with turbostratic structures and high in-plane crystallinity via an all-solid-state flash Joule heating (FJH) system. It provides short pulses of high electrical energy followed by rapid cooling (10³˜10⁴K s⁻¹), all in <1 s. Starting from BH₃NH₃ and carbon black, the FJH-product is named flash BCN (f-BCN-x, where x is the carbon percentage in the reactants). Other conductive powder additives, such as iron and tungsten can also be used to replace the carbon black.

The atomic percentage of carbon can be controlled from ˜0% to ˜100% as determined via X-ray photoelectron spectroscopy (XPS) by changing the carbon content in the reactants. At the lower percentage of carbon, closely aligned spectroscopic features to those of pure turbostratic h-BN (t-BN) are observed.

The f-BCN has a turbostratic arrangement, which facilitates its exfoliation by different mechanical methods, such as adhesive tape exfoliation, monodirectional mechanical shearing, and bath sonication. Calculation results show the existence of turbostratic structures and the energy barriers converting to well-aligned counterparts.

Hexagonal boron nitride (h-BN) and graphene are two common layered materials whose interlayer interactions are ˜26 meV atom⁻¹ (˜2.5 kJ mol⁻¹) [Rydberg 2003], while the in-plane binding energy is ˜450 kJ mol⁻¹, more than two orders of magnitude higher than the interlayer interactions. Therefore, the formation of turbostratic materials with high in-plane crystallinity can be kinetically controlled by a thermal annealing followed by an ultrafast cooling process. The thermal annealing facilitates the formation of ordered in-plane structures,^{[2]} and the ultrafast cooling process preserves the misaligned stacking sequences in local, rather than global energy minima. This can be extended to doped graphene as well.[²¹]

Compared to commercial h-BN and graphene, f-BCN has better temporal stability when dispersed in aqueous Pluronic (F-127, 1 wt % in deionized water). Polyvinyl alcohol (PVA) nanocomposites containing 10 wt % f-BCN that are coated on copper foils confer improved corrosion resistance when subjected to 0.5 M sulfuric acid or 3.5 wt % saline solution.

Synthesis of f-BCN

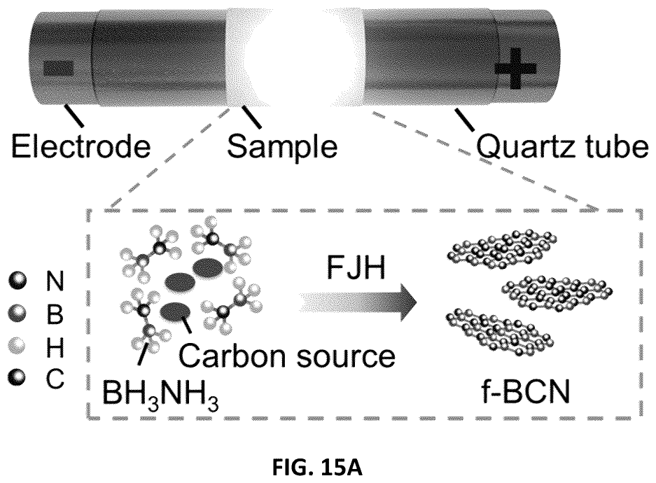

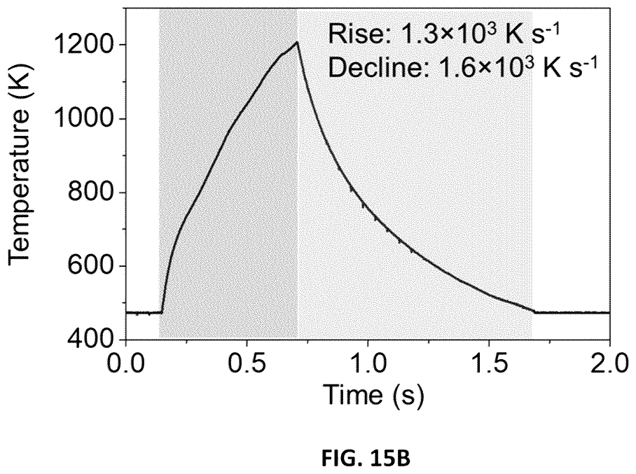

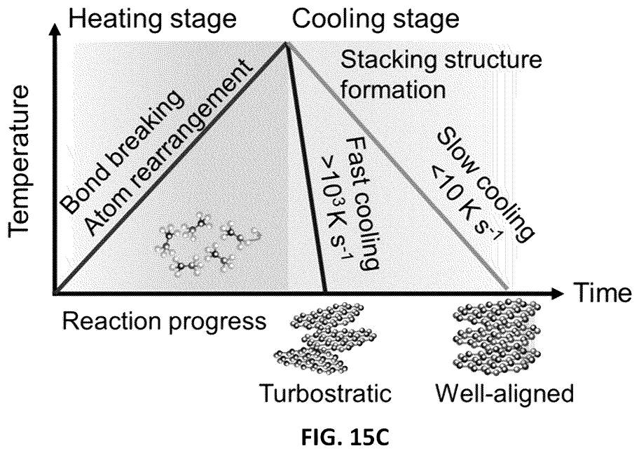

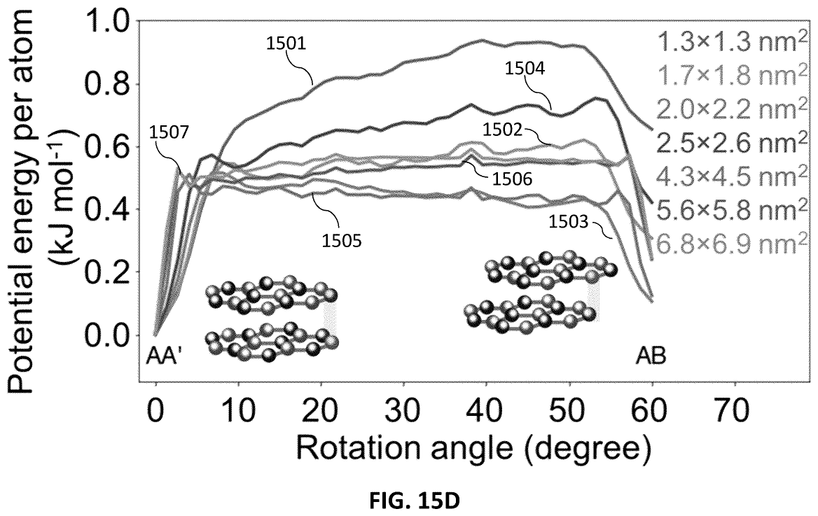

FIG. 15A illustrates the ultrafast all-solid-state preparation process based on FJH to synthesize the f-BCN in <1 s. As discussed previously herein, the FJH system that can be utilized (and parameters) can be based on the system set forth and described in the Tour '642 Application and the Tour '111 PCT Application with the modifications as discussed below.

In a typical flash process, a mixture of BH₃NH₃ and commercial carbon black is slightly compressed inside a quartz tube between two copper electrodes. BH₃NH₃ is chosen as the reactant since it serves as both a boron and nitrogen source, and there are preformed B-N bonds in the precursor. Carbon black simultaneously acts as the carbon source and the conductive agent during the reaction. The capacitor banks in the circuit are used to provide electrothermal energy to the reactants.

By changing the carbon content in the mixture, the FJH process can be used to synthesize f-BCN with various compositions and turbostratic structures. During a typical flash reaction with a voltage of 150 V and a sample resistance of ˜40Ω, the current passing through the sample reaches ˜15 A in ˜600 ms discharge time. The total amount of electrical energy is 3.1 kJ g⁻¹ and the energy cost for converting 1-ton BH₃NH₃ precursor into flash product is presently ˜$19. The real-time temperature can be measured using an infrared sensor as plotted in FIG. 15B. The temperature reaches ˜1220 K within ˜600 ms with a ramp rate in the heating stage that is estimated to be ˜1300 K s⁻¹, followed by rapid cooling at ˜1600 K s⁻¹.

Other carbon-free conductive additives, such as tungsten and iron, were also tried, and the flash products are named f-BN-W and f-BN-Fe, respectively. Specifically, iron powder can be collected by a magnet and reused. This resulted in the formation of BN without obvious carbon signal.

Due to the possible catalytic effect of Cu during the reaction, the graphite spacers were used as the alternatives of the Cu wool plugs. To facilitate the outgassing and avoid the explosion of the tube, the diameter of the graphite spacer was ˜1 mm smaller than the quartz tube. BN was prepared using such graphite spacers.

Previous pyrolytic dehydrogenation analysis has reported that there are three thermal decomposition steps to form BN-based structures from the BH₃NH₃ precursor [Frueh 2011], and that the overall reaction is highly exothermic (˜171 kJ mol⁻¹). This drives the reaction to completion, even though the third step, dehydrogenation, NHBH(s) to BN(s), has a high kinetic barrier and generally requires a higher temperature of 1200˜1400K. [Demirci 2020; Frueh 2011]. The thermochemical equation is shown in Eq (3),

$$B {H}_{3} {NH}_{3} ( s ) = 3 {H}_{2} ( g ) + BN ( s ) {Δ}_{f} {H}^{θ} = - 1 71.1 kJ {mol}^{- 1} \qquad ( 3 )$$

There are three stepwise thermal decompositions (shown in Eqs (4)-(6)) to form the BN crystals from the BH₃NH₃ precursor [Frueh 2011], and the overall reaction is highly exothermic. The third step dehydrogenation, NHBH(s) to BN(s) in Eq (6), is the rate-limiting step and generally requires a higher temperature of 1200˜1400 K.

$$B {H}_{3} {NH}_{3} ( s ) = {H}_{2} ( g ) + {H}_{2} B = {NH}_{2} ( s ) ( 343 K - 373 K ) \qquad ( 4 )$$

$${H}_{2} B = {NH}_{2} ( s ) = {H}_{2} ( g ) + HBNH ( g ) ( 393 K - 403 K ) \qquad ( 5 )$$

$$HBNH ( g ) = {H}_{2} ( g ) + BN ( s ) ( 1200 K - 1400 K ) \qquad ( 6 )$$

Compared to other bottom-up methods, such as CVD [Xu D 2018; Tan 2015] and hydrothermal methods [Ding 2021; Ding 2019], which usually involve a much slower cooling rate of <10 K s⁻¹ and result in the formation of well-aligned stacking morphologies, the FJH method has a 100-1000× faster cooling rate and generates turbostratic BCN (t-BCN) as shown in FIG. 15C. Simulations were performed using the finite element method (FEM), and the temperatures reached in the bulk of the sample are found to be sufficient for driving the third decomposition step since the timescale of the uniform energy input is relatively short compared to that of heat diffusion.

Nudged elastic band (NEB) simulations were performed to study the thermodynamic stability against in-plane rotation by using h-BN as an example. FIG. 15D (with plots 1501-1507 for 1.3×1.3 nm², 1.7×1.7 nm², 2.0×2.2 nm², 2.5×2.6 nm², 4.3×4.5 nm², 5.6×5.8 nm², and 6.8×6.9 nm², respectively) shows the potential energy profiles of h-BN sheets with different sizes along the rotational minimum energy pathways from AA′- to AB-stacking. All potential energies were normalized by the total number of atoms in the small h-BN sheets and were relative to the most stable AA′ stacking mode. The calculations indicate that: (1) t-BN is generally ˜0.5 kJ mol¹ higher in energy than AA′-stacked h-BN. The energy difference may be larger when the h-BN sheet is very small; (2) except for the smallest h-BN sheet (1.3×1.3 nm²), all other energy profiles exhibit an energy barrier realigning from turbostratic (rotation angle ≠0° or 60°) stacking to AA′- or AB-stacking. This energy barrier of realignment accounts for t-BN's is metastability; (3) the slope of the energy profile near 0° is steeper for larger h-BN sheets. This results because a larger h-BN sheet has a higher chance of interlayer misalignment (e.g., N on top of N or B on top of B, leading to large electrostatic repulsion), even when the rotation angle is small. The energy barrier of realignment per atom is nearly size-independent (˜0.054 kJ mol⁻¹=0.56 eV to AA′, and ˜0.039 kJ mol⁻¹=0.40 eV to AB) as listed in TABLE IV. (In other words, the energy barrier of realignment for the whole h-BN sheet scales as the total number of atoms and scales as the sheet area.) Therefore, the formation of BN-based turbostratic structure is kinetically possible, which can be achieved by the FJH method with the ultrafast heating and cooling process.

TABLE IV
Energy Barriers Of Realignment Of Different Sizes Of
H-BN Sheets From Turbostratic To AA′ Or To AB Stacking

| | | | Energy | | Energy | |
|---|---|---|---|---|---|---|
| Sheet | Sheet | Total | barrier of | Energy barrier | barrier of | Energy barrier of |
| size | size | number | realignment | of realignment | realignment | realignment per |
| in x | in y | of | to AA′ | per atom to AA′ | to AB | atom to AB (kJ |
| (nm) | (nm) | atoms | (kJ mol⁻¹) | (kJ mol⁻¹ atom⁻¹) | (kJ mol⁻¹) | mol⁻¹ atom⁻¹) |
| 1.3 | 1.3 | 96 | 0 | 0 | 0 | 0 |
| 1.8 | 1.7 | 160 | 8.4 | 0.0523 | 7.1 | 0.0445 |
| 2.0 | 2.2 | 216 | 10.8 | 0.0498 | 5.4 | 0.0248 |
| 2.5 | 2.6 | 308 | 12.6 | 0.0408 | 17.6 | 0.0571 |
| 4.5 | 4.3 | 836 | 54.4 | 0.0651 | 37.7 | 0.0450 |
| 5.8 | 5.6 | 1344 | 77.0 | 0.0573 | 38.5 | 0.0286 |
| 6.8 | 6.9 | 1904 | 115.9 | 0.0609 | 65.3 | 0.0343 |

Spectroscopic Analysis and Crystal Structure of f-BCN

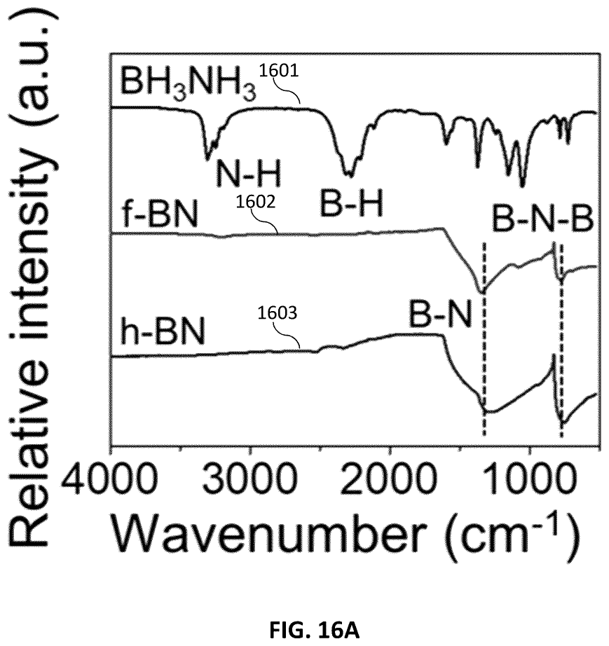

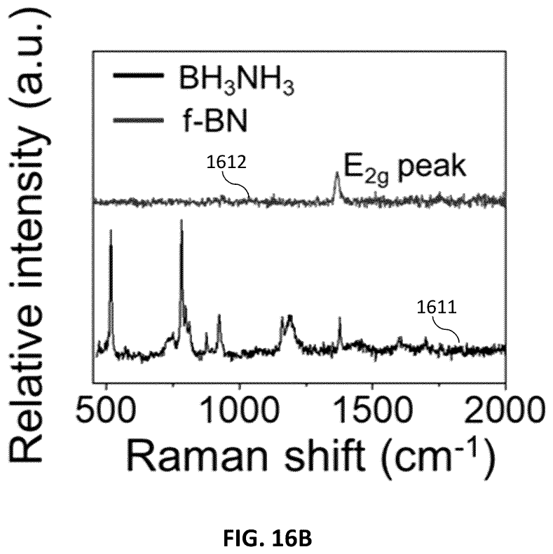

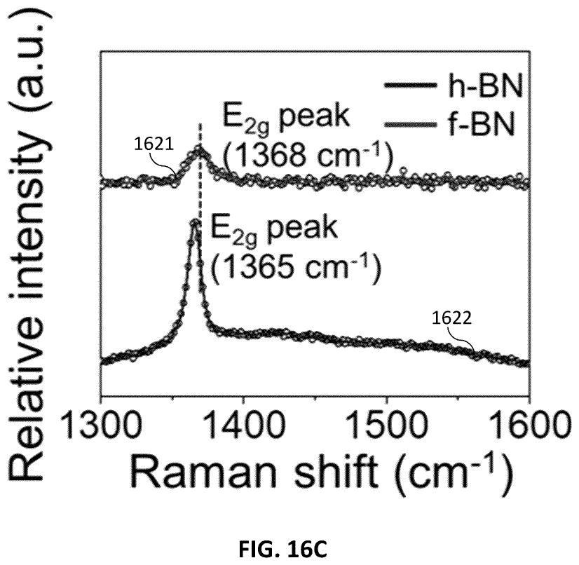

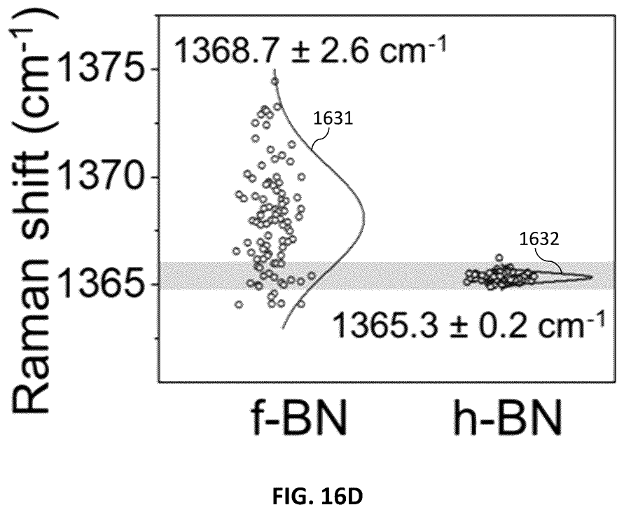

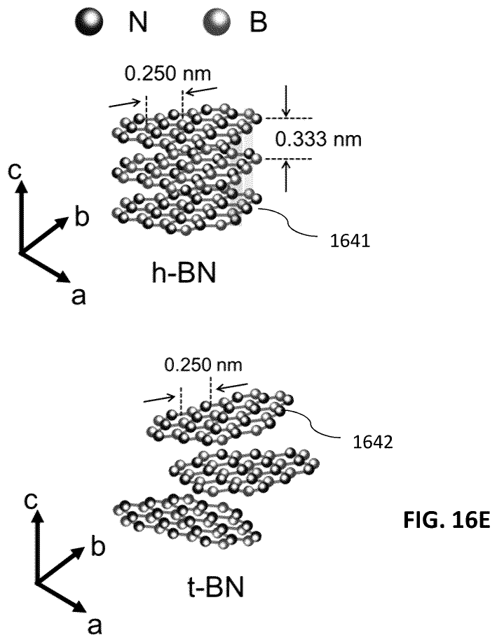

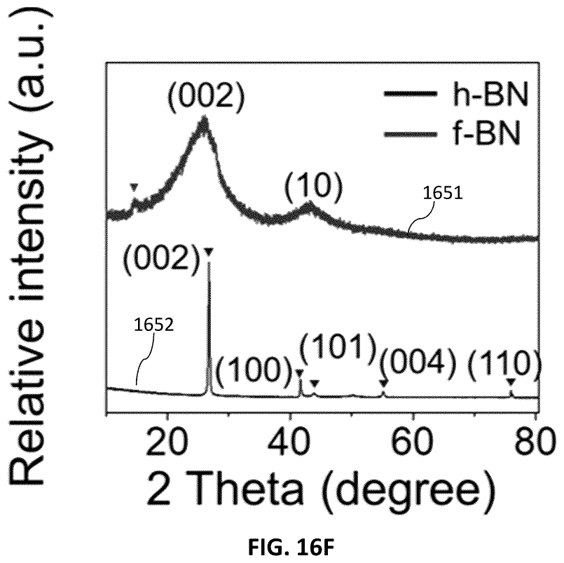

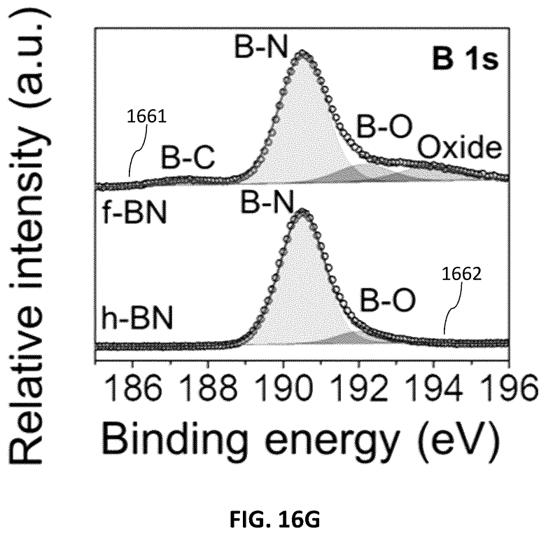

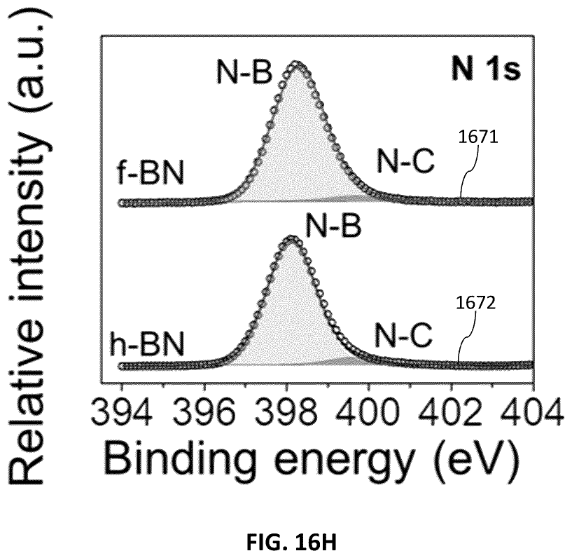

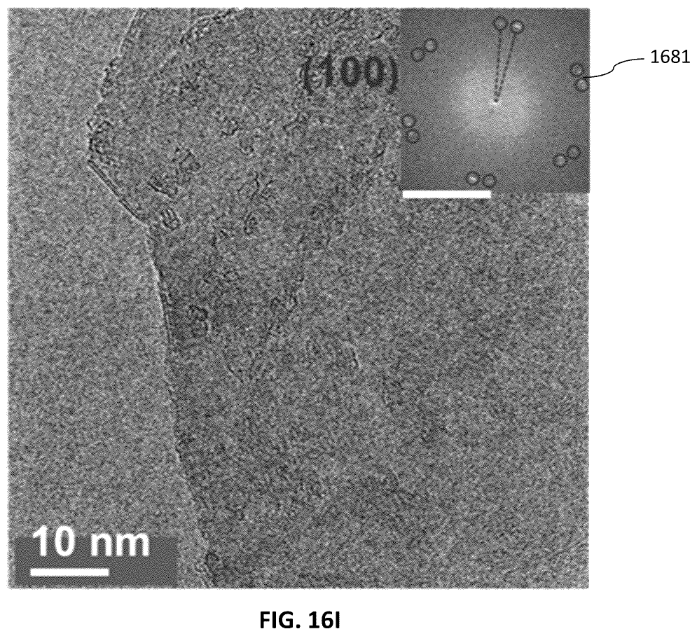

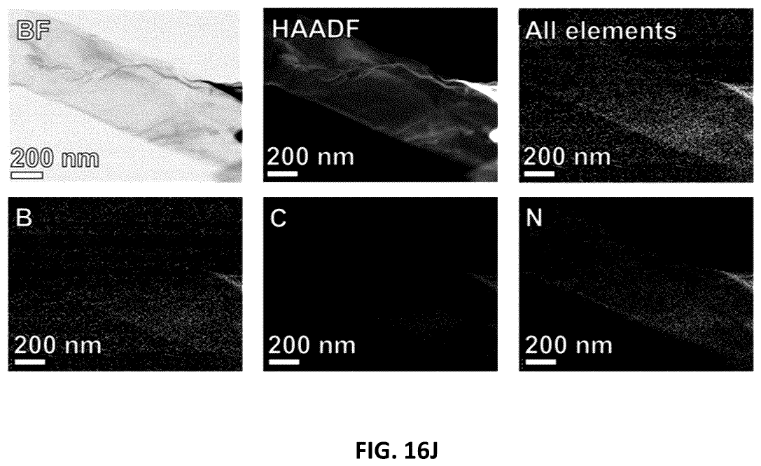

When a mixture of BH₃NH₃ and 20 wt % carbon black is used as the reactant, the flash product showed similar spectroscopic features as h-BN. Therefore, f-BCN-20 (or any f-BCN-x in which x is less than or equal to 20) is also called flash BN (f-BN) in this context. BH₃NH₃ and f-BN can be analyzed by Fourier-transform infrared spectroscopy (FTIR); it is noted that there were no interfering peaks of carbon black or flash graphene (FG) [Luong 2020] in the IR. There were no obvious N-H or B-H stretching band in the f-BN product as shown in FIG. 16A (with plots 1601-1603 for BH₃NH₃, f-BN, and h-BN, respectively), which indicated the complete conversion of BH₃NH₃ [Frueh 2011]. The f-BN product showed a B-N stretching peak (E₁ᵤ mode, ˜1353 cm⁻¹) and a B-N-B bending peak (A₂ᵤ mode, ˜782 cm⁻¹) [Zou 2019] in the IR spectrum, which is similar to the spectrum of commercial h-BN. The shoulder peak at ˜1074 cm⁻¹ is ascribed to the B-C band.

FTIR result is consistent with the Raman spectra in Figure FIG. 16B (with plots 1611-1612 for BH₃NH₃ and f-BN, respectively). There were many Raman peaks for BH₃NH₃ between 500 and 1200 cm⁻¹, whereas these peaks are absent in f-BN and the characteristic E_{2g} peak appears. Compared to bulk h-BN, the E_{2g} peak in the Raman spectrum showed a blue shift as the number of layers decreased and there was a ˜4 cm⁻¹ blue shift in isolated monolayer h-BN due to the shorter BN bonds and the hardening of E_{2g} mode. [Gorbachev 2011; Cai 2017].

From representative high-resolution Raman spectra shown in FIG. 16C (with plots 1621-1622 for f-BN and h-BN, respectively), there was a ˜3 cm⁻¹ blue shift of the characteristic E_{2g} peak and a lower integrated intensity I(E_{2g}) for the f-BN, which resembled features of few-layer h-BN sheets and indicated the weakened coupling interaction between adjacent layers. [Gorbachev 2011].

The E_{2g} peak positions of 100 different spots on f-BN and h-BN were studied in FIG. 16D (with circles 1631-1632 for f-BN and h-BN, respectively). Commercial h-BN belongs to bulk h-BN, whose E_{2g} peaks were centered at 1365.3 cm⁻¹ with a narrow distribution (˜0.2 cm⁻¹, red shadow region). The f-BN had a higher average E_{2g} peak (˜1368.7 cm⁻¹) with a broader distribution (˜2.6 cm⁻¹), and ˜72% of the region showed a blue shift of the E_{2g} peak, which indicated the prevailing decoupling effect in the f-BN sample.

The scheme in FIG. 16E displayed a normal in-plane lattice constant ˜0.25 nm and interlayer spacing ˜0.33 nm in well-aligned h-BN crystals 1641. There were random translational and rotational orientations of individual sheets in t-BN crystals 1642 with larger average interlayer distances.

The turbostratic nature of the f-BN sample was further explored by X-ray diffraction (XRD) in FIG. 16F (with circles 1651-1652 for f-BN and h-BN, respectively). The (002) diffraction peak became broader but less intense and shifted toward a lower angle from ˜26.7° to 26.1°, indicating the expansion of the interlayer spacing by ˜2.3%. The (100) and (101) peaks merged into a broad (10) peak in f-BN and the long-range order diffraction peaks, such as (110) and (004), were absent. These results support the absence of an ordered structure of basal planes, and the existence of a turbostratic structure. [Alkoy 1997; Thomas 1963; Gladkaya 1986].

Elemental analyses carried out by XPS indicated the atomic ratio of B to N is ˜1.05 and the existence of 6.7 wt % C. See TABLE V.

TABLE V
Element Content As Determined By XPS Spectral Analysis

| | B | N | O | C |
|---|---|---|---|---|
| Commercial h-BN | 45.8% | 47.5% | 5.1% | 1.7% |
| f-BN | 41.1% | 38.9% | 13.3% | 6.7% |
| BH₃NH₃ | 46.7% | 49.0% | 4.3% | / |

High-resolution B is and N is spectra indicated the dominance of typical B-N bonds (˜190.5 eV) and N-B bonds (˜398.2 eV). FIG. 16G (with plots 1661-1662 for f-BN and h-BN, respectively); FIG. 16H (with plots 1671-1672 for f-BN and h-BN, respectively). [Ba 2017; Hu 2019]. A small B-C peak (˜187.3 eV) was observed, which was consistent with the B-C band as shown in FTIR in FIG. 16A. The valence band of f-BN shows the valence band maximum (VBM) is ˜3.10 eV, which slightly downshifts compared with that of commercial h-BN (˜2.70 eV), with this downshift caused by introducing some O and C atoms in f-CN. UV-vis spectra of commercial h-BN and f-BN indicated the optical bandgap of ˜6.0 eV (FIG. 510, Supporting Information). [Ba 2017]. Thus, FJH synthesis could become an effective method to tune the VBM by introducing heteroatoms

The Brunauer-Emmett-Teller (BET) method showed that the specific surface area of f-BN (˜143 m² g⁻¹) was ˜7 fold larger than that of commercial h-BN (˜22 m² g⁻¹). The larger surface area of f-BN was likely the result of small flake sizes and average layer numbers. The larger nanopore size distribution can come from the gaps between the small flakes. On the other hand, the commercial h-BN samples were composed of the thick microplates with >10 layers and well-aligned structure.

The f-BN sheets can reach up to ˜4.3 μm in lateral size with a wrinkled structure. High-resolution transmission electron microscopy (HR-TEM) analysis showed two stacking f-BN layers. Corresponding fast Fourier transform (FFT) patterns indicated the existence of two sets of six-fold diffraction patterns close to each other with a rotational mismatch of ˜12°, which resulted from the turbostratic structure of the f-BN. FIG. 16I (with inset 1681 showing the FFT patterns, and the scale bar is 5 nm⁻¹).

Polycrystalline materials are composed of many crystalline domains with various sizes and orientations, which also give multiple sets of diffraction patterns. For the polycrystalline films, the in-plane crystal boundaries separate the individual domains in the real space and the films show multiple sets of diffraction patterns in the reciprocal space. The turbostratic materials are the solids whose basal planes have misalignments. Each individual sheet has its own translational and rotational orientation in the real space, and it shows one set of diffraction patterns in the reciprocal space. Therefore, the diffraction patterns for polycrystalline films comes from the in-plane domains, while the diffraction patterns for turbostratic materials is caused by out-of-plane domains (each individual sheets).

This means there are several solutions to distinguish polycrystalline materials and turbostratic materials by TEM, namely
(1) The inverse Fourier transform can be carried out for each set of diffraction patterns in the reciprocal space, and the reconstructed images in the real space reflect the relative association among the different sets of spots. Specifically, if the reconstructed images show the crystal structures from different areas of the same sheets, it belongs to polycrystals. Otherwise, it is the turbostratic materials.
(2) The HR-TEM can be carried out from the top view. The Moiré patterns can be observed for the turbostratic materials, while there are no Moiré patterns for polycrystals. There are many different types of the Moiré patterns. The Moiré patterns generated by only one rotational stacking fault is the simplest type with the period λ and rotation angle θ. With more than two rotational orientations, more complex Moiré patterns can be observed
(3) The Fourier transform can be carried out at different position of the sample in the same images and the as-obtained diffraction patterns can be compared in the reciprocal space. Specifically, if all the diffraction patterns are not the same (orientation and spot number), then it belongs to polycrystals. Otherwise, it is the turbostratic materials.

Solutions (2) and (3) were used to demonstrate the turbostratic feature of flash samples.

To identify the turbostratic structure [Ci 2010; Warner 2009], top-view atomic HR-TEM images were carried out. The in-plane Moiré patterns were observed from few layers area. The clear fringes and FFT patterns indicated good crystallinity of the flash products. The FFT patterns were compared at different positions atop the same sheets. Due to the unchanged orientations and spot numbers of the diffraction spots, the possibility of polycrystals in this area was excluded. Therefore, the various sets of diffraction spots were resulted from the turbostratic structure.

The bright-field (BF) and high-angle annular dark-field scanning transmission electron microscopy (HAADF-STEM) images, together with elemental mapping, indicated the existence of B, N, and a small amount of C in f-BN sheets (FIG. 16J), which was consistent with the XPS results.

Plate-like f-BN with lateral sizes of 20-50 nm was also observed. HR-TEM images showed the crystallinity of f-BN nanoplates with the majority of these nanoplates only several layers thick. Corresponding FFT images showed there were at least three sets of six-fold diffraction patterns. The estimated mass yield of f-BN was ˜34%. The conductive carbon additive could be removed from f-BN by thermal treatment under air. However, oxidation would occur simultaneously on the surface. See TABLE VI. There are small amounts of B-C and B-O bonds in f-BN, which is reasonable since previous studies have shown that the oxidation of B-C bonds starts at ˜600° C. [Hu 2019; Li 2014].

TABLE VI
Element Content After Thermal Treament

| | B | N | O | C |
|---|---|---|---|---|
| Commercial h-BN | 46.0% | 47.1% | 5.2% | 1.7% |
| f-BN | 34.7% | 12.5% | 46.6% | 6.1% |
| BH₃NH₃ | 44.9% | 46.4% | 6.4% | 2.3% |

Mechanical Exfoliation Tests of f-BN

The turbostratic characteristics of f-BN facilitates its exfoliation by various mechanical methods, such as adhesive tape exfoliation, monodirectional mechanical shearing, and bath sonication. TABLE VII.

TABLE VII
Results Of Mechanical Exfoliation Tests

| | f-BN | Commercial h-BN |
|---|---|---|
| Tape exfoliation | Yes | No |
| Mechanical shearing | Yes | No |
| Bath sonication (without surfactant) | Yes | No |

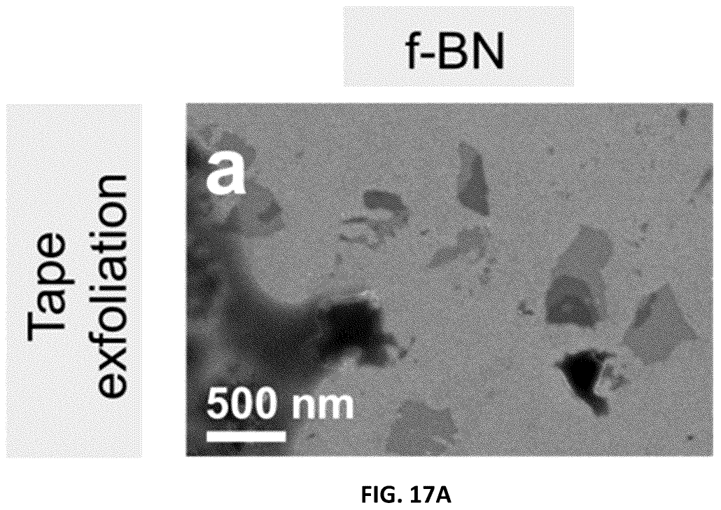

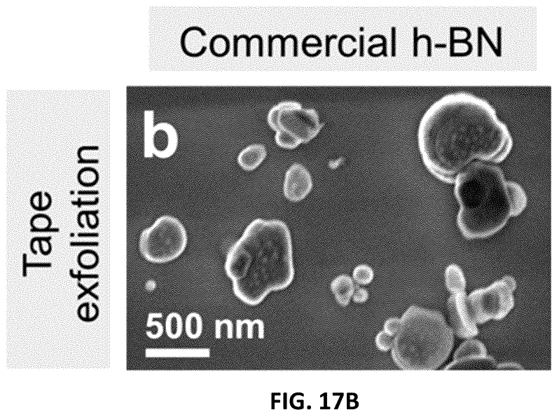

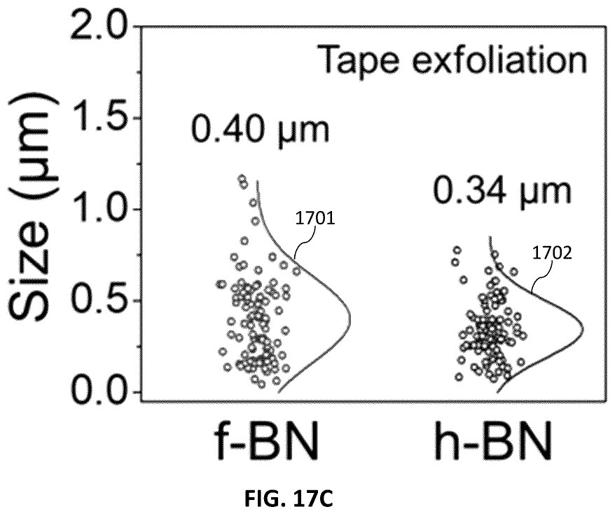

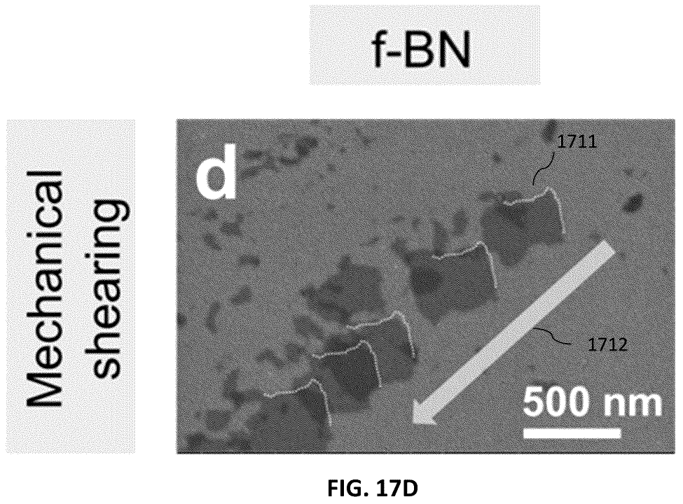

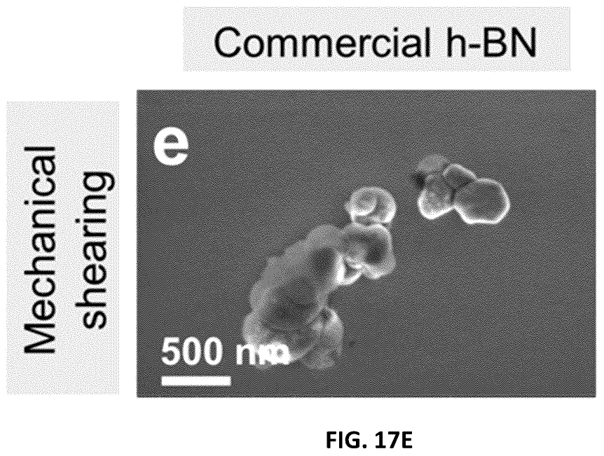

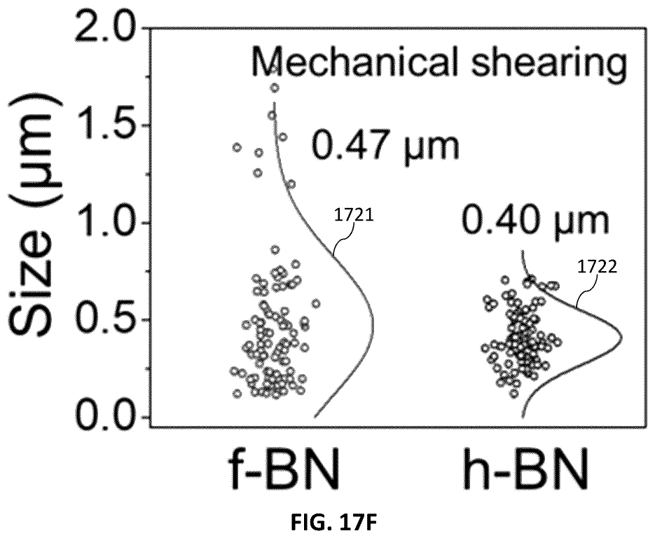

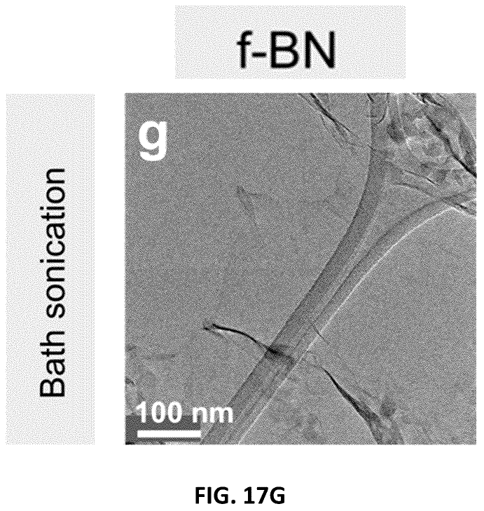

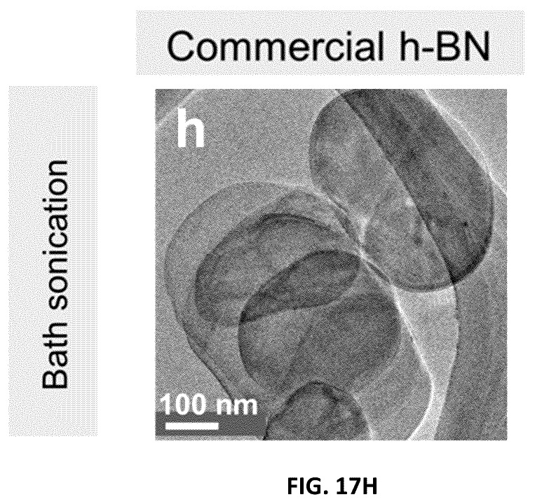

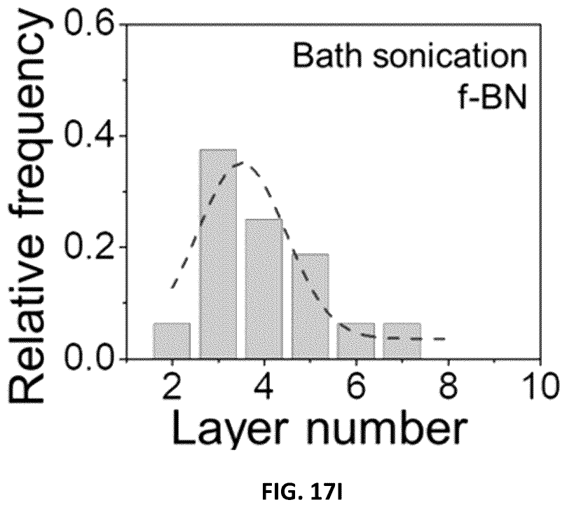

Few-layer f-BN sheets obtained by adhesive tape exfoliation can be distinguished from top-view scanning electron microscopy (SEM) as shown in FIG. 17A. In contrast, due to the strong coupling between adjacent layers in commercial h-BN, there was no obvious exfoliation and only thick nanoplates of several hundred nanometers were observed in FIG. 17B. The average lateral size of f-BN and commercial h-BN, obtained from the tape exfoliation method, were 0.40 and 0.34 μm, respectively. FIG. 17C (with circles 1701-1702 for f-BN and h-BN, respectively). The size distribution results showed that the majority of the f-BN flakes have the lateral size no more than 1.0 μm, which makes it difficult to be applied in electronic devices, such as field effect transistors. [Gupta 2020].

However, the merits of f-BN, such as the nanoscale feature and good dispersibility, show the potential applications of f-BN as the nano-fillers to enhance the mechanical properties and to improve the electrochemical anticorrosion performance as discussed below.

The same exfoliation phenomena can be observed by applying monodirectional shearing force. The mechanical exfoliation of f-BN sheets is demonstrated in FIG. 17D, representing exfoliated f-BN sheets with the same edge feature (delineated by the white dashed lines 1711 outlining each sheet). The direction of the monodirectional shearing force is shown by arrow 1712 in FIG. 17D. The atomic force microscopy (AFM) profile showed the bilayer to few-layer features of the exfoliated f-BN sheets. These results indicated effective exfoliation of f-BN. In contrast, few-layer BN sheets cannot be directly prepared from commercial h-BN by monodirectional shearing under the same conditions (FIG. 17E). The average lateral size of f-BN and commercial h-BN, obtained from the mechanical shearing method, were 0.47 and 0.40 μm, respectively. FIG. 17F (with circles 1721-1722 for f-BN and h-BN, respectively).

Compared to commercial h-BN nanoplates with >10 layers, few layer f-BN flakes of several hundred nanometers with ripple-like structures were obtained by bath sonication in ethanol without surfactant. FIGS. 17G-17H. The layer number distributions of the f-BN, obtained by the bath sonication treatment showed that ˜80% of the f-BN sheets have 3-5 layers. FIG. 17I. In some regions, small black particles can be found, presumably from the carbon conductive additives. HR-TEM images and corresponding FFT patterns demonstrate the high quality of the turbostratic f-BN sheets and the well-aligned structure of commercial h-BN nanoplates.

### Electrochemical Anticorrosion Tests of F-BN Composites

The turbostratic feature improves the dispersibility and stability of f-BN in aqueous solution. After dispersal in aqueous Pluronic (F-127) (1 wt % in deionized water), the concentration of f-BN can reach up to ˜18 wt % higher than that of commercial h-BN. The percentage of commercial h-BN and f-BN still in solution were ˜6% and 77% after 21 days, respectively, which indicates the f-BN dispersion has a higher temporal stability. Good dispersibility of f-BN makes it possible to prepare stable nanocomposites with f-BN as a compatible additive.

A prerequisite is the dispersion and distribution of the nano-fillers inside polymer matrices, since strengthening of the composite relies on the interactions between the polymer and the surface area of the fillers. [Luong 2020; Albdullah 2018]. PVA has been studied as a surface coating model system for testing additives to reduce chemical and electrochemical metal corrosion. [Sarkar 2016; Owuor 2017]. The barrier films provide tortuous diffusion pathways for corrosive electrolytes, delaying the metal corrosion process. Likewise, they prevent metal ions from migrating, thus building up a local Nernst potential at the polymer-metal interface. The addition of appropriate nano-fillers can occupy the free volume within the polymer matrix and improve the film's blocking properties. [Sarkar 2016].

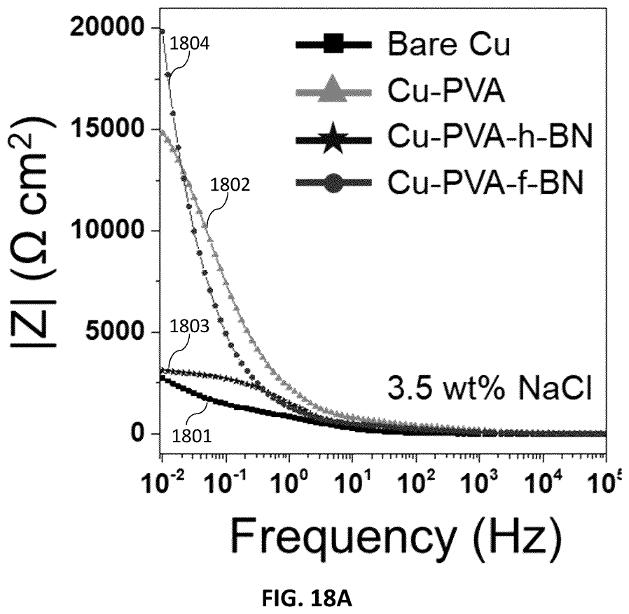

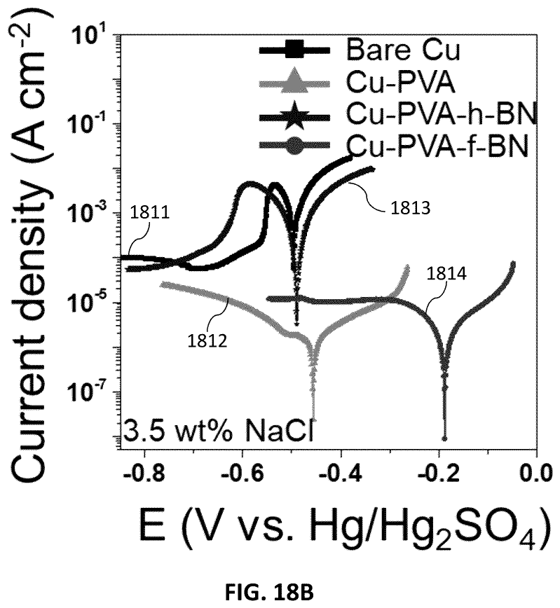

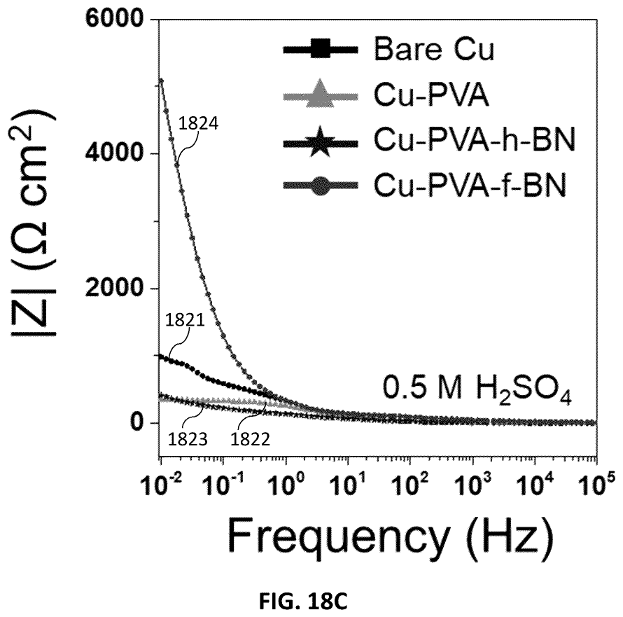

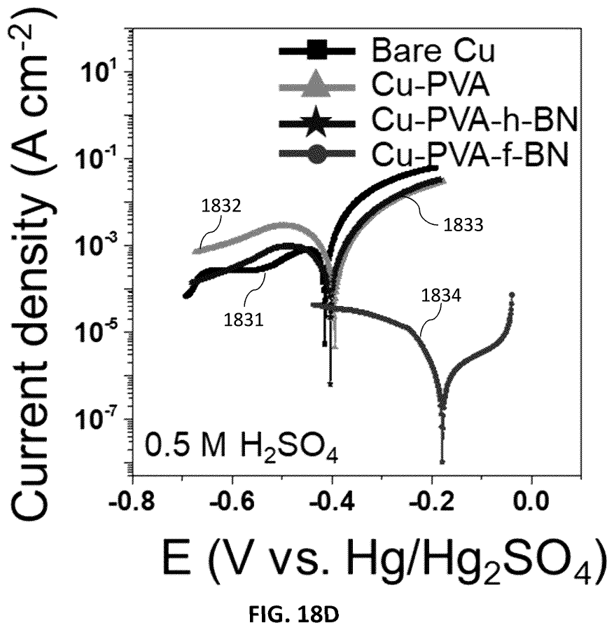

Since f-BN has shown good dispersibility in aqueous solution, further demonstrations of f-BN as fillers in PVA composites, which act as an electrochemical anticorrosion coating, are shown in FIGS. 18A-18D.

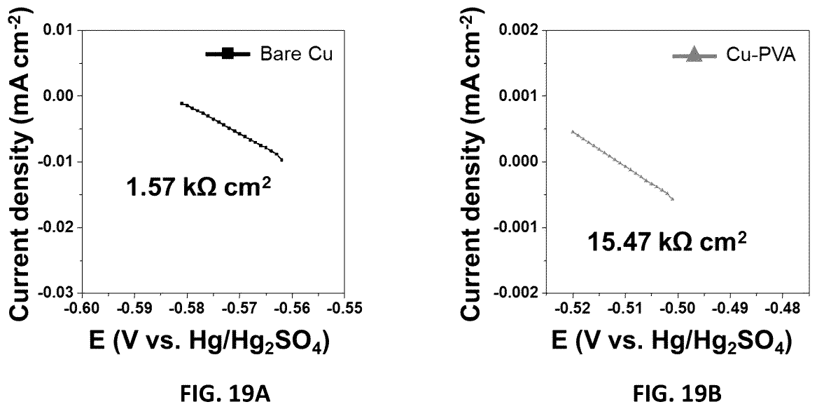

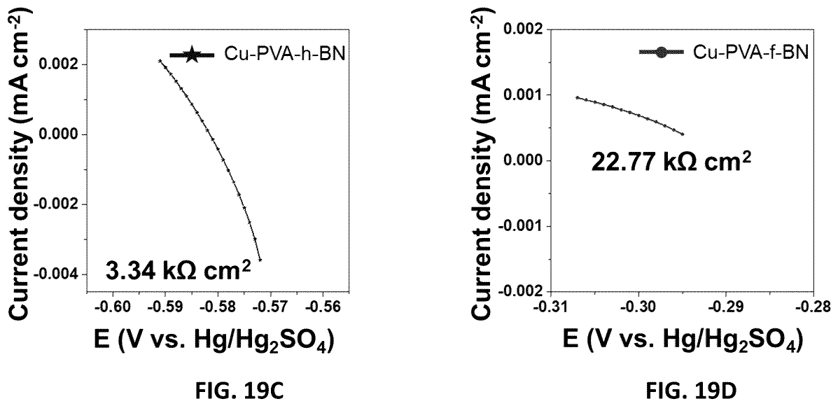

Before the electrochemical tests, the coating thickness was characterized by cross-sectional SEM images. The average thickness of the coating layer was ˜9 μm. The electrochemical linear polarization resistance (LPR) tests of bare Cu, PVA coated Cu (Cu-PVA), commercial h-BN and PVA composite coated Cu (Cu-PVA-h-BN), and f-BN and PVA composite coated Cu (Cu-PVA-f-BN) in 3.5 wt % saline solution are shown in FIGS. 19A-19D. The Cu-PVA-f-BN showed the largest polarization resistance (Rₚ) ˜22.8 kΩ cm², which was ˜47% higher than Cu-PVA.

The open circuit potential (E_{corr}) represents the thermodynamic tendency of the electrode to lose electrons to the solution. [Warner 2009; Li 2014]. According to the Nernst equation, the metal surface remains relatively stable when the measured potential is lower than E_{corr}. The potentiodynamic polarization measurements in FIG. 18A (with plots 1801-1804 for bare Cu, Cu-PVA, Cu-PVA-h-BN, and Cu-PVA-f-BN, respectively) and FIG. 18B (with plots 1811-1814 for bare Cu, Cu-PVA, Cu-PVA-h-BN, and Cu-PVA-f-BN, respectively) demonstrate that Cu-PVA-f-BN had the more positive E_{corr}, (˜188 mV vs Hg/Hg₂SO₄), thus there is less tendency for the surface metal to take part in the electrochemical oxidation process. Compared with pure PVA and PVA-h-BN composite coatings, the PVA-f-BN composite has higher corrosion protection efficiency (>92%) and better anti-corrosion performance as shown in TABLE VIII.

TABLE VIII
Electrochemical Parameters Determined From Potentiodynamic Polarization
For Bare Cu-PVA, Cu-PVA-h-BN, And Cu-PVA-f-BN In 3.5 Wt % NaCl (Aq)

| | | | | | | Corr | Corr |
|---|---|---|---|---|---|---|---|
| | Rₚ | βₐ | β_{c} | i_{corr} | E_{corr} | rate | protect |
| Sample | (kΩ cm²) | (mV dec⁻¹) | (mV dec⁻¹) | (μA cm⁻²) | (mV) | (mpy) | eff (%) |
| bare Cu | 1.57 | 55 | 67 | 8.36 | −496 | 3.82 | / |
| Cu-PVA | 15.47 | 118 | 107 | 1.58 | −456 | 0.72 | 81 |
| Cu-PVA-h-BN | 3.34 | 43 | 50 | 3.01 | −490 | 1.37 | 64 |
| Cu-PVA-f-BN | 22.77 | 70 | 69 | 0.66 | −188 | 0.30 | 92 |

The same enhanced anti-corrosion trend is also observed in 0.5 M H₂SO₄ as shown in FIG. 18C (with plots 1821-1824 for bare Cu, Cu-PVA, Cu-PVA-h-BN, and Cu-PVA-f-BN, respectively) and FIG. 18D (with plots 1831-1834 for bare Cu, Cu-PVA, Cu-PVA-h-BN, and Cu-PVA-f-BN, respectively). The Cu-PVA-f-BN showed the largest polarization resistance (Rₚ) ˜10.0 kΩ cm², which is >20 fold higher than Cu-PVA. The corrosion protection efficiency for Cu-PVA-f-BN is >97% vs 68% for Cu-PVA-h-BN as shown in TABLE IX. This further shows to the superior dispersibility and compatibility of f-BN in the polymer matrix.

TABLE IX
Electrochemical Parameters Determined From Potentiodynamic Polarization
For Bare Cu, Cu-PVA, Cu-PVA-h-BN, And Cu-PVA-f-BN In 0.5M H₂SO₄

| | | | | | | Corr | Corr |
|---|---|---|---|---|---|---|---|
| | Rₚ | βₐ | β_{c} | i_{corr} | E_{corr} | rate | protect |
| Sample | (kΩ cm²) | (mV dec⁻¹) | (mV dec⁻¹) | (μA cm⁻²) | (mV) | (mpy) | eff (%) |
| bare Cu | 0.23 | 87 | 69 | 72.74 | −414 | 33.22 | / |
| Cu-PVA | 0.47 | 77 | 91 | 38.58 | −394 | 17.62 | 47 |
| Cu-PVA-h-BN | 0.65 | 72 | 67 | 23.21 | −403 | 10.60 | 68 |
| Cu-PVA-f-BN | 10.02 | 146 | 65 | 1.95 | −179 | 0.89 | 97 |

The optical and microscopic morphology after electrochemical testing indicated that the Cu under the PVA-f-BN composite coating is least affected, and surface elemental analyses also showed there is no obvious formation of the oxides for Cu-PVA-f-BN. These results are consistent with the highest corrosion protection efficiency from the electrochemical tests and demonstrates one potential application of f-BN as a filler for nanocomposites.

Mechanical performance, such as hardness and Young's modulus of epoxy resin with 1 wt % f-BN additive shows ˜54% and ˜70% increase, respectively, compared to pure epoxy resin. These improvements cannot be achieved by replacing f-BN with equal amounts of commercial h-BN.

Synthesis of f-BCN with Different Chemical Compositions

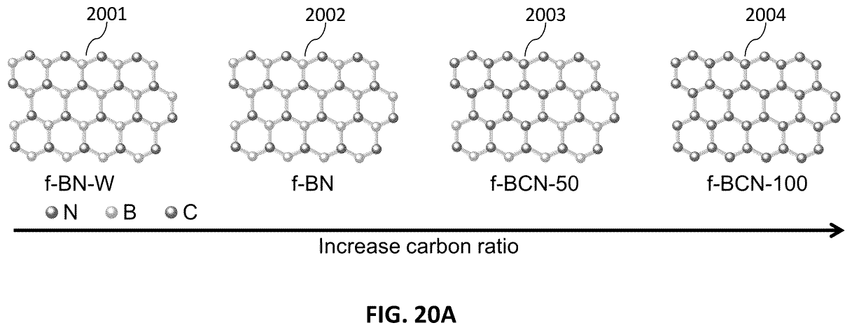

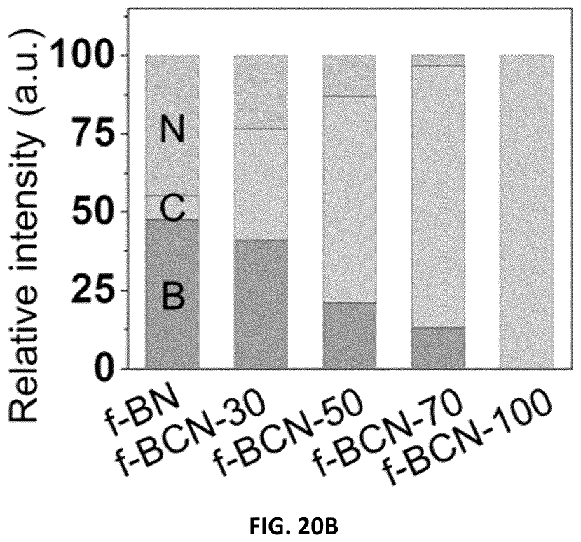

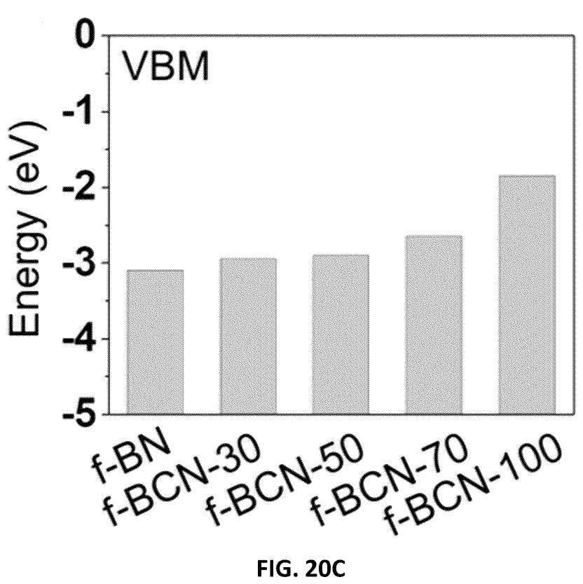

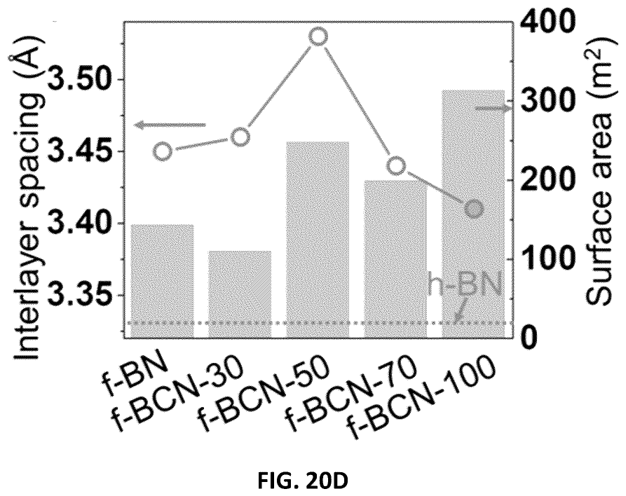

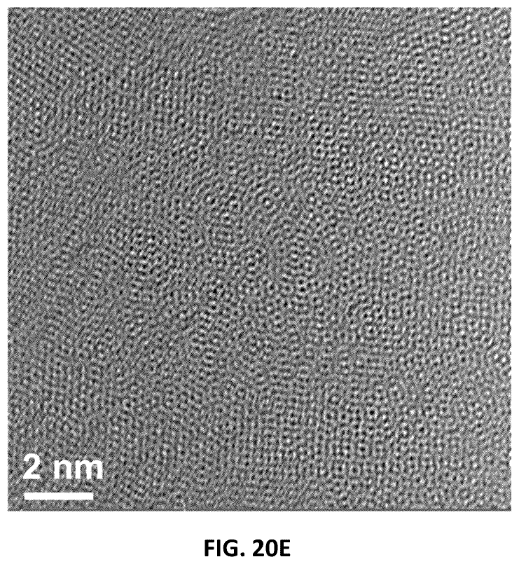

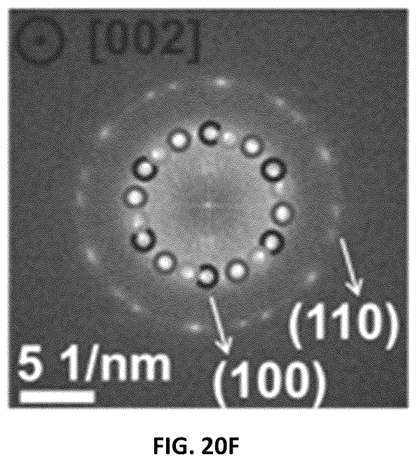

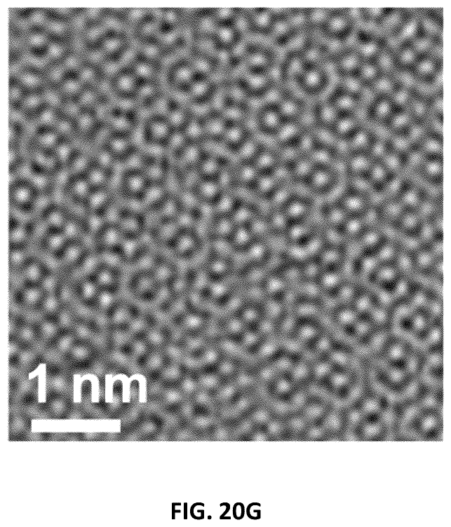

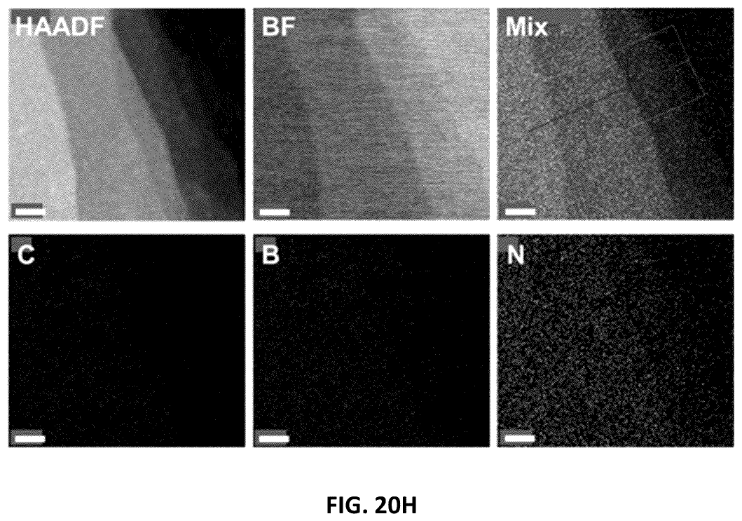

The atomic ratios of carbon can be tuned by directly changing the weight percent of carbon black in the reactants. If a mixture of BH₃NH₃ and 30 wt % carbon black is used as the reactant, the flash product is called f-BCN-30. The same naming convention is used herein for the other f-BCN samples prepared. As the weight percent of carbon increases, the atomic percentage of carbon in flash products can be controlled from ˜0% to ˜100% as determined by XPS results. FIG. 20A (with illustrations 2001-2004 for f-BN-W, f-BN, f-BCN-50, and f-BCN-100, respectively). The elemental analyses demonstrated the monotonic decrease of B and N from f-BN to f-BCN-100. FIG. 20B. High resolution XPS of C is spectra showed the existence of C-B and C-N bonds in f-BCN samples. As the mass ratios of the carbon increased, the C-B and C-N ratios also increased. High resolution XPS of B is and N is spectra also confirmed the existence of B-C and N-C bonds.

The presence of B-C and N-C bonds confirmed the formation of in-plane hybrid structures instead of the out-of-plane stacked heterostructures, the latter being often more thermodynamically stable. This can be attributed to an ultrafast heating and cooling rate (˜10⁴ K s⁻¹) of the FJH reaction.

There are several possibilities for the flash products after the reaction between carbon black and BH₃BH₃, namely:
(1) The mixture of BN and carbon black.
(2) The mixture of NC, BC, BN and graphene or carbon black.
(3) Boron-carbon-nitrogen ternary compound and carbon black.

The high-resolution XPS results reflected the existence of B-C, B-N and C-N bonds, which exclude the possibility that the product is just the mixture of BN and carbon black.

For NC and BC, there are two possibilities. At first, BC and NC might be boron carbide and carbon nitride. The boron carbide has a covalent B₄C part at ˜187.4 eV in B is spectrum and it has characteristic XRD peaks (Powder Diffraction File 35-0798, B₄C). However, the deconvolution result of the B is spectrum showed no peak at ˜187.4 eV, and there was no characteristic XRD peaks, which excluded the possibility of the boron carbide. Similarly, there was no characteristic XRD peaks of carbon nitride (Powder Diffraction File 50-1250, C₃N₄), which excluded the possibility of the carbon nitride. The other possibility of BC and NC is the co-doped graphene, which can be regarded as the carbon-rich boron-carbon-nitrogen components.

From TEM images, existence of the conductive carbon materials was seen with some graphitic structures in the flash products. Use f-BCN-30 as an example, the conductive carbon materials had an average size of ˜25 nm, which made it distinguishable from f-BCN-30. This observation indicated that the flash product had unconverted carbon materials. Therefore, the flash products are the mixture of boron-carbon-nitrogen ternary compound and carbon black. Due to the existence of the conductive carbon materials in the products, the carbon ratios determined by the XPS analysis can be overestimated.

Due to the thermal stability difference of the conductive carbon materials and substitutional carbon species chemically bonded with boron and nitrogen, thermogravimetric analysis (TGA) can be used to oxidize the conductive carbon materials. The first-order derivative of thermogravimetric curve showed 2 peaks starting from ˜540° C. and ˜750° C., and the first peak is mainly attributed to the oxidation of conductive carbon materials. Therefore, the conductive carbon materials can be removed from the flash products by control the temperature at ˜675° C. under air condition (i.e., the carbon contents for the carbon-rich boron-carbon-nitrogen ternary compounds can be underestimated). XPS results of various f-BCN samples before and after thermal treatment reflected the existence of the substitutional carbon species and the ratio of carbon contents can reach 35.7 at % in f-BCN-70 after thermal treatment at ˜675° C. under air condition for 30 min.

The carbon ratio of the in-plane hybrid structure affects the electronic structures and changes the VBM. As the atomic ratios of carbon increase, the VBM of f-BCN changes from ˜3.10 eV to −1.85 eV. FIG. 20C. The Raman spectra of different f-BCN samples showed the appearance of the G peak (˜1580 cm⁻¹, single resonance), D peak (˜1350 cm⁻¹, intervalley double resonance), 2D peak (˜2695 cm⁻¹, second order zone boundary phonons), D+G peak (˜2930 cm⁻¹, a combination of scattering peak), 2D′ (˜3250 cm⁻¹) and G* (˜2450 cm⁻¹). [Huang 2020; Hong 2013; Yoon 2012]. As the carbon ratio increased in the reactants, the intensity of D+G peak decreased and 2D peak increased. The intensity ratio between D and G peaks for f-BCN-70 is ˜1.10, which is similar to boron and nitrogen co-doped graphene, which belongs to the carbon rich BCN. f-BCN-100 (FG) shows a high 2D to G ratio (˜8) and a low D peak, which is similar with Luong 2020. The introduction of carbon to the f-BCN sample also confers magnetic properties [Sarkar 2016], which is different from commercial h-BN.

h-BN shows a diamagnetic response since boron is bonded with nitrogen and the total magnetic moment is ˜0. However, f-BCN-50 has B-C/O and N-C/O bonds, which can contribute to the total magnetic moment. f-BCN-50 shows a ferrimagnetic response with a small coercivity of ˜22 Oe. The saturation magnetic moment of f-BCN-50 is 0.115 emu g⁻¹. Inductively coupled plasma mass spectrometry (ICP-MS) confirmed the negligible contribution from magnetic metals, such as Fe, Co and Ni, and other d-block metals. [Fan 2019; Zhao 2014]. (HNO₃ (67-70 wt %, TraceMetal™ Grade, Fisher Chemical), HCl (37 wt %, 99.99% trace metals basis, Millipore-Sigma), and water (Millipore-Sigma, ACS reagent for ultratrace analysis) were used for sample digestion. All the samples were digested using a dilute aqua regia method. The samples were soaked in HNO₃/HCl (1 M each) solution at 85° C. for 6 h. The acidic solution was filtered to remove any undissolved particles. The solution was then diluted to the appropriate concentration range using 2 wt % HNO₃ within the calibration curve. ICP-MS was conducted using a Perkin Elmer Nexion 300 ICP-MS system).

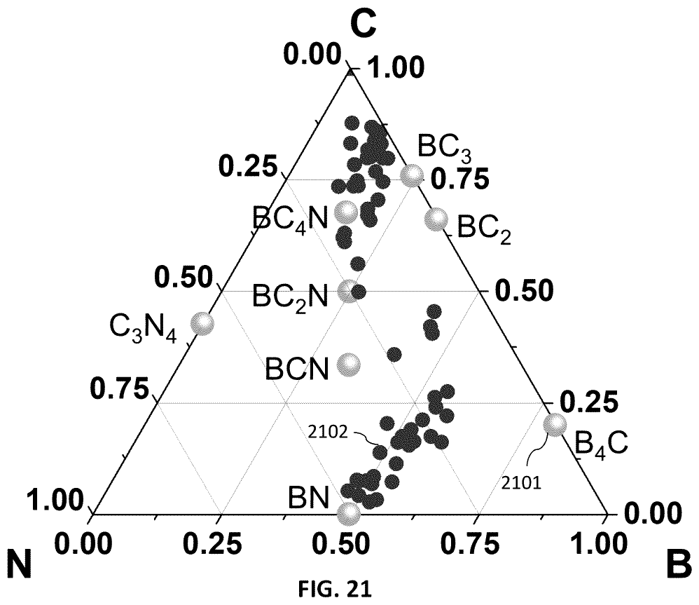

The boron-carbon-nitrogen ternary phase diagram in FIG. 21 shows the chemical compositions (boron, carbon, and nitrogen) of different f-BCN products before thermal treatments, showing broad accessibility to varied BCN materials via FJH methods. In FIG. 21, spheres 2101 and dots 2102 refer to the classic compounds and the experimental results for embodiments as described herein, representatively. The atomic ratios were determined by XPS results.

All of these f-BCN samples have turbostratic structures with larger interlayer spacings, since (002) diffraction peaks shift to lower angles with broad (10) peaks by XRD. The interlayer spacing of f-BCN was 3 to 6% larger than in commercial h-BN and f-BCN-50 had the largest interlayer spacing, which was ˜6.1% larger than in commercial h-BN. FIG. 20D; see also TABLE X.

TABLE X
Crystal Structure Of f-BCN Samples

| | | | Percentage |
|---|---|---|---|
| Materials | (002) position/degree | Interlayer spacing/Å | change¹ |
| h-BN | 26.77 | 3.33 | / |
| f-BN | 25.84 | 3.45 | +3.5% |
| f-BCN-30 | 25.73 | 3.46 | +4.0% |
| f-BCN-50 | 25.21 | 3.53 | +6.1% |
| f-BCN-70 | 25.87 | 3.44 | +3.4% |
| f-BCN-100 | 26.09 | 3.41 | +2.6% |

¹The values show the percentage change of interlayer spacing compared with commercial h-BN, where Eq (7) is used to calculate the percentage change.
$Percentage Change = \frac{Interlayer {spacing}_{f - BCN} - Interlayer {spacing}_{h - B N}}{Interlayer {spacing}_{h - B N}} \times 100 \% \qquad ( 14 )$

There are larger surface areas for f-BCN samples (110-310 m² g⁻¹) and they have abundant micropores as well as mesopores. FIG. 20D. The Moiré patterns can be seen from the HR-TEM image of f-BCN samples (FIG. 20E), which indicates the existence of turbostratic stacking structure. Corresponding FFT patterns reflect multiple sets of the diffraction spots from [002] direction. FIG. 20F. Atom-scale HR-TEM image shows the complex Moiré patterns and good in-plane crystallinity. FIG. 20G. STEM images confirm the nonaligned edges and elemental mapping results demonstrate the existence of B, C and N for f-BCN-30 samples. FIG. 20H.

To confirm the existence of substitutional carbon species in the structure and exclude the hydrocarbon contamination resulted in fake positive carbon signal, electron energy loss spectroscopy (EELS) was carried out and the C K-edge spectrum showed the existence of 1s-π* and 1s-σ* peaks, which indicates the existence of substitutional carbon atoms in the conjugated structure and excludes the possibility that the carbon signal is sorely from amorphous hydrocarbon contamination. [Langenhorsta 2002; McGilvery 2012].

### Heteroatom Doped (Substituted) Re-Flashed Graphene

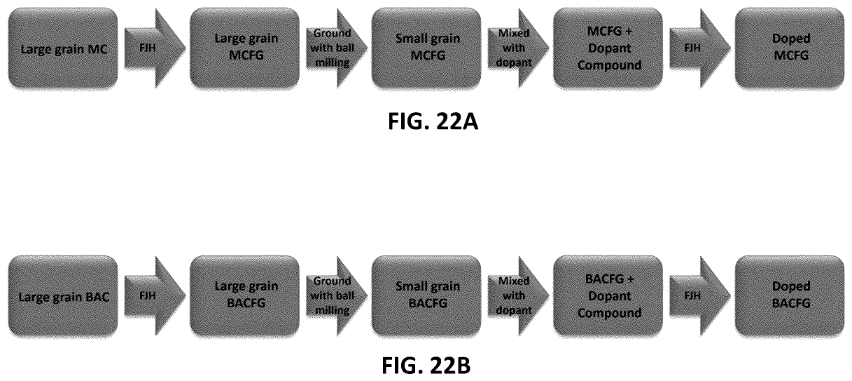

In embodiments, the present invention further relates to utilizing already synthesized flash graphene for the flash doping process. Thus, a carbon feedstock is initially flashed to convert it to turbostratic flash graphene. Then, the flash graphene is mixed with a heteroatom doping compound(s) before undergoing a second flash. This new method achieves doping ratios higher than those achieved by the previously referenced single flash doping method. A schematic of this process is illustrated in FIGS. 22A-22B.

### Synthesis of Heteroatom-Substituted Re-Flash Graphene by FJH

The FJH system that can be utilized (and parameters) to synthesize heteroatom-substituted re-flash graphene can be based on the system set forth and described in the Tour '642 Application and the Tour '111 PCT Application with the modifications as discussed below. [See also Luong 2020; Chen 2022; Deng 2022]. Parameters/declarations for heteroatom-substituted re-flashed graphene can include the following:
(1) Flash graphene can be converted into doped flash graphene after it has already been flashed once.
(2) This method can be performed in varying degrees with multiple different carbon feedstocks, as well as multiple different doping compounds.
(3) The doping ratio can generally be maximized when the doping compound-flash graphene weight ratio is 1:4.
(4) Lower surface area amorphous carbon feedstocks can generally have higher doping ratios.
(5) Organic powders with low melting points can, in some embodiments, be the most effective doping compounds.
(6) Performing the doping flash reaction under argon atmosphere can, in some embodiments, be needed for higher doping ratios.
(7) Smaller grain size amorphous carbon feedstocks can, in some embodiments, be less effective for initial graphene conversion but can be more effective for subsequent doping.
(8) The doping flash can, in some embodiments, yield the highest doping ratios when ref-lashed once at around 3 kJ/g and then again at around 16 kJ/g.
(9) This re-flash method can be performed with a pulse width modulated DC electrical pulse from a capacitor bank discharge, and can also be performed with modulated or non-modulated AC and DC current sources.

The synthesize heteroatom-substituted re-flash graphene uses flash graphene as an initial reactant instead of amorphous carbon, allowing higher doping ratios to be achieved. The flash graphene that is used for re-flashing can be the flash graphene synthesized from FJH, including, but not limited to, the flash graphene described hereinabove for the 1D carbon nanomaterials, the flash graphene described in the Tour '642 Patent, and the holey and wrinkled flash graphene described in the Tour '987 PCT Application.

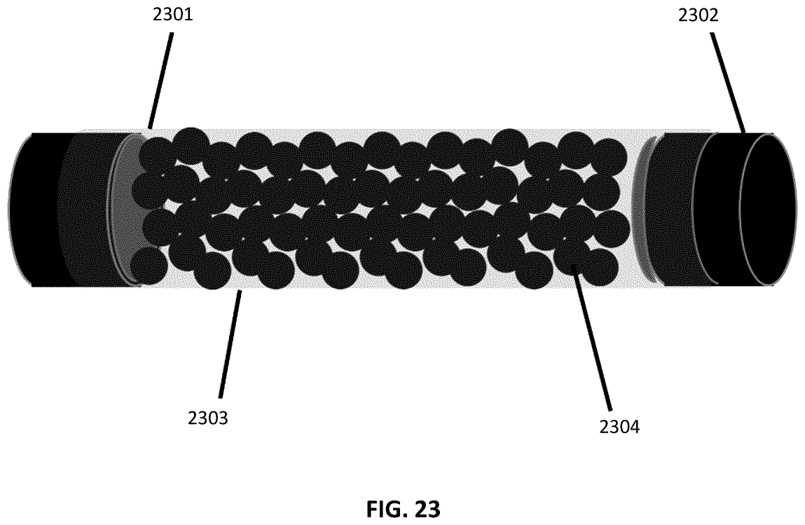

For example, in embodiments, the desired carbon feedstock for graphene conversion is selected. The two feedstocks for the graphene that have been discovered to achieve high doping ratios, are metallurgical coke (MC) and bituminous activated charcoal (BAC) are described here, but this can vary and include plastic derived flash graphene, holey and wrinkled flash graphene (HWFG) or graphene obtained from any source and any method. A schematic for the reaction vessel for both is illustrated in FIG. 23. In FIG. 23, the graphite electrodes 2302, the copper electrodes 2301, and the feedstock 2304 (in quartz tube 2303) are all conductive enough to allow for the passage of electrical current necessary for Joule heating. The graphite and the copper are sufficiently more conductive than the feedstock such that most of the heat is expended in the feedstock. The copper helps provide a more even electrical contact and keeps smaller grains of feedstock in more effectively.

In an example process utilizing metallurgical coke, several kilograms of metallurgical coke chunks were obtained from Suncoke. This metallurgical coke was then ground and sieved until the grain size diameters were between 0.84 and 1.68 mm. The coke was then placed into a fused quartz tube with an inner diameter of 16 mm and a length of approximately 10 cm and the tube was closed on either end by two graphite electrodes. The sample was then compressed until it reaches 1.3Ω. The metallurgical coke was reacted in this vessel via flash Joule heating with batch sizes of 5.7 g at 7.5 kJ/g using a pulse-width modulated signal divided into 3 duty cycles of 10% for 1 s, 20% for 0.5 s, and 50% for 5 s. The resulting flash graphene was determined via Raman spectroscopy analysis to be ˜99% converted to turbostratic flash graphene.

In an example process utilizing bituminous activated charcoal, bituminous activated charcoal was obtained already with grain sizes between roughly 1 and 2 mm in diameter. It was then filled into flashing vessels in 4.2-gram batches, compressed to 1.0Ω, and flashed at 7.5 kJ/g with the same duty cycle pattern as were used with metallurgical coke. The graphene conversion was also measured at ˜99%.

Once the flash graphene is made, it initially remained in grains that are too large for effective mixing. Hence, it was placed in a planetary ball mill among steel balls for 60 min to reduce its size to grains less than 0.2 mm in diameter.

Thereafter, a heteroatom compound or a combination of different compounds (for co-doping) was then mixed by mortar and pestle with the flash graphene in a 1:4 weight ratio in batches of 200 mg. Boric acid was used for boron doping, melamine resin was used for nitrogen doping, polyphenylene sulfide was used for sulfur doping, and perfluorooctanoic acid was used for fluorine doping. These compounds were chosen for the testing as described herein based upon their low decomposition temperature as well as the high doping ratios they achieve compared to other tested doping compounds. However, there is no particular limitation on the dopant material that can be used, and the dopant used in the present invention is not limited to the dopant selected for testing.

200 mg of this mixture was then loaded into a quartz tube ˜4 cm long and with an inner diameter of 8 mm. Fine copper wool was then rolled into small electrodes 8 mm in diameter and ˜4 mm thick on either end, in electrical contact with the feedstock. Small graphite cylinders 8 mm in diameter and ˜8 mm long were then placed in the quartz tube on either end and in electrical contact with the copper electrodes. The resulting vessel was placed between two electrodes attached to a flash Joule heating system and compressed until measuring below 5Ω. The vessel was then placed under an argon atmosphere.

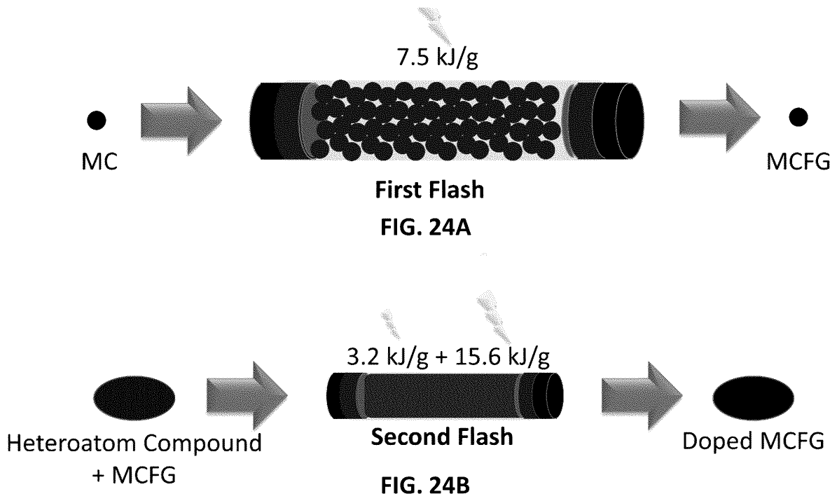

Thereafter, flash Joule heating was then performed in two steps to maximize yield. The first pretreating flash was performed at ˜3.1 kJ/g and the second, primary flash was performed at ˜15.6 kJ/g. The flash reactions were performed using a pulse width modulated discharge with a 3-step duty cycle pattern of 10% for 1 s, 20% for 0.5 s, and 50% for 5 s. The difference between this flash and the one performed in step one is illustrated in FIGS. 24A-24B.

### Characterization of Heteroatom Substituted Re-Flash Graphene

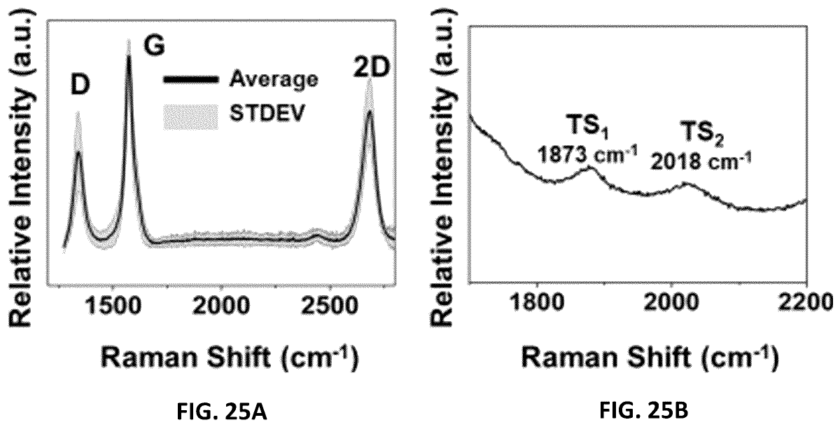

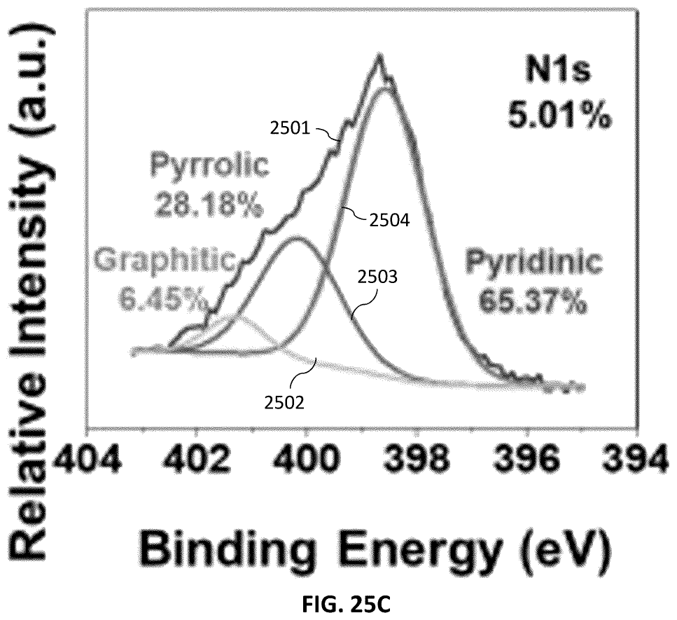

Standard characterization tools were utilized to verify both that the resulting product was converted to graphene and that the graphene is doped with heteroatoms. FIGS. 25A-25C show Raman and X-ray photoelectron spectroscopy (XPS) analyses of N-doped BAC-derived reflash graphene. The presence of the D, G, and 2D Raman peaks, as illustrated in FIG. 25A, as well as the height of the 2D peak relative to that of the G peak, indicate that this sample was converted into high quality graphene (the high 2D peak is a positive indicator of graphene). FIG. 25B demonstrates the presence of the TS₁ and TS₂ Raman peaks, which further indicate that the stacking of the layers of graphene is turbostratic (not ordered) in nature. The doping of nitrogen in the graphene lattice is demonstrated in FIG. 25C (with plots 2501-2504 for N1a, graphitic, pyrrolic, and pyridinic, respectively), which further elaborates on the chemical bonding character of the nitrogen bonds. From this XPS spectroscopic analysis, it was calculated that the N doping percentage in this sample was ˜5%, meaning that 5% of the atoms present in the sample were nitrogen.

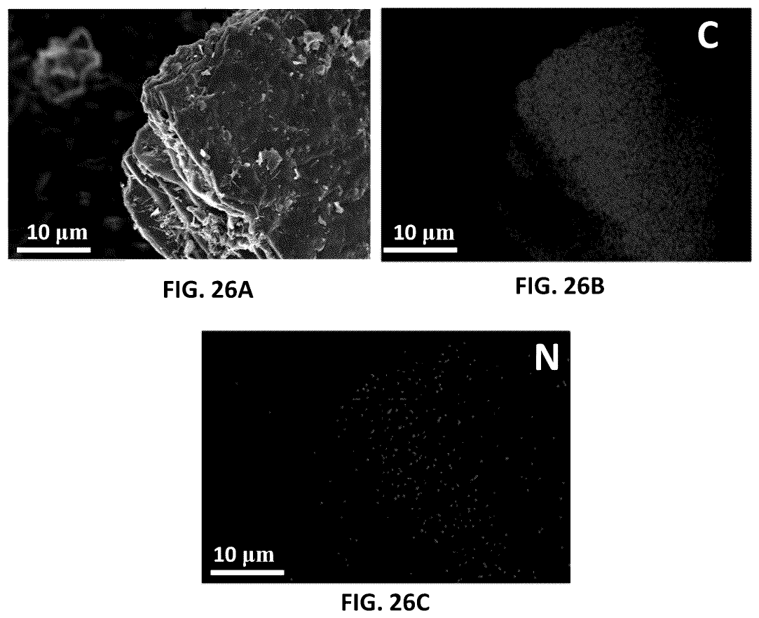

The morphology and elemental composition of the product was further verified by using scanning electron microscopy (SEM) and energy-dispersive X-ray spectroscopy (EDX), as shown in FIGS. 26A-26C, which displays N-doped BAC-derived reflash graphene. The EDX analysis demonstrated that the N atoms are distributed evenly across the face of the graphene (carbon) sample. The fading colors around the edges of the sample were due to the sample being out of focus outside the center. Using these methods, this verified that the product, which was confirmed to be graphene via Raman spectroscopic analysis, was primarily composed of C but also exhibits N atoms near the surface. This analysis served as confirmation in addition to the XPS analysis of the presence of nitrogen in the product.

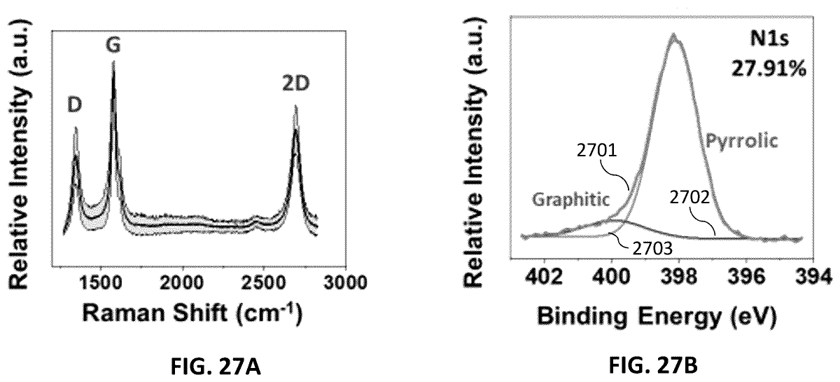

FIGS. 27A-27B demonstrated the analysis of N-doped MC-derived reflash graphene. The graphene character of the product is again confirmed by Raman spectroscopy analysis (again the high 2D peak is a positive indicator of graphene), and the XPS spectroscopy analysis of FIG. 27B (with with plots 2701-2703 for N1a, graphitic, and pyrrolic, respectively) confirmed that this sample has a particularly high doping ratio of almost 28%.

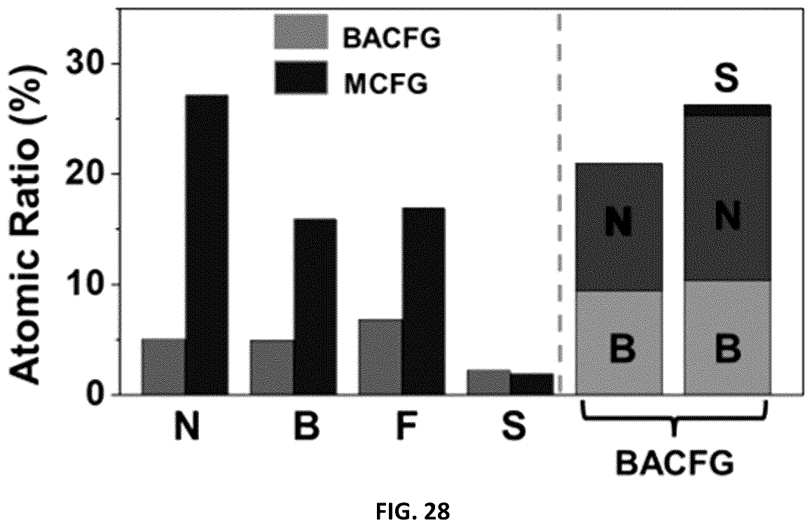

In the embodiments tested, the results of the best doping ratios achieved are summarized in FIG. 28, which includes the results from co-doping experiments during in several different heteroatoms were doped into the graphene lattice at once. (The right part FIG. 28 (marked “BACFG”) shows the co-doping of multiple different types of heteroatoms). In the embodiments tested, the doping reactions were generally more successful with metallurgical coke derived flash graphene than with bituminous activated charcoal derived flash graphene.

### Applications

Various applications for this process and the resulting product exist. The method solves the difficulty of effectively achieving high doping ratios well above 10% in heteroatom doped graphene. In addition, this process is easily scalable and can be used to create doped graphene in bulk. In addition, the low price of feedstocks that are required to produce this heteroatom doped graphene allows this method to effectively compete with other methods of producing doped graphene.

Further, possible applications of the resulting heteroatom substituted re-flash graphene include use as concrete and epoxy additives to increase mechanical strength as well is use in battery electrode materials to increase performance.

Still further, the ability to dope graphene using varied heteroatom compounds also provides the opportunity for the upcycling of organic waste sources via FJH (as described above) into heteroatom-substituted re-flash graphene.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1 of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

U.S. Patent Appl. Publ. No. 2021/0206642, entitled “Flash Joule Heating Synthesis Method And Compositions Thereof,” filed Mar. 2, 2021, published Jul. 8, 2021 to Tour et al. (the “Tour '642 Application”).
PCT International Patent Publication No. WO 2022/067111, entitled “Ultrafast Flash Joule Heating Methods And System For Performing Same,” to J. M. Tour, et al., filed Sep. 24, 2021 (the “Tour '111 PCT Application”).
PCT International Patent Appl. No. PCT/US/64987, entitled “Ultrafast Synthesis Of Holey And Wrinkled Graphene, to J. M. Tour, et al., filed Mar. 27, 2023 (the “Tour '987PCT Application”).
Advincula, P. A., et al., Carbon, 2021, 178, 649 (“Advincula 2021”).
Agnoli, S, et al., Journal of Materials Chemistry A, 2016, 4, 5002-5025 (“Agnoli 2016”).
Ahamed, A., et al., J. Hazard. Mater., 2020, 390, 121449 (“Ahamed 2020”).
Ahn, J., et al., J. Appl. Phys., 2000, 87, 4022 (“Ahn 2000”).
   Ajayan, P. M., et al., in Carbon Nanotub. Synth. Struct. Prop. Appl. (Eds.: M. S. Dresselhaus, G. Dresselhaus, P. Avouris), Springer, Berlin, Heidelberg, 2001, pp. 391-425 (“Ajayan 2001”).
Alabdullah, F. T., Exfoliated Hexagonal Boron Nitride Based Anti-corrosion Polymer Nano-composite Coatings for Carbon Steel in a Saline Environment, Colorado School of Mines (2018) (“Alabdullah 2018”).
Algozeeb, W. A., et al., ACS Nano, 2020, 14, 15595 (“Algozeeb 2020”).
Alkoy, S., et al., J. Eur. Ceram. Soc., 1997, 17, 1415 (“Alkoy 1997”).
Arenal, R., et al., Nano Lett., 2006, 6(8), 1812-1816 (“Arenal 2006”).
Ashraf, M. A, et al., Nanoscale Res. Lett., 2018, 13, 214 (“Ashraf 2018”).
Ba, K., et al., Sci. Rep., 2017, 7, 45584 (“Ba 2017”).
Bae, D. S., et al., Nano Converg., 2022, 9(1), 20 (“Bae 2022”).
Bazargan, A, et al., Chem. Eng. J. 2012, 195-196, 377 (“Bazargan 2012”).
Beckham, J. L., et al., Adv. Mater., 2022, 34, 2106506 (“Beckham 2022”).
Brar, V. W., et al., Phys. Rev. B, 2002, 66, 155418 (“Brar 2002”).
Cai, N., et al., Energy Convers. Manag., 2021, 229, 113794 (“Cai 2021”).
Cai, Q. R., et al., Nanoscale, 2017, 9, 3059 (“Cai 2017”).
Carozo, V., et al., Nano Lett., 2011, 11, 4527 (“Carozo 2011”).
Carroll, K. M, et al., Langmuir, 2018, 34, 73 (“Carroll 2018”).
Cao, C. C., et al., 2D Mater., 2022, 9, 015014 (“Cao 2022”).
Chen, W., et al., ACS Nano, 2022, 16, 6646 (“Chen 2022”).
Chen, W., et al., ACS Nano, 2021, 15, 11158 (“Chen I2021”).
Chen, W., et al., ACS Nano, 2021, 15, 1282 (“Chen 112021”).
Chen, X., et al., Sci. Rep., 2017, 7(1), 1-9 (“Chen 2017”).
Chen, X., et al., Appl. Phys. Lett., 2015, 107(25), 253105 (“Chen 2015”).
Chen, Y., et al., Chem. Phys. Lett., 1999, 299(3-4), 260-264 (“Chen 1999”).
Chiang, W.-H, et al., Nat. Mater., 2009, 8, 882 (“Chiang 2009”).
Chilkoor, G., et al., ACS Nano, 2020, 14, 14809 (“Chilkoor 2020”).
Chopra, N. G., et al., Science, 1995, 269(5226), 966-967 (“Chopra 1995”).
Ci, L. J., et al., Nat. Mater., 2010, 9, 430 (“Ci 2010”).
Constantinescu, G., et al., Phys. Rev. Lett., 2013, 111, 036104 (“Constantinescu 2013”).
Demirci, U. B., Energies, 2020, 13(12), 3071 (“Demirci 2020”).
Deng, B., et al., Nat. Commun., 2022, 13(1), 262 (“Deng 2022”).
Deng, B., et al., Nat. Commun., 2021, 12, 5794 (“Deng 2021”).
Ding, W., et al., Nat. Commun. 2021, 12, 5886 (“Ding 2021”).
Ding, W., et al., ACS Nano, 2019, 13, 1694 (“Ding 2019”).
Edgar, J. H., Properties of group III nitrides (1994) (“Edgar 1994”).
Fathalizadeh, A., et al., Nano Lett., 2014, 14(8), 4881-4886 (“Fathalizadeh 2014”).
Fan, M. M., et al., Adv. Mater., 2019, 31, 1805778 (“Fan 2019”).
Feng, L., et al., Materials, 2014, 7, 3919 (“Feng 2014”).
Ferrari, A. C., et al., Nat. Nanotechnol., 2013, 8, 235 (“Ferrari 2013”).
Fouquet, M, et al., Phys. Rev. B, 2012, 85, 235411 (“Fouquet 2012”).
Frueh, S., et al., Inorg. Chem., 2011, 50(3), 783-792 (“Frueh 2011”).
Gladkaya, I. S., et al., J. Alloys Compd., 1986, 117, 241 (“Gladkaya 1986”).
Gong, J, et al., Ind. Eng. Chem. Res., 2013, 52, 15578 (“Gong 2013”).
Gorbachev, R. V., et al., Small, 2011, 7, 465 (“Gorbachev 2011”).
Govind Rajan, A., et al., J. Phys. Chem. Lett., 2018, 9, 1584 (“Govind Rajan 2018”).
Guo, Y., et al., Sci. Rep., 2022, 12, 2522 (“Guo 2022”).
Gupta, S., et al., ACS Appl. Nano Mater., 2020, 3, 7930 (“Gupta 2020”).
Han, X., et al., ACS Nano, 2018, 12, 11, 11219 (“Han 2018”).
Hong, J., et al., Sci. Rep., 2013, 3, 2700 (“Hoon 2013”).
Hu, S.-Q., et al., J Chem., 2019, 2019, 8793282 (“Hu 2019”).
Huang, L., et al., ACS Nano, 2020, 14, 12045 (“Huang 2020”).
Huang, Y., et al., Nanotechnology, 2011, 22(14), 145602 (“Huang 2011”).
Hunter, R. D, et al., J. Mater. Chem. A, 2022, 10, 4489 (“Hunter 2022”).
Jagodzinska, K, et al., Chem. Eng. J., 2022, 446, 136808 (“Jagodzinska 2022”).
Jia, M., et al., Macromol. Rapid Commun., 2022, 43, 2100835 (“Jia 2022”).
Jia, Z., et al., Catalysts, 2017, 7, 256 (“Jia 2017”).
Jie, X., et al., Nat. Catal., 2020, 3, 902 (“Jie 2020”).
Kakiagea, M., et al., Key Eng. Mater., 2013, 534, 55 (“Kakiagea 2013”).
Khanna, V., et al., Journal of Industrial Ecology, 2008, 12(3), 394-410 (“Khanna 2008”).
Kim, H.-S., et al., Nanomaterials (Basel.) 2021, 12(1), 11 (“Kim H 2021”).
Kim, J., et al., Acta Mater., 2011, 59(7), 2807-2813 (“Kim 2011”).
Kim, J. H., et al., Sci. Rep., 2019, 9(1), 15674 (“Kim 2019”).
Kim, J. H., et al., Nano Converg., 2018, 5(1), 17 (“Kim J 2018”).
Kim, K. S., et al., ACS Omega, 2021, 6 (41), 27418-27429 (“Kim K 2021”).
Kim, K. S., et al., ACS Nano, 2018, 12 (1), 884-893 (“Kim K 2018”).
Kim, M., et al., Chem. Eng. J., 2020, 395, 125148 (“Kim 2020”).
Koepke, J. C., et al., Chem. Mater., 2016, 28(12), 4169-4179 (“Koepke 2016”).
Koken, D., et al., ACS Appl. Nano Mater., 2022, 5 (2), 2137-2146 (“Koken 2022”).
Kosynkin, D. V., et al., Nature, 2009, 458, 872 (“Kosynkin 2009”).
Kou, L., et al., Nano-Micro Lett., 2017, 9, 51 (“Kou 2017”).
Kour, R., et al., J. Electrochem. Soc., 2020, 167, 037555 (“Kour 2020”).
Koutsioukis, A., et al., Nanomaterials, 2022, 12, 447 (“Koutsioukis 2022”)
Kumar, S., et al., Chem. Eng. J., 2021, 403, 126352 (“Kumar 2021”).
Lahiri, D., et al., Acta Biomater., 2010, 6(9), 3524-3533 (“Lahiri 2010”).
Langenhorsta, F., et al., Phys. Chem. Chem. Phys., 2002, 4, 5183 (“Langenhorsta 2002”).
Lebedev, A. V., et al., ECS J. Solid. State. Sci. Technol., 2020, 9, 083004 (“Lebedev 2020”).
Lee, C. H., et al., Molecules, 2016, 21(7), 922 (“Lee 2016”).
Lee, J.-K., et al., IUCrJ, 2021, 8(Pt 6), 1018-1023 (“Lee J 2021”)
Lee, S.-H., et al., Carbon, 2021, 173, 901 (“Lee S 2021”).
Li, L., et al., ACS Nano, 2014, 8, 1457 (“Li 2014”).
Li, T., et al., Nat. Energy, 2018, 3, 148 (“Li 2018”).
Li, Y., et al., E3S Web Conf, 2021, 260, 03027 (“Li 2021”).
Li, Y., et al., Earth Environ. Sci., 2020, 453 (1), 012091 (“Li 2020”).
Lian, J. B., et al., J. Phys. Chem. C, 2009, 113, 9135 (“Lian 2009”).
Liu, F., et al., Front. Chem., 2021, 9 (“Liu 2021”).
Lourie, O. R., et al., Chem. Mater., 2000, 12(7), 1808-1810 (“Lourie 2000”).
Luong, D. X., et al., Nature, 2020, 577, 647 (“Luong 2020”).
Martin-Lara, M. A, et al., J. Clean., Prod. 2022, 365, 132625 (“Martin-Lara 2022”).
McGilvery, C. M., et al., Micron, 2012, 43, 450 (“McGlvery 2012”).
McLean, B., et al., J. Appl. Phys., 2021, 129, 044302 (“McLean 2021”).
Medupin, R. O, et al., Sci. Rep., 2019, 9, 20146 (“Medupin 2019”).
Merlen, A., et al., Coatings, 2017, 7, 153 (“Merlen 2017”).
Mueller, J. E, et al., J. Phys. Chem. C, 2010, 114, 4939 (“Mueller 2010”).
Owuor, P. S., et al., ACS Nano, 2017, 11, 8944 (“Owuor 2017”).
Pakdel, A., et al., Nanotechnology, 2012, 23(21), 215601 (“Pakdel 2012”).
Park, H. J., et al., Sci. Adv., 2020, 6, eaay4958 (“Park 2020”).
Plimpton, S., J. Comput. Phys., 1995, 117, 1 (“Plimpton 1995”).
Puyoo, G., et al., Carbon, 2017, 122, 19 (“Puyoo 2017”).
Rao, R., et al., ACS Nano, 2018, 12, 11756 (“Rao 2018”).
Rathinavel, S., et al., Mater. Sci. Eng. B, 2021, 268, 115095 (“Rathinavel 2021”).
Ren, S. M., et al., ACS Appl. Mater. Interfaces, 2017, 9, 27152 (“Ren 2017”).
Restivo, J., et al., Processes, 2020, 8, 1329 (“Restivo 2020”).
Roy, S, et al., Nanotechnol. Rev., 2018, 7, 475 (“Roy 2018”).
Rubio, A., et al., Phys. Rev. B Condens. Matter, 1994, 49(7), 5081-5084 (“Rubio 1994”).
Ruiz-Cornejo, J. C., et al., Rev. Chem. Eng., 2020, 36, 493 (“Ruiz-Cornejo 2020”).
Rydberg, H., et al., Phys. Rev. Lett., 2003, 91, 126402 (“Rydberg 2003”).
Sarkar, N., et al., Ind. Eng. Chem. Res., 2016, 55, 2921 (“Sarkar 2016”).
Sharma, S. S., et al., J. Chem. Technol. Biotechnol., 2020, 95, 11 (“Sharma 2020”).
Shi, C., et al., Small, 2019, 15, 1902348 (“Shi 2019”).
Singh, D. K., et al., Diam. Relat. Mater., 2010, 19, 1281 (“Singh 2010”).
Shiratori, T., et al., Nanomaterials (Basel), 2021, 11 (3), 651 (“Shiratori 2021”).
Simpson, A. Stuckes, J. Phys. C: Solid State Phys., 1971, 4, 1710 (“Simpson 1971”).
Singh, N. K., et al., RSC Adv., 2018, 8, 17237 (“Singh 2018”).
Smith, R. J., et al., Adv. Mater., 2011, 23, 3944 (“Smith 2011”).
Song, L., et al., Nano Lett., 2010, 10, 3209 (“Song 2010”).
Spahr, M. E., et al., Fillers for Polymer Applications., 375-400 (2017) (“Spahr 2017”).
Stanford, M. G., et al., ACS Nano, 2020, 14(10), 13691 (“Stanford 2020”).
Stehle, Y., et al., Chem. Mater., 2015, 27(23), 8041-8047 (“Stehle 2015”).
Tan, L. F., et al., Adv. Electron. Mater., 2015, 1, 1500223 (“Tan 2015”).
Tay, R. Y., et al., Chem. Mater., 2015, 27(20), 7156-7163 (“Tay 2015”).
Tay, R. Y., et al., J. Mater. Chem. C Mater. Opt. Electron. Devices, 2014, 2 (9), 1650-1657 (“Tay 2014”).
Teah, H., et al., ACS Sustainable Chem. Eng., 2020, 8(4), 1730-1740 (“Yeah 2020”).
Temizel-Sekeryan, S., et al., Int J Life Cycle Assess, 2021, 26(4), 656-672 (“Temizel-Sekeryan 2021”).
Terao, T., et al., J. Phys. Chem. C, 2010, 114(10), 4340-4344 (“Tetao 2010”).
Thambiliyagodage, C. J., et al., Carbon, 2018, 134, 452 (“Thambiliyagodage 2018”).
Thomas, J., et al., J. Am. Chem. Soc., 1963, 84, 4619 (“Thomas 1963”).
Toyos-Rodriguez, C., et al., J. Nanomater., 2019, 1-10 (“Toyos-Rodriguez 2019”).
Tripathi, P. K., et al., Nanomaterials, 2017, 7, 284 (“Tripathi 2017”).
Trompeta, A.-F., et al., Journal of Cleaner Production, 2016, 129, 384-394 (“Trompeta 2016”).
Vedhanarayanan, B., et al., NPG Asia Mater., 2018, 10, 107 (“Vedhanarayanan 2018”).
Viswanatha, R, et al., John Wiley & Sons, Ltd, 2007, pp. 139-170 (“Viswanatha 2007”).
Wang, B, et al., J. Am. Chem. Soc., 2007, 129, 9014 (“Wang 2007”).
Wang, C. X., et al., J. Am. Chem. Soc., 2017, 139, 13997 (“Wang 2017”).
Wang, J., et al., Catal. Today, 2020, 351, 50 (“Wang 2020”).
Wang, X., et al., Chemical Society Reviews, 2014, 43, 7067-7098 (“Wang 2014”).
Wang, Y., et al., ACS Sustain. Chem. Eng., 2022, 10, 2204 (“Wang 2022”).
Wang, Y., et al., J. Nanomater., 2008, 2008, 1-7 (“Wang 2008”).
Wang, Z., et al., Nanomaterials, 2019, 9, 1045 (“Wang 2019”).
Warner, J. H., et al., Nano Lett., 2009, 9, 102 (“Warner 2009”).
Williams, P. T., Waste Biomass Valorization, 2021, 12, 1 (“Williams 2021”).
Wolfram Research, Inc., Mathematica, Version 11.3, Champaign, IL (2018) (“Wolfram 2018”).
Wu, F., et al., Journal of Cleaner Production, 2020, 270, 122465 (“Wu 2020”).
Wyss, K. M., et al., Adv. Mater., 2022, 34(8), 2106970 (“Wyss I2022”).
Wyss, K. M., et al., Commun. Eng., 2022, 1, 1 (“Wyss II 2022”).
Wyss, K. M, et al., ACS Nano, 2022, 16(5), 7804 (“Wyss III 2022”)
Wyss, K. M., et al., Carbon, 2021, 174, 430 (“Wyss I2021”).
Wyss, K. M., et al., ACS Nano, 2021, 15, 10542 (“Wyss II 2021”).
Wu, C., et al., Process Saf. Environ. Prot., 2016, 103, 107 (“Wu 2016”).
Wu, N., et al., Carbon, 2021, 176, 88 (“Wu 2021”).
Xia, K., et al., Procedia IUTAM, 2017, 21, 94 (“Xia 2017”).
Xie, H., et al., Small Methods, 2018, 2, 1700371 (“Xie 2018”).
Xu, D., et al., Angew. Chem. Int. Ed., 2018, 57, 755 (“Xu D 2018”).
Xu, H., et al., Journal of Energy Chemistry, 2018, 27, 146-160 (“Xu H 2018”).
Xu, Q., et al., Nanoscale, 2019, 11, 1475 (“Xu 2019”).
Yang, W., et al., J. Am. Chem. Soc., 2015, 137, 1436 (“Yang 2015”).
Yaqoob, L., et al., ACS Omega, 2022, 7, 13403 (“Yaqoob 2022”).
Yan, Z., et al., ACS Nano, 2014, 8, 5061 (“Yan 2014”).
Yao, D., et al., ACS Sustain. Chem. Eng., 2022, 10, 1125 (“Yao 2022”).
Yao, Y. G., et al., Science, 2018, 359, 1489 (“Yau 2018”).
Yao, Y., et al., Nano Lett., 2016, 16, 7282 (“Yao 2016”).
Ye, R., et al., ACS Nano 2019, 13, 10872-10878 (“Ye 2019”).
Yoon, D., et al., Raman Spectroscopy for Characterization of Graphene, Springer-Verlag Berlin Heidelberg (2012) (“Yoon 2012”).
Yu, D. P., et al., Appl. Phys. Lett., 1998, 72(16), 1966-1968 (“Yu 1998”).
Yuan, D., et al., Nano Lett., 2008, 8, 2576 (“Yuan 2008”).
Zare, Y., Compos. Part Appl. Sci. Manuf, 2016, 84, 158 (“Zare 2016”).
Zeng, X., et al., ACS Nano, 2017, 11(5), 5167-5178 (“Zeng 2017”).
Zhao, C., et al., Adv. Funct. Mater., 2014, 24, 5985 (“Zhao 2014”).
Zhao, M.-Q., et al., ACS Nano, 2012, 6, 10759 (“Zhao 2012”).
Zhi, C., et al., Adv. Funct. Mater., 2009, 19(12), 1857-1862 (“Zhi 2009”).
Zhi, C., et al., J. Am. Chem. Soc., 2005, 127(46), 15996-15997 (“Zhi 2005”).
Zhi, C., et al., Solid State Commun., 2005, 135(1-2), 67-70 (“Zhi II 2005”).
Zhong, B., et al., Mater. Des., 2017, 120, 266 (“Zhong 2017”).
Zhu, M., et al., J. Inorg. Mater., 2019, 34, 817 (“Zhu 2019”).
Zhuang, C., et al., RSC Adv., 2016, 6(114), 113415-113423 (“Zhuang 2016”).
Zhuo, C., et al., J. Appl. Polym. Sci., 2014, 131, DOI 10.1002/app.39931 (“Zhou 2014”).
Zou, B. J., et al., Prog. Org. Coat., 2019, 133, 139 (“Zou 2019”).

1. A method comprising flash Joule heating a mixture of a material and a catalyst to form a 1-dimensional structure.

2. The method of claim 1, wherein
(a) the flash Joule heating is a process comprising applying a voltage across the mixture, which drives a current through the mixture to form the 1-dimensional structure;
(b) the voltage is applied in one or more voltage pulses; and
(c) duration of each of the one or more voltage pulses is for a duration period.

3. (canceled)

4. The method of claim 1, wherein the 1-dimensional structure is a graphitic 1D and/or hybrid material nanomaterial.

5. The method of claim 1, wherein the method further comprises forming the 1-dimensional structure forms along with one or more other dimensional structures selected from the group consisting of 0-dimensional structures, 2-dimensional structures, and mixtures thereof.

6. The method of claim 1, wherein the 1-dimensional structure and the one or more other dimensional structures are conjoined covalently or non-covalently.

7. The method of claim 6, wherein the 1-dimensional structure and the one or more other dimensional structures are conjoined to form a 3-dimensional network.

8. The method of claim 1, wherein the material is a carbon material comprising a polymer.

9. The method of claim 8, wherein the mixture is formed by loading the polymer with particles of the catalyst through surface wetting.

10. The method of claim 8, wherein the mixture is formed by loading the polymer with particles of the catalyst through melt mixing.

11. The method of claim 1, wherein the materials is a waste product comprising carbon.

12. The method of claim 1, wherein the catalyst is selected from the group consisting of iron(II) chloride, nickel(II) chloride, cobalt(II) chloride, and ferrocene.

13. The method of claim 1, wherein the catalyst is selected from the group consisting of any transition metal or main group metal or transition metal or main group metal complex, salt, oxide, halide, or combinations thereof.

14. The method of claim 1, wherein the mixture further comprising a conductive carbon additive.

15. The method of claim 14, wherein the conductive carbon additive is selected from the group consisting of graphene, flash graphene, turbostratic graphene, anthracite coal, coconut shell-derived carbon, higher temperature-treated biochar, activated charcoal, calcined petroleum coke, metallurgical coke, coke, shungite, carbon nanotubes, asphaltenes, acetylene black, carbon black, ash, carbon fiber, and mixtures thereof.

16. (canceled)

17. The method of claim 14, wherein the method further comprises that, after the flash Joule heating, separating at least some of the conductive carbon additive from the formed the 1-dimensional structure.

18. The method of claim 17, wherein the step of separating is based grain size of the conductive carbon additive and size of the 1-dimensional structure formed.

19. The method of claim 18, wherein the step of separating comprising sieving to separate the small 1-dimensional structure from the large grain conductive carbon additive.

20-21. (canceled)

22. The method of claim 1, wherein % yield of 1-dimensional structure formed in the method is at least 65%.

23-32. (canceled)

33. A method comprising flash Joule heating a mixture to form boron nitride nanotubes, wherein the mixture comprises (i) a material comprising boron, (ii) a material comprising nitrogen and (iii) a catalyst.

34. The method of claim 33, wherein
(a) the flash Joule heating is a process comprising applying a voltage across the mixture, which drives a current through the mixture to form the boron nitride nanotubes;
(b) the voltage is applied in one or more voltage pulses; and
(c) duration of each of the one or more voltage pulses is for a duration period.

35. The method of claim 33, wherein the material comprising the boron and the material comprising the nitrogen are different materials.

36. The method of claim 33, wherein the material comprising the boron and the material comprising the nitrogen are the same material.

37. The method of claim 36, wherein the same material is ammonia borane.

38. The method of claim 33, wherein the catalyst is Ni(acac)₂ and/or Fe(acac)₃.

39. The method of claim 33, wherein the catalyst comprises Ni and/or Fe.

40. The method of claim 33, wherein the mixture further comprises a conductive carbon source.

41-48. (canceled)

49. The method of claim 40, wherein % yield of the boron nitride nanotubes formed in the method is at least 45%.

50-104. (canceled)
